(19) United States
(12) Patent Application Publication
(10) Pub. No.: US 2026/0289043 A1
(43) Pub. Date: Sep. 24, 2026

(54) Fast Hybrid Method Applying To Metasurfaces Without And With Substrate

(71) Applicant: The Regents of The University of Michigan, Ann Arbor, MI (US)

(72) Inventors: Leung TSANG, Ann Arbor, MI (US); Jongwoo JEONG, Gumi (KR); Zhenming HUANG, Ann Arbor, MI (US)

(73) Assignee: The Regents of The University of Michigan, Ann Arbor, MI (US)

(21) Appl. No.: 19/563,062

(22) Filed: Mar. 11, 2026

Related U.S. Application Data
(60) Provisional application No. 63/772,006, filed on Mar. 14, 2025.

(51) Int. Cl. G06F 30/25; G06F 17/14; G06F 111/10

(52) U.S. Cl. CPC G06F 30/25; G06F 17/142; G06F 2111/10

(57) ABSTRACT

A computer-implemented method is provided for full-wave simulations of metasurfaces. The method includes: receiving a metasurface comprised of a plurality of scattering structures having same shape; determining a baseline T-matrix for a given scattering structure of the metasurface; generating a model for the metasurface by assigning a T-matrix to each scattering structure comprising the metasurface, where each assigned T-matrix is a variant of the baseline T-matrix; for each scattering structure in the model, formulating a Foldy-Lax equation for a particular scattering structure, thereby forming a set of Foldy-Lax equations, where each Foldy-Lax equation accounts for scattering from each of remaining scattering structures in the model; and determining a scattered wave for each of the plurality of scattering structures by applying a Fast Fourier transform to the set of Foldy-Lax equations.

### FIELD

The present disclosure relates to techniques for full-wave simulations of metasurfaces with and without a substrate.

### BACKGROUND

There has been rapid growth in the technology of metasurfaces in optics/quantum, microwaves, and terahertz. In optics, metasurfaces can be used to focus light, form efficient diffractive elements, and control polarization of light. In microwave domain, metasurfaces enable new platforms for communications, antenna, radars, and remote sensing. With the advances of 3-D printing technologies, metasurfaces can be fabricated for terahertz devices bridging the gap between photonics and microwaves for future communications and imaging. Recently, metasurfaces have been utilized to increase quantum entanglement between two qubits that are far apart by increasing their coherent interactions for applications in quantum computers. There has been a huge growth of publications in metasurfaces in recent years. Theoretical investigations of electromagnetic fields of metasurfaces have been conducted by numerical and analytical methods. Commercial softwares for full-wave simulations, such as Altair FEKO, Ansys HFSS, CST and COMSOL, are based on numerical methods of space discretization. Full-wave simulations of metasurfaces have gained popularity due to their capability of accurately solving Maxwell's equations. For instance, COMSOL has been used to characterize metasurfaces, while CST has been utilized to validate intensity. But their numerical methods are primarily applicable to metasurfaces with a minimized number of unit cells and limited size of substrate, which may introduce artificial side effects. Analytical methods based on quasi-static approximation give electromagnetic solutions of metasurfaces expressed by circuit elements. However, circuit models neglect the radiation properties of the elements and the wave interactions among unit cells. Quasi-analytical methods have also been employed with various assumptions, which compromise accuracy. Consequently, developing a fast and efficient full-wave solver for metasurfaces is essential.

This section provides background information related to the present disclosure which is not necessarily prior art.

### SUMMARY

This section provides a general summary of the disclosure, and is not a comprehensive disclosure of its full scope or all of its features.

A computer-implemented method is provided for full-wave simulations of metasurfaces. The method includes: receiving a metasurface comprised of a plurality of scattering structures having same shape; determining a baseline T-matrix for a given scattering structure of the metasurface; generating a model for the metasurface by assigning a T-matrix to each scattering structure comprising the metasurface, where each assigned T-matrix is a variant of the baseline T-matrix; for each scattering structure in the model, formulating a Foldy-Lax equation for a particular scattering structure, thereby forming a set of Foldy-Lax equations, where each Foldy-Lax equation accounts for scattering from each of remaining scattering structures in the model; and determining a scattered wave for each of the plurality of scattering structures by applying a Fast Fourier transform to the set of Foldy-Lax multiple scattering equations.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a flowchart depicting a fast hybrid multiple scattering method for performing full-wave simulations of metasurfaces.

FIGS. 2A and 2B are diagrams illustrating the Fold-Lax multiple scattering equations for vector cylindrical waves (VCW) and vector spherical waves (VSW), respectively.

FIG. 3A illustrate unit cells with scatterers having an enclosing cylinder for VCW and FIG. 3B illustrate two unit cells with two enclosing spheres,

FIG. 4 is a diagram showing the computational process of solving multiple scattering using vector cylindrical waves.

FIG. 5 is a diagram showing the computational process of solving multiple scattering using vector spherical waves.

FIG. 6 illustrates a 3D geometric shape a unit cell along with a rotated unit cell.

FIGS. 7A and 7B are graphs showing the comparison of scattered field simulations using the proposed fast hybrid multiple scattering method with vector cylindrical waves in relation to commercially available simulation tools of FEKO and HFSS.

FIGS. 7C and 7D are graphs showing the comparison of scattered field simulations using the proposed fast hybrid multiple scattering method with vector spherical waves in relation to commercially available simulation tools.

FIGS. 7E and 7F are diagrams showing far-field solutions of the proposed fast hybrid multiple scattering method with vector spherical waves verified using FEKO.

FIGS. 8A and 8B are 3D models of metasurface designs with 400 and 1296 unit cells, respectively.

FIGS. 9A and 9B are graphs showing intensity distributions of a metasurface focusing lens simulated with the proposed fast hybrid multiple scattering method with vector cylindrical wave and 400 unit cells shown on the x-z plane and on the x-y plane, respectively.

FIGS. 9C and 9D are graphs showing intensity distributions of a metasurface focusing lens simulated with the proposed fast hybrid multiple scattering method with vector cylindrical wave and 1296 unit cells shown on the x-z plane and on the x-y plane, respectively.

FIG. 9E is a graph showing an intensity profile for the metasurface focusing lens along the x-axis.

FIGS. 10A and 10B are graphs showing intensity distributions of a metasurface focusing lens simulated with the proposed fast hybrid multiple scattering method with vector spherical wave and 400 unit cells shown on the x-z plane and on the x-y plane, respectively.

FIGS. 10C and 10D are graphs showing intensity distributions of a metasurface focusing lens simulated with the proposed fast hybrid multiple scattering method with vector spherical wave and 1296 unit cells shown on the x-z plane and on the x-y plane, respectively.

FIG. 10E is a graph showing an intensity profile for the metasurface focusing lens along the x-axis.

FIG. 11A shows the 4 layer metasurface absorber.

FIG. 11B is a graph showing an intensity profile for a metasurface absorber along the x-axis.

FIGS. 11C and 11D are graphs showing CPU time and memory, respectively, for the proposed fast hybrid multiple scattering method with vector spherical waves.

FIGS. 12A and 12B are graphs showing CPU time and memory, respectively, for check computational complexity of the proposed fast hybrid multiple scattering method with vector cylindrical waves with comparisons against commercial softwares

FIGS. 12C and 12D are graphs showing CPU time and memory, respectively, for check computational complexity of the proposed fast hybrid multiple scattering method with vector spherical waves with comparisons against commercial softwares

FIG. 13 is a diagram of a laser beam incident on a metasurface with scattering structures placed on a substrate.

FIG. 14 is a diagram illustrating the scattering problem of two scattering structures placed above a substrate.

FIGS. 15A and 15B are graphs showing results of a single sphere above a substrate of planar surface.

FIGS. 16A and 16B are graphs showing results of two spheres above a substrate of planar surface with Nₘₐₓ=one.

FIGS. 17A and 17B are graphs showing results of two spheres above a substrate of planar surface with Nₘₐₓ=two.

FIG. 18 is a graph showing speed of the proposed fast hybrid multiple scattering method in relation to the commercial software FEKO.

FIG. 19 is a graph showing results of 256 cubic scatters with horizontal polarized incidence with comparisons with several versions of FEKO<a commercial software.

FIG. 20A illustrates an OAM metasurface.

FIG. 20B illustrates a single unit cell of silicon elliptical nanopillar which performs as a resonator.

FIG. 21 shows the results of a far field of a metasurface with a RCP incident wave.

FIG. 22 illustrates a wavelength-selective metamirror.

FIG. 23 is a plot showing the near field results of the metamirror.

Corresponding reference numerals indicate corresponding parts throughout the several views of the drawings.

### DETAILED DESCRIPTION

Example embodiments will now be described more fully with reference to the accompanying drawings.

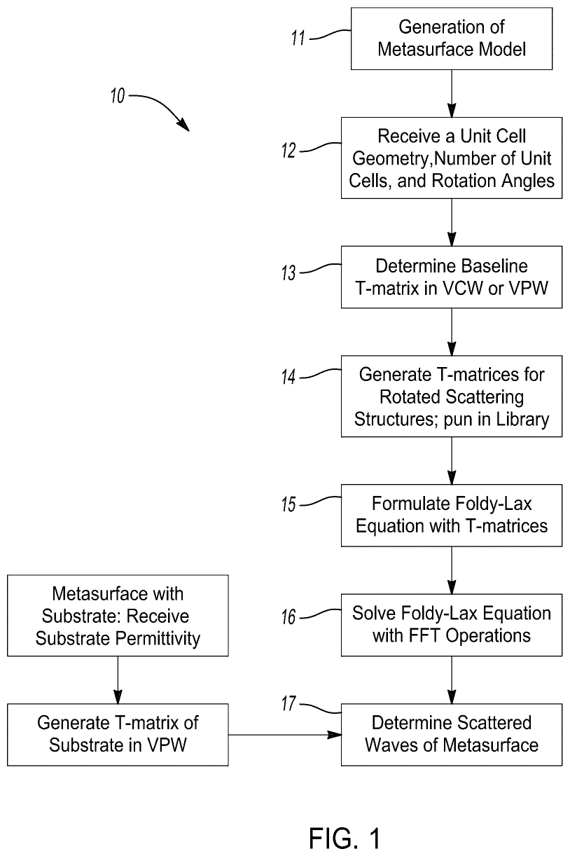

FIG. 1 depicts a fast hybrid multiple scattering method 10 for performing full-wave simulations of metasurfaces. As a starting point, a model for a metasurface to be simulated is provided at 11. The metasurface is comprised of a plurality of scattering structures having same shape. The model for the metasurface may include unit cell geometry, number of unit cells and rotation angles as indicated at 12.

A baseline T-matrix is determined at 13 for an exemplary scattering structure of the metasurface. The baseline T-matrix is preferably determined using an electromagnetic field solver. Commercially available electromagnetic field solvers include but are not limited to Ansys HFSS finite element method solver, COMSOL simulation software, and FEKO computational electromagnetic software. In the example embodiments, the scattering surface is represented by either a cylinder or a sphere, such that the baseline T-matrix expresses scattered fields outside of the cylinder as vector cylindrical waves or outside the sphere as vector spherical waves as further described below.

Next, a model for the metasurface is generated at 14 by assigning a T-matrix to each scattering structure comprising the metasurface. Each assigned T-matrix is a variant of the baseline T-matrix. More specifically, the model is generated by rotating elements of the baseline T-matrix according to a series of orientations to form a series of T-matrix variants; the series of T matrix variants is stored in a library; and a T-matrix variant from the series of T-matrix variants is assigned to each scattering structure in the model, where orientation of the T-matrix variant aligns with orientation of the scattering structure to which it is assigned.

For each scattering structure in the model, a Foldy-Lax equation is formulated at 15 for a particular scattering structure, thereby forming a set of Foldy-Lax equations. Each Foldy-Lax equation accounts for scattering from each of remaining scattering structures in the model as will be described in more detail below.

Lastly, a scattered wave is determined at 17 for each of the plurality of scattering structures by applying a Fast Fourier transform to the set of Foldy-Lax equations. In an example embodiment, the scattered wave for each of the scattering structures is determined iteratively until a stop condition is met. In the multiple scattering iteration approach, the current solution is compared with the initial solution. If the difference between the current solution and the initial solution is under a predefined tolerance, then a stop condition is met. In iterative method, a stop condition is satisfied when the residual of the GMRES method is under a predefined tolerance.

The proposed fast hybrid multiple scattering method 10 uses multiple scattering theory. In an example embodiment, the multiple scattering equations are from the Foldy Lax. The Foldy-Lax multiple scattering equations have been rigorously derived from Maxwell equations. A multiple scattering problem means that there are a large number of scatterers and electromagnetic waves are scattered by the scatterers to each other. For an arbitrary exciting field or incident wave upon the single scatterer, the fields of the single scatterer can be calculated by computational electromagnetic methods. This may be referred to herein as the “single scatterer solution”. In a multiple scattering problem, the “single scatterer solution” is assumed to be known. The single scatterer solution can be used to calculate the T-matrix in VCW or VSW.

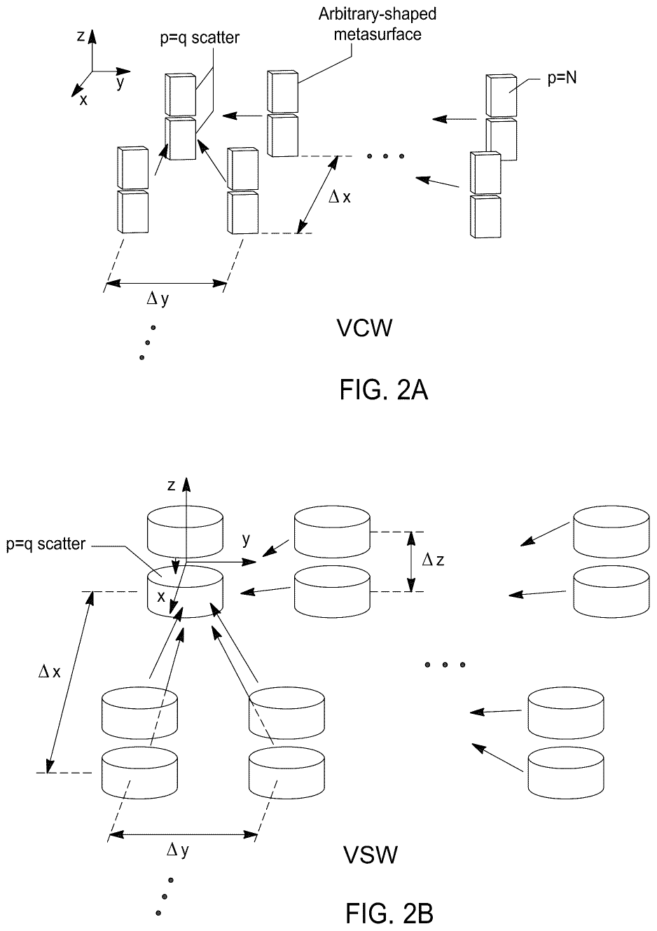

Consider N scatterers, where N is a large number, as shown in FIG. 2A for VCW and FIG. 2B for VSW. Let E_{inc} be the incident wave, and Tₚ be the T-matrix of the scatterers for scatterers p=1, 2, . . . , N. Then, the multiple scattering equations of Foldy-Lax (FL) govern the final exciting field,

$${E}_{q}^{ex} ,$$

q=1, 2, . . . , N of the scatterers. The Foldy-Lax equation, in symbolic form, is as shown below

$${E}_{q}^{ex} = {E}^{inc} + {\sum }_{p = 1 , p \neq q}^{N} {G}_{qp} {T}_{p} {E}_{p}^{ex} , \qquad ( 1 )$$

where G_{qp} is the propagator from scatterer p to scatterer q. The term

$${G}_{qp} {T}_{p} {E}_{p}^{ex}$$

is scattering from particle p to particle q. The following observations were made. Since the single scatterer solutions is known, the unknowns in a multiple scattering problem are the final exciting fields. This is in contrast to the single scatterer problem in which the exciting field is known and the scattered field is unknown. The final exciting field of a scatterer is due to the incident wave plus the scattered fields from other scatterers to that scatterer. The advantage of the Foldy-Lax equations is that they only require scattering from a scatterer to all other scatterers. The Foldy-Lax equations do not require the electromagnetic field solutions everywhere.

Further, one can use a T-matrix to calculate scattering to other scatterers. The T-matrix only requires a subset of information of the “single scatterer” solution. There is no spatial discretization in the Foldy Lax equations. Since N is large, there is a need for a fast summation of scattering from a large number of other scatterers. After the final exciting field of scatterers are computed, one can calculate the fields “everywhere” by using the “single scatterer solution” of each scatterer.

For scatterers that are close to each other, such as the nearest neighbors, one can decompose into near scatterers and non-near scatterers. Near field scattering corresponds to a sparse matrix.

Equation (1) represent Foldy-Lax equation in terms of exciting fields. One can also express the Foldy-Lax equation in terms of scattered fields

$${E}_{p}^{s} = {T}_{p} {E}_{p}^{ex} , \qquad ( 2 )$$

which provides the Foldy-Lax equation for scattered wave as the following equation:

$${E}_{q}^{s} = {T}_{q} {E}^{inc} + {T}_{q} {\sum }_{p = 1 , p \neq q}^{N} {G}_{qp} {E}_{p}^{s} , \qquad ( 3 )$$

where the scattered waves

$${E}_{p}^{s}$$

represent “scattered waves to others”. The procedure of the Foldy-Lax solution is as follows: (1) solve the Foldy-Lax scattered wave equation; and (2) for most problems, that is sufficient, because in most problems, only the final solution in the far field is required such as final scattering pattern of a metasurface. Using

$${E}_{p}^{s} ,$$

q=1, 2, . . . , N, one can calculate the far field solution of the problem by summing scattered waves from all scatterers in the far field.

A T-matrix provides the scattered field characteristics of a single scatterer in a unit cell to the scatterers of other unit cells. The T-matrix is part of the single scatterer solution. Applying wave vector functions, one obtains T-matrix elements in vector cylindrical waves (VCW) and in vector spherical waves (VSW). The T-matrices are coefficients of the wave expansions and are independent of distance. In metasurfaces, different scatterers are obtained by rotating the scatterers. Once the T-matrix of a scatterer is obtained, the new T-matrix elements of a rotated scatterer is computed by rotation of the T-matrix elements. In metasurfaces, the scatterers are of irregular shapes. The T-matrix expresses scattered fields outside an enclosing boundary: VCWs and VSWs use a cylindrical surface and a spherical surface, respectively. The three computational electromagnetic methods—finite difference frequency difference (FDFD), finite element method (FEM), and method of moments (MoM) can be employed to generate a dataset of electromagnetic fields for T-matrix extraction. In this disclosure, the in-house FDFD is used to calculate the T-matrix in VCW, whereas FEKO is used to calculate the T-matrix in VSW. Whether VCW or VSW is more advantageous depends on the shape of the scatterer and the placements of adjacent unit cells.

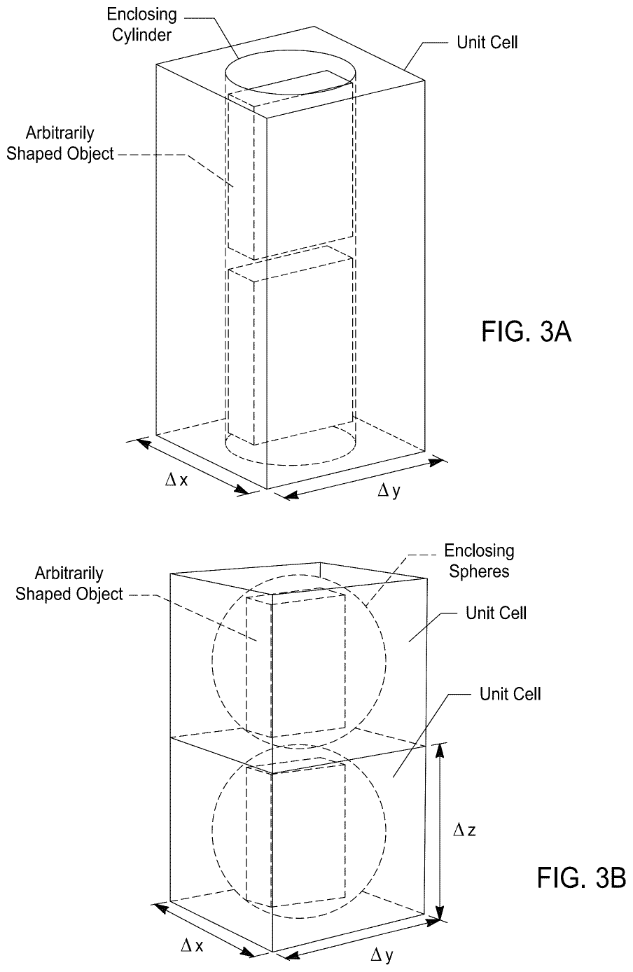

Unit cells with scatterers of high aspect ratios (a height exceeding a radius) forms a dense medium on the horizontal plane. Within an enclosing cylinder as shown in FIG. 3A, it is feasible to incorporate layered objects without causing intrusion. The procedure to extract VCW T-matrix elements is as follows. First, the scattered field dataset is fed into the T-matrix extraction algorithm. T-matrix elements are then calculated using either electromagnetic near-field solutions or far-field solutions since T-matrix elements represent the relationship between incident field coefficients and scattered field coefficients, independent of locations of field points. The electric fields are a product of T-matrix coefficients that are independent of the vector wave positions which are dependent on positions. In this disclosure, the far-field solutions are selected. Far field extractions do not include evanescent components of VCW. Evanescent waves of VCW are neglected in this disclosure. To determine the number of azimuthal modes, the inverse solutions and forward solutions of far-field amplitudes are compared. If the difference between them is within the tolerance, the T-matrix generation process is completed.

The far-field bistatic scattering amplitudes, fᵥᵥ, fᵥₕ, fₕᵥ, and fₕₕ of a single scatterer are first obtained. The T-matrix elements of VCW are next calculated using propagating kz mode, as shown in the equations below:

$${T}_{{nn}^{′}}^{( α , β )} ( k cos {θ}_{s} , k cos {θ}_{i} ) = ( {Kf}_{αβ} ) ( {θ}_{s} , {θ}_{i} ) = \frac{{ξ}_{α , β} sin {θ}_{i}}{8 {π}^{2} sin {θ}_{s}} {i}^{n - {n}^{′}} {\int }_{0}^{2 π} d {ϕ}_{s} {\int }_{0}^{2 π} d {ϕ}_{i} {e}^{i ( {n}^{′} {ϕ}_{i} - n {ϕ}_{s} )} {f}_{αβ} ( {θ}_{s} , {ϕ}_{s} ; {θ}_{i} , {ϕ}_{i} ) , \qquad ( 4 )$$

where

| | |
|---|---|
| ξ_{α, β} value | ƒ_{α, β} table |

| α/β | M | N | α/β | M | N |
|---|---|---|---|---|---|
| M | i | 1 | M | fₕₕ | fₕᵥ |
| N | −1 | i | N | fᵥₕ | fᵥᵥ |

The indices M and N in equation (4) denotes VCW modes corresponding to M and N vector wave functions. In equation (4), f_{αβ} is far-field scattering amplitude. Often the metasurface design for phase shift control requires rotating a scatterer within a unit cell. The rotation angle is defined by the azimuthal angle. T-matrix generation of a rotated object is readily obtained by applying a phase shift in the T-matrix without the need of another T-matrix extraction. The rotated T matrix is obtained from the following equation:

$${T}_{{mn}^{′} , rot}^{( α , β )} ( k cos {θ}_{s} , k cos {θ}_{i} ) = {e}^{i {α}_{rot} ( {n}^{′} - n )} {T}_{{mi}^{′}}^{( α , β )} ( k cos {θ}_{s} , k cos {θ}_{i} ) . \qquad ( 5 )$$

The memory usage for a single T-matrix is only 2.3 MB. This means that the T-matrix library of unit cells with rotated objects can be stored in memory to reduce CPU time. It should be noted that many unit cells in the metasurface share the same rotation angles, reducing the number of stored T-matrices. Once computed, they are re-useable and are put in a T-matrix library.

For some geometries, VSW offers advantages. The T-matrix of VSWs is defined by the region outside an enclosing sphere which encompasses the arbitrary shaped object. When defining enclosing spheres, it is necessary to select appropriate radii to prevent them from overlapping: while a single enclosing sphere can accommodate more than two vertically arranged objects, this configuration is not preferred on horizontally dense media since increasing the number of vertically arranged objects enlarges the maximum radius of the enclosing sphere, consequently causing overlapping enclosing spheres. Thus, as shown in FIG. 3B, a single unit cell encompasses a sphere that encloses a scatterer. By expressing far-field solutions in terms of VSW functions, T-matrix elements are extracted using the orthogonal properties of VSW functions. To address numerical issues arising from a large order, the normalized associated Legendre functions is adopted for VSWs:

$${P}_{n}^{( N ) m} ( x ) = {( - 1 )}^{m} \sqrt{\frac{( n + \frac{1}{2} ) ( n - m ) !}{( n + m ) !}} {P}_{n}^{m} ( x ) \qquad ( 6 )$$

$${P}_{n}^{( N ) ( - m )} ( x ) = {( - 1 )}^{m} {P}_{n}^{( N ) m} ( x ) .$$

The second equation in (6) is used to generate orders with the opposite sign of m. The T-matrix elements of the VSW are obtained by the following formula:

$${T}_{mn , {m}^{′} , {n}^{′}}^{MMN} = \frac{{k ( - 1 )}^{{m}^{′}} {i}^{n - {n}^{′} + 1}}{4 π} \int d Ω \int {Ω}^{′} {\overline{C}}_{- mn}^{( N )} ( θ , ϕ ) \cdot \overline{\overline{F}} ( θ , ϕ , {θ}^{′} , {ϕ}^{′} ) \cdot {\overline{C}}_{{m}^{′} {n}^{′}}^{( N )} ( {θ}^{′} , {ϕ}^{′} ) \qquad ( 7 )$$

$${T}_{mn , {m}^{′} , {n}^{′}}^{MN} = \frac{{k ( - 1 )}^{{m}^{′} + 1} {i}^{n - {n}^{′}}}{4 π} \int d Ω \int {Ω}^{′} {\overline{C}}_{- mn}^{( N )} ( θ , ϕ ) \cdot \overline{\overline{F}} ( θ , ϕ , {θ}^{′} , {ϕ}^{′} ) \cdot {\overline{B}}_{{m}^{′} {n}^{′}}^{( N )} ( {θ}^{′} , {ϕ}^{′} )$$

$${T}_{mn , {m}^{′} , {n}^{′}}^{NM} = \frac{{k ( - 1 )}^{{m}^{′}} {i}^{n - {n}^{′}}}{4 π} \int d Ω \int {Ω}^{′} {\overline{B}}_{- mn}^{( N )} ( θ , ϕ ) \cdot \overline{\overline{F}} ( θ , ϕ , {θ}^{′} , {ϕ}^{′} ) \cdot {\overline{C}}_{{m}^{′} {n}^{′}}^{( N )} ( {θ}^{′} , {ϕ}^{′} )$$

$${T}_{mn , {m}^{′} , {n}^{′}}^{NN} = \frac{{k ( - 1 )}^{{m}^{′}} {i}^{n - {n}^{′} + 1}}{4 π} \int d Ω \int {Ω}^{′} {\overline{B}}_{- mn}^{( N )} ( θ , ϕ ) \cdot \overline{\overline{F}} ( θ , ϕ , {θ}^{′} , {ϕ}^{′} ) \cdot {\overline{B}}_{{m}^{′} {n}^{′}}^{( N )} ( {θ}^{′} , {ϕ}^{′} )$$

where

$$\overline{\overline{F}} ( θ , ϕ , {θ}^{′} , {ϕ}^{′} ) = {f}_{vv} ( θ , ϕ , {θ}^{′} , {ϕ}^{′} ) \hat{θ} {\hat{θ}}^{′} + {f}_{vn} ( θ , ϕ , {θ}^{′} , {ϕ}^{′} ) \hat{θ} {\hat{ϕ}}^{′} + {f}_{hv} ( θ , ϕ , {θ}^{′} , {ϕ}^{′} ) \hat{ϕ} {\hat{θ}}^{′} + {f}_{hv} ( θ , ϕ , {θ}^{′} , {ϕ}^{′} ) \hat{ϕ} \hat{{ϕ}^{′}} ,$$

$${\overline{B}}_{mn}^{( N )} ( θ , ϕ ) = \frac{1}{\sqrt{2 π n ( n + 1 )}} [ \hat{θ} \frac{d}{d θ} {P}_{n}^{( N ) m} ( cos θ ) + \hat{ϕ} \frac{im}{sin θ} {P}_{n}^{( N ) m} ( cos θ ) ] {e}^{in ϕ} ,$$

$${\overline{C}}_{mn}^{( N )} ( θ , ϕ ) = \frac{1}{\sqrt{2 π n ( n + 1 )}} [ \hat{θ} \frac{im}{sin θ} {P}_{n}^{( N ) m} ( cos θ ) - \hat{ϕ} \frac{d}{d θ} {P}_{n}^{( N ) m} ( cos θ ) ] {e}^{in ϕ} .$$

The T-matrix elements by rotating the object inside the enclosing sphere are computed from the object with αᵣₒₜ. With the new variable Φ=φ−αᵣₒₜ, the following equations are obtained:

$${\overline{C}}_{- mn}^{( N )} ( θ , Φ + {α}_{rot} ) = {\overline{C}}_{mn}^{( N )} ( θ , Φ ) {e}^{- im {α}_{rot}} \qquad ( 8 )$$

$${\overline{C}}_{{m}^{′} {n}^{′}}^{( N )} ( θ , Φ + {α}_{rot} ) = {\overline{C}}_{{m}^{′} {n}^{′}}^{( N )} ( θ , Φ ) {e}^{- {im}^{′} {α}_{rot}}$$

$${\overline{B}}_{- mn}^{( N )} ( θ , Φ + {α}_{rot} ) = {\overline{B}}_{mn}^{( N )} ( θ , Φ ) {e}^{- im {α}_{rot}}$$

$${\overline{B}}_{{m}^{′} {n}^{′}}^{( N )} ( θ , Φ + {α}_{rot} ) = {\overline{B}}_{{m}^{′} {n}^{′}}^{( N )} ( θ , Φ ) {e}^{- {im}^{′} {α}_{rot}} .$$

By applying the new variable to equation (7) and substituting equation (8) into equation (7), one obtains the T-matrix elements with the rotated angle of the object, as shown below

$${T}_{mn , {m}^{′} {n}^{′}}^{MM ( {α}_{ot} )} = {T}_{mn , {m}^{′} {n}^{′}}^{MM} exp ( i ( {m}^{′} - m ) {α}_{rot} ) \qquad ( 9 )$$

$${T}_{mn , {m}^{′} {n}^{′}}^{MN ( {α}_{ot} )} = {T}_{mn , {m}^{′} {n}^{′}}^{MN} exp ( i ( {m}^{′} - m ) {α}_{rot} )$$

$${T}_{mn , {m}^{′} {n}^{′}}^{NM ( {α}_{ot} )} = {T}_{mn , {m}^{′} {n}^{′}}^{NM} exp ( i ( {m}^{′} - m ) {α}_{rot} )$$

$${T}_{mn , {m}^{′} {n}^{′}}^{NN ( {α}_{ot} )} = {T}_{mn , {m}^{′} {n}^{′}}^{NN} exp ( i ( {m}^{′} - m ) {α}_{rot} ) .$$

The T-matrix of the rotated objects are obtained from equation (9) without re-computing T-matrix extraction. Once T-matrices are computed, they are stored in T-matrix libraries. Unlike VCW, VSW do not have evanescent waves. T-matrices are obtained accurately from far field scattering amplitudes using accurate quadrature integrations of the 4-fold integrals in equation (7).

Since the single scatterer solution is known, the unknown in the multiple scattering problem is the final exciting field of the single scatterer. Foldy-Lax equation expresses the final excitation fields at the unit cell q as the sum of incident waves from the other unit cells and the incident waves,

$${E}_{q}^{EX} ( r ) = {E}_{q}^{inc} ( r ) + {\sum }_{p \neq q} {E}_{p}^{s} ( r ) \qquad ( 10 )$$

where

$${E}_{q}^{EX} ( r ) , {E}_{q}^{inc} ( r ) , and {E}_{p}^{s} ( r )$$

are the final excitation fields, incident waves, and scattered fields except p≠q. Each term in equation (10) is expressed by VCW functions, which lead to the following equations:

$${E}_{q}^{EX} ( {r}_{q} ) = {\sum }_{n} {\int }_{C} {dk}_{z} [ {a}_{n}^{EM} ( {k}_{z} ) {RgM}_{n} ( {k}_{z} , {rr}_{q} ) + {a}_{n}^{EN} {RgN}_{n} ( {k}_{z} , {rr}_{q} ) ] , \qquad ( 11 )$$

$${E}_{q}^{inc} ( {rr}_{q} ) = {\sum }_{n} {\int }_{C} {dk}_{z} [ {a}_{n}^{M , nn ( q )} ( {k}_{iz} ) {RgM}_{n} ( {k}_{z} , {rr}_{q} ) + {a}_{n}^{N , inc ( q )} ( {k}_{iz} ) {RgN}_{n} ( {k}_{z} , {rr}_{q} ) ] ,$$

$${E}_{p}^{S} ( {rr}_{p} ) = {\sum }_{n} {\int }_{C} {dk}_{z} [ {a}_{n}^{SM ( p )} ( {k}_{z} ) {M}_{n} ( {k}_{z} , {rr}_{p} ) + {a}_{n}^{SN ( p )} {N}_{n} ( {k}_{z} , {rr}_{p} ) ] ,$$

where

$$\begin{matrix}{a}_{n}^{M , inc ( q )} ( {k}_{\dot{\sum }} ) = exp ( {ik}_{i} \cdot {r}_{q} ) \frac{{i}^{n + 1} {e}^{- in {ϕ}_{i}}}{{k}_{i ρ}} {E}_{hi} δ ( {k}_{z} - {k}_{iz} ) , {a}_{n}^{N , inc ( q )} ( {k}_{iz} ) \\ = - exp ( {ik}_{i} \cdot {r}_{q} ) \frac{{i}^{n} {e}^{- in {ϕ}_{i}}}{{k}_{i ρ}} {E}_{vi} δ ( {k}_{z} - {k}_{iz} )\end{matrix} .$$

In the above equation rr_{q} means r−r_{q}. The same holds for the p index. Applying the translation addition theorem to

$${E}_{p}^{S} ( {rr}_{p} )$$

in equation (11), the VCW solutions of the Foldy-Lax equation are obtained as

$$( \begin{matrix}I - {F}^{MM} & - {F}^{MN} \\ - {F}^{NM} & I - {F}^{NN}\end{matrix} ) ( \begin{matrix}{a}^{SM} \\ {a}^{SN}\end{matrix} ) = ( \begin{matrix}{ψ}^{SM} \\ {ψ}^{SN}\end{matrix} ) \qquad ( 12 )$$

where

$${F}_{{qn}^{′} , pn}^{β , α} ( {k}_{z , {n}_{z}} , {k}_{z , nz}^{′} ) = {\sum }_{m} {T}_{{m}^{″} m}^{( β , α ) , q} ( {k}_{z , {n}_{z}} , {k}_{z , {n}_{z}}^{′} ) {σ}_{mn}^{qp} ( {k}_{z , {n}_{z}}^{′} ) ,$$

$${σ}_{mn}^{qp} ( {k}_{z , {n}_{z}} ) = \{ \begin{matrix}Δ {k}_{z} {H}_{m - n}^{( 1 )} ( {k}_{{ρ}_{z} , {n}_{z}} \vert {\overline{ρ}}_{p} - {\overline{ρ}}_{q} \vert ) exp ( - i ( m - n ) {ϕ}_{\overline{{ρ}_{p} {ρ}_{q}}} ) exp ( - {ik}_{z , {n}_{z}} ( {z}_{p} - {z}_{q} ) ) , & for q \neq p \\ 0 , & for q = p\end{matrix} ,$$

$${ψ}_{{qm}^{′}}^{S , β} ( {k}_{z , {n}_{z}} ) = {\sum }_{m} exp ( i {\overline{k}}_{i} \cdot {\overline{r}}_{q} ) \frac{{i}^{m} exp ( - im {ϕ}_{i} )}{{k}_{i ρ}} [ {iE}_{hi} {T}_{{m}^{′} m , q}^{( β , M )} ( {k}_{z , {n}_{z ′}} , {k}_{\dot{E}} ) - {E}_{vi} {T}_{{m}^{′} m , q}^{( β , N )} ( {k}_{z , {n}_{z ′}} , {k}_{\dot{z}} ) ] ,$$

$$α = M or N , β = M or N .$$

In equation (12), the unknowns α^{SM} and α^{SN} are the scattered field coefficients of each unit cell. The scattered field coefficients ψ^{SM} and ψ^{SN} are related to incident waves that act as sources. The size of a column vector is 2NₘNₙN_{q}, where Nₘ, Nₙ, and N_{q} are the numbers of k_{z} modes, azimuth modes, and unit cells, respectively. The Foldy-Lax equation describes the electromagnetic wave interaction, relating excitation and scattered field to the T-matrix elements. Because of this, T-matrices of the unit cells are embedded in the Foldy-Lax equation. Each unit cell can have a different T-matrix meaning that the scatterers in the metasurface can be all different. Thus, this approach is applicable to metasurfaces where all the scatterers can be different. Depending on the rotation angle of a unit cell, the precomputed T-matrix with the corresponding αᵣₒₜ is loaded from the T-matrix library into the FHMSTM code. The solutions of the Foldy-Lax equation are obtained by iterative methods as the number of scatterers is large. Triple Fast Fourier Transform (FFT) is proposed as a fast and efficient method of solving the Foldy-Lax equation for the metasurface.

To reduce CPU time and memory, the FFT is applied to equation (12) for the iterative method. The FFT operation offers fast computation of a matrix by a column vector and reduces memory usage. By applying FFT to the convolution

$$ψ ( {x}_{m} ) = {\sum }_{n = 1 , … , N} Δ {xg ( {x}_{m} - {x}_{n} )}_{j} ( {x}_{n} ) ,$$

m,nϵ{1, . . . , N}, it is computed with O(N log N) operations whereas the direct matrix multiplication takes O(N²). The function g(xₘ−xₙ) is Toeplitz matrix. In metasurfaces, the unit cells are arranged with uniform spacings of Δx along x-axis and Δy along y-axis on the horizontal plane. The translation addition theorem applied to the unit cell positions generates the Toeplitz matrix in the Foldy-Lax equation. As a result, the Foldy-Lax equation is solved with 2-D FFT in the x-y plane. Since unit cells enclose the vertical direction (z-axis), x-y positioned unit cells cover the entire space of the metasurface. The position of a unit cell p is defined as by two indices. The indices and range from 1 to Nₓ and from 1 to N_{y}, where Nₓ and N_{y} are the numbers of unit cells along the x-axis and along y-axis. The position of a unit cell q is defined by and with unprimed variables. Applying these notations to the translation addition theorem in the Fold-Lax equation, the following is formulated:

$$σ ( {α}_{g}^{′} - {α}_{g} , {β}_{g}^{′} - {β}_{g} , m - n ; {k}_{z , {n}_{z}} ) = \{ \begin{matrix}Δ {k}_{z} {H}_{m - n}^{( 1 )} ( {k}_{ρ , n} \vert {\overline{ρ}}_{p} - {\overline{ρ}}_{q} \vert ) exp ( - i ( m - n ) {ϕ}_{\overline{{ρ}_{p} {ρ}_{q}}} ) exp ( - {ik}_{z , {n}_{z}} ( {z}_{p} - {z}_{q} ) ) , & {α}_{g} \neq {α}_{g}^{′} , {β}_{g} \neq {β}_{g}^{′} \\ 0 , & otherwise\end{matrix} \qquad ( 13 )$$

where

$$\vert {\overline{ρ}}_{p} - {\overline{ρ}}_{q} \vert = \sqrt{Δ {{x}^{2} ( {α}_{g}^{′} - {α}_{g} )}^{2} + Δ {{y}^{2} ( {β}_{g}^{′} - {β}_{g} )}^{2}}$$

$${ϕ}_{\overline{{ρ}_{p} {ρ}_{q}}} = tan ( Δ y ( {β}_{g}^{′} - {β}_{g} ) / Δ x ( {α}_{g}^{′} - {α}_{g} ) ) .$$

It should be noted that the translation addition theorem function in equation (13) follows Toeplitz matrix with respect to

$${α}_{g}^{′} - {α}_{g} and {β}_{g}^{′} - {β}_{g} .$$

One FFT can be found in the azimuthal modes in the translation addition theorem since the translation addition theorem includes an order difference m−n of the azimuthal mode. Therefore, the 2-D spatial domain and the order difference in the Foldy-Lax equation allow one to utilize the FFT operation. Thus, the procedure is triple FFT with two orders in horizontal translation and one order in order difference of VCW functions. The translation addition matrix is multiplied by a column vector in iterative methods as it follows:

$${ψ}^{α} ( {α}_{g} , {β}_{g} , m ; {k}_{z} ) = {\sum }_{{α}_{g}^{′} = 1}^{{N}_{x}} {\sum }_{{β}_{g}^{′} = 1}^{{N}_{y}} {\sum }_{n = - {N}_{max}}^{{N}_{max}} σ ( {α}_{g}^{′} - {α}_{g} , {β}_{g}^{′} - {β}_{g} , m - n ; {k}_{z} ) {a}^{S α} ( {α}_{g}^{′} , {β}_{g}^{′} , n ; {k}_{z} ) \qquad ( 14 )$$

where the semicolon distinguishes variables for the FFT operation from k_{z}. Applying the FFT to each k_{z} sampling points, it becomes the following

$${\tilde{ψ}}^{a} = {FFT}^{- 1} \{ {σ}_{F} ∘ {a}_{F}^{S α} \} \qquad ( 15 )$$

where σ_{F} and

$${a}_{F}^{S α}$$

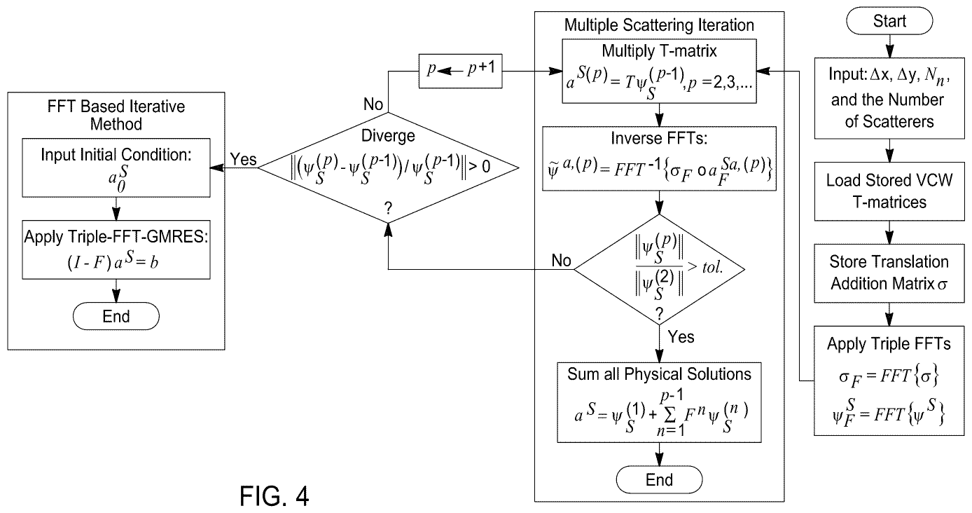

are the translation addition function and the scattered field coefficient after the FFT operation. The iteration method depends on ∥F∥. If ∥F∥<1, use multiple scattering approach. When the Foldy-Lax matrix satisfies, the scattered field coefficients are computed by the multiple scattering iteration approach as shown below

$${a}^{S} = {ψ}_{S} + F {ψ}_{S} + {F}^{2} {ψ}_{S} + … + {F}^{n - 1} {ψ}_{S} \qquad ( 16 )$$

where ψₛ consists of the sub-matrices ψ_{SM} and ψ_{SN}. Each term describes the electromagnetic interaction in the Foldy-Lax equation. As the multiple scattering order increases, the error is compared with that of the first order. If tolerance is under criteria, the multiple scattering iteration stops and provides the solution. If ∥F∥>1, the multiple scattering iteration approach is switched to the generalized minimal residual method (GMRES) iterative method. The proposed algorithm for computing multiple scattering with the FFT is shown in FIG. 4.

The FHMSTM-VSW utilizes the following vector wave functions

$$Rg {\overline{N}}_{mn} ( \overline{r} ) = {( - 1 )}^{m} [ \frac{n ( n + 1 ) {j}_{n} ( kr )}{kr} {\overline{P}}_{mn}^{( N )} ( θ , ϕ ) + \frac{{j}_{n} ( kr ) + kr {j}_{n}^{′} ( kr )}{kr} {\overline{B}}_{mn}^{( N )} ( θ , ϕ ) ] \qquad ( 17 )$$

$$Rg {\overline{N}}_{mn} ( \overline{r} ) = {( - 1 )}^{m} {j}_{n} ( kr ) {\overline{C}}_{mn}^{( N )} ( θ , ϕ )$$

$$where$$

$${\overline{P}}_{mn}^{( N )} ( θ , ϕ ) = \frac{1}{\sqrt{2 π n ( n + 1 )}} {P}_{n}^{( N ) m} ( cos θ ) exp ( im ϕ ) \hat{r} .$$

The VSW functions prefixed with ‘Rg’ refer to the regular function (the spherical Bessel function). Vector and matrix notations incorporate a bar and double bars, respectively, over the variables to distinguish the VCW wave functions from the VSW wave functions. Apply the same procedure used for the FHMSTM-VCW. The final excitation fields with the VSWs are expressed as shown below

$${\overline{E}}_{l}^{ex} ( \overline{r} ) = {\sum }_{mn} [ {w}_{mn}^{( M ) ( l )} Rg {\overline{M}}_{mn} ( k \overline{r} {\overline{r}}_{l} ) + {w}_{mn}^{( N ) ( l )} Rg {\overline{N}}_{mn} ( k {\overline{rr}}_{l} ) ] \qquad ( 18 )$$

where

$${w}_{mn}^{( M ) ( l )} and {w}_{mn}^{( N ) ( l )}$$

are final excitation coefficients. The scattered fields are obtained from the exciting fields as follows:

$${\overline{E}}_{l}^{s} ( \overline{r} ) = {\sum }_{mn} [ {a}_{mn}^{S ( M ) ( l )} {\overline{M}}_{mn} ( k \overline{{rr}_{l}} + {a}_{mn}^{S ( N ) ( l )} {\overline{N}}_{mn} ( k \overline{r} {\overline{r}}_{l} ) ] \qquad ( 19 )$$

where

$${a}_{mn}^{S ( M ) ( l )} = {\sum }_{m , n} {T}_{mn}^{MM ( l )} {w}_{mn}^{( M ) ( l )} + {T}_{mn}^{MN ( l )} {w}_{mn}^{( N ) ( l )} , \qquad ( 20 )$$

$${a}_{mn}^{s ( N ) ( l )} = {\sum }_{m , n} {T}_{mn}^{MN ( l )} {w}_{mn}^{( N ) ( l )} + {T}_{mn}^{NN ( l )} {w}_{mn}^{( N ) ( l )} .$$

$${T}_{mn}^{αβ}$$

denotes the T-matrix elements corresponding to α,βϵ{M,N}. Substituting equations (18) and (19) into the Foldy-Lax equation of equation (3) and applying the translation addition theorem, the derived multiple scattering equation as follows

$$[ \begin{matrix}{\overline{w}}^{M} \\ {\overline{w}}^{N}\end{matrix} ] = [ \begin{matrix}{\overline{b}}^{M} \\ {\overline{b}}^{N}\end{matrix} ] + [ \begin{matrix}\overline{\overline{A}} & \overline{\overline{B}} \\ \overline{\overline{B}} & \overline{\overline{A}}\end{matrix} ] [ \begin{matrix}{\overline{\overline{I}}}_{{T}_{NAN}} & {\overline{\overline{I}}}_{{T}_{NN}} \\ {\overline{\overline{I}}}_{{T}_{NAM}} & {\overline{\overline{I}}}_{{T}_{Nv}}\end{matrix} ] [ \begin{matrix}{\overline{w}}^{M} \\ {\overline{w}}^{N}\end{matrix} ] \qquad ( 21 )$$

$${a}_{mn}^{M ( l )} = 4 π {i}^{n} exp ( i {\overline{k}}_{i} \cdot {\overline{r}}_{l} ) [ \begin{matrix}{E}_{vi} ( {\hat{θ}}_{i} \cdot {\overline{C}}_{- mn}^{( N )} ( {θ}_{i} , {ϕ}_{i} ) ) \\ + {E}_{hi} ( {\hat{ϕ}}_{i} \cdot {\overline{C}}_{- mn}^{( N )} ( {θ}_{i} , {ϕ}_{i} ) )\end{matrix} ]$$

$${a}_{mn}^{N ( l )} = 4 π {i}^{n} exp ( i {\overline{k}}_{i} \cdot {\overline{r}}_{l} ) [ \begin{matrix}{E}_{vi} ( {\hat{θ}}_{i} \cdot ( - i {\overline{B}}_{- mn}^{( N )} ( {θ}_{i} , {ϕ}_{i} ) ) ) \\ + {E}_{hi} ( {\hat{ϕ}}_{i} \cdot ( - i {\overline{B}}_{- mn}^{( N )} ( {θ}_{i} , {ϕ}_{i} ) ) )\end{matrix} ]$$

where A̅, B̅, b̅^{M}, and b̅^{N} comprise the sub-matrices A̅^{(lj)}, B̅^{(lj)}, and the sub-vector ā^{M(l)}, and ā^{N(l)} respectively. In sub-matrices, unit cell indices are l,jϵ{1, 2, . . . , N}, where Nₛ is the total number of the unit cells. The parenthesis in superscripts of sub-matrices denote the indices of the unit cell. The block matrices and are translation addition matrices, with elements given by:

$${A}_{mn}^{( j )} = {A}_{mmμv} ( k \overline{{r}_{l} {r}_{j}} ) \qquad ( 22 )$$

$${B}_{mn}^{( j )} = {B}_{mnμv} ( k \overline{{r}_{i} {r}_{j}} ) .$$

Modifying the original form, the translation addition matrix elements with a normalized form are calculated as shown below,

$${A}_{mnμv} ( k \overline{{r}_{l} r} ) = \frac{{γ}_{μ v}}{{γ}_{mn}} {( - 1 )}^{μ} {\sum }_{p} \sqrt{\frac{( p + μ - m ) ! 2 π}{( p - μ + m ) ! ( p + 1 / 2 )}} a ( μ , v \vert - m , n \vert p ) \times a ( v , n , p ) {h}_{p} ( k \vert \overline{{r}_{l} {r}_{j}} \vert ) {Y}_{p}^{( N ) μ - m} ( {θ}_{lj} , {ϕ}_{lj} ) \qquad ( 23 )$$

$${B}_{mnμv} ( k {\overline{{r}_{l} r}}_{j} ) = - \frac{{γ}_{μ v}}{{γ}_{mn}} {( - 1 )}^{μ} {\sum }_{p} \sqrt{\frac{( p + μ - m ) ! 2 π}{( p - μ + m ) ! ( p + 1 / 2 )}} \times a ( μ , v \vert - m , n \vert p , p - 1 ) b ( v , n , p ) \times {h}_{p} ( k \vert \overline{{r}_{l} {r}_{j}} \vert ) {Y}_{p}^{( N ) μ - m} ( {θ}_{lj} , {ϕ}_{lj} )$$

where

$${Y}_{n}^{( N ) m} ( θ , ϕ ) = {( - 1 )}^{m} \sqrt{\frac{( n - m ) ! ( 2 n + 1 )}{4 π ( n + m )}} {p}_{n}^{m} ( cos θ ) exp ( im ϕϕ$$

$$a ( μ , v \vert - m , n \vert p ) = {( - 1 )}^{μ - m} ( 2 p + 1 ) \sqrt{\frac{( v + μ ) ! ( n - m ) ! ( p - μ + m ) !}{( v - μ ) ! ( n + m ) ! ( p + μ - m ) !}} ( \begin{matrix}v & n & p \\ μ & - m & - ( μ - m )\end{matrix} ) ( \begin{matrix}v & n & p \\ 0 & 0 & 0\end{matrix} )$$

$$a ( μ , v \vert - m , n \vert p , p - 1 ) = {( - 1 )}^{μ - m} ( 2 p + 1 ) \sqrt{\frac{( v + μ ) ! ( n - m ) ! ( p - μ + m ) !}{( v - μ ) ! ( n + m ) ! ( p + μ - m ) !}} ( \begin{matrix}v & n & p \\ μ & - m & - ( μ - m )\end{matrix} ) ( \begin{matrix}v & n & p - 1 \\ 0 & 0 & 0\end{matrix} ) .$$

The parentheses containing six elements represents the Wigner 3j symbols. The range of summation over p is performed only on non-zero elements of a(μ,v|−m,n|p) and a(μ,v|−m,n|p,p−1). The argument of the factorial function is no less than 0 in equation (23). Angles θᵢⱼ and φᵢⱼ in equation (23) are defined by the vector r̅ᵢ̅r̅ⱼ̅=r̅ᵢ−r̅ⱼ originating from r̅ⱼ. In equation (21), I̅_{T}_{_{MM}}, I̅_{T}_{_{MN}}, I̅_{T}_{_{NM}}, and I̅_{T}_{_{NN}} consist of the diagonal block matrices denoted by

$${\overline{\overline{T}}}_{MM}^{( lj )} , {\overline{\overline{T}}}_{MN}^{( lj )} , {\overline{\overline{T}}}_{NM}^{( lj )} , and {\overline{\overline{T}}}_{NN}^{( lj )} .$$

For i≠j, each block matrix has zero elements.

In the FHMSTM-VSW, 3D-FFTs are applied to three dimensional positions in the translation addition matrix A̅ and B̅. This provides the fast multiplication A̅ and B̅ by a column vector as well as compression of these achieving reduced memory usage. As shown in FIG. 2B and FIG. 3B, the positions of the scatterer are

$${x}_{l} = ( α - 1 ) Δ x - \frac{{x}_{sd}}{2} \qquad ( 24 )$$

$${y}_{l} = ( β - 1 ) Δ y - \frac{{y}_{sd}}{2}$$

$${z}_{l} = ( γ - 1 ) Δ z - \frac{{z}_{sd}}{2}$$

where αϵ{1, 2, . . . , Nₛ}, βϵ{1, 2, . . . N_{y}}, and γϵ{1, 2, . . . , Nₛ}. Translation addition matrices of the VSWs are defined by indices as

$${A}_{mnμv} ( k \overline{{r}_{l} {r}_{j}} ) = {σ}_{mnμv}^{A} ( α - {α}^{′} , β - {β}^{′} , γ - {γ}^{′} ) and {B}_{mnμv} ( k \overline{{r}_{l} {r}_{j}} ) = {σ}_{mnμv}^{B} ( α - {α}^{′} , β - {β}^{′} , γ - {γ}^{′} ) .$$

Translation addition matrix-column vector multiplication has the following form:

$${w}_{order}^{( mn )} ( α , β , γ ) = {\sum }_{μ v} {\sum }_{α , β , γ} {σ}^{( mnμv )} ( α - {α}^{′} , β - {β}^{′} , γ - {γ}^{′} ) {a}^{( μ v )} ( {α}^{′} , {β}^{′} , {γ}^{′} ) \qquad ( 25 )$$

where σ is either σ̅^{A} or σ̅^{B}, and its size is

$$( 2 {N}_{x} - 1 ) ( 2 {N}_{y} - 1 ) ( 2 {N}_{z} - 1 ) {{N}_{max}^{2} ( {N}_{max} + 2 )}^{2} .$$

In equation (25), the parenthesis in the superscript denotes the spherical wave orders. a^{(μv)}(α′,β′,γ′) is the result of multiplying block diagonal matrices of the T-matrix by the final excitation coefficients, either in the multiple-scattering iteration method or in the GMRES iterative method. The mapping of indices to angles and distance is shown below,

$$ϕ ( α - {α}^{′} , β - {β}^{′} ) = {tan}^{- 1} ( \frac{Δ y ( β - {β}^{′} )}{Δ x ( α - {α}^{′} )} ) \qquad ( 26 )$$

$$θ ( α - {α}^{′} , β - {β}^{′} , γ - {γ}^{′} ) = {tan}^{- 1} ( \frac{\sqrt{Δ {{x}^{2} ( α - {α}^{′} )}^{2} + Δ {{y}^{2} ( β - {β}^{′} )}^{2}}}{Δ z ( γ - {γ}^{′} )} )$$

$$r ( α - {α}^{′} , β - {β}^{′} , γ - {γ}^{′} ) = \sqrt{Δ {{x}^{2} ( α - {α}^{′} )}^{2} + Δ {{y}^{2} ( β - {β}^{′} )}^{2} + Δ {{z}^{2} ( γ - {γ}^{′} )}^{2}} .$$

The 3-D FFT is then applied to equation (25) as follows:

$${σ}_{F}^{( mnμv )} = FFT \{ {\tilde{σ}}^{( mnμv )} \} , \qquad ( 27 )$$

$${a}_{F}^{( μ v )} = FFT \{ {\tilde{a}}^{( μ v )} \} ,$$

$${\tilde{w}}_{order}^{( mn )} = {FFT}^{- 1} \{ {\sum }_{μ v} {σ}_{F}^{( m μμv )} ∘ {a}_{F}^{( μ v )} \} .$$

Finally,

$${w}_{order}^{( mn )}$$

is taken from the first octant of

$${\tilde{w}}_{order}^{( mn )}$$

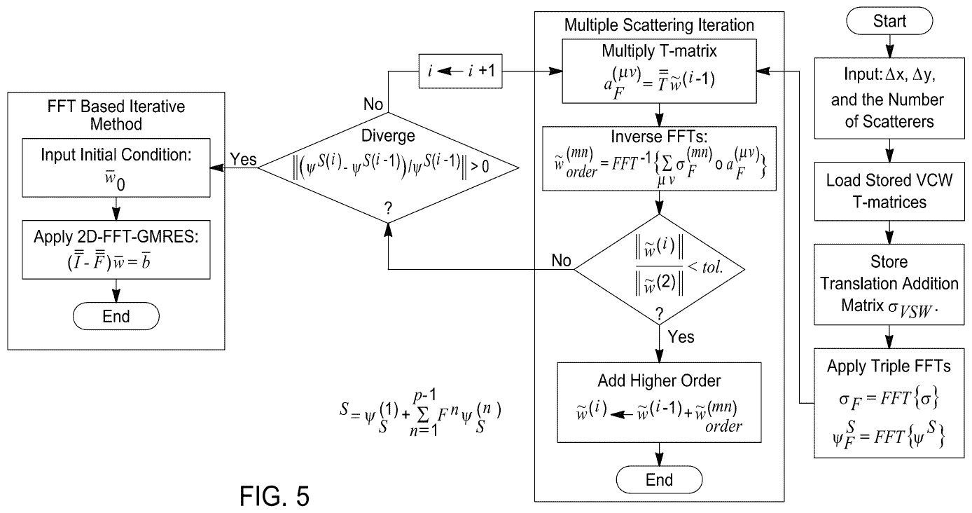

in equation (27). For the solutions of equation (21), the compact form is expressed as

$$( \overline{\overline{I}} - {\overline{\overline{F}}}_{VSW} ) \overline{w} = {\overline{b}}_{VSW} \qquad ( 28 )$$

where F̅_{VSW} is the translation addition matrix multiplied by the block diagonal T-matrices. Applying the multiple scattering iteration method, the final excitation field coefficients are expanded as

$$\overline{w} = {\overline{b}}_{VSW} + {\overline{\overline{F}}}_{VSW} {\overline{b}}_{VSW} + {\overline{\overline{F}}}_{VSW}^{2} {\overline{b}}_{VSW} + \qquad ( 29 )$$

where each term corresponds to the order of exciting waves. FFTs are iteratively applied to multiplication of F̅_{VSW} and the previous exciting wave order, which leads to excited field coefficients of a higher order. When the multiple scattering iteration solution diverges, the inversion of equation (28) is solved by the GMRES iterative method. The algorithm for fast multiple scattering using VSWs is described in FIG. 5.

The far-field solutions are often used for the metasurface analysis. The far-field solutions are derived by applying far-field approximation to VSW functions:

$${f}_{V ξ} ( {θ}_{s} , {ϕ}_{s} ) = {\sum }_{l} {\sum }_{n , m} \frac{exp ( - ik ( {x}_{l} sin {θ}_{s} cos {ϕ}_{s} + {y}_{l} sin {θ}_{s} sin {ϕ}_{s} + {z}_{l} cos {θ}_{s} ) )}{k} \times \times {{i}^{- n - 1} ( 1 )}^{m} {a}_{mn}^{SM ( l )} {\overline{C}}_{mn}^{( N )} ( {θ}_{s} , {ϕ}_{s} ) + {{i}^{- n} ( - 1 )}^{m} {a}_{mn}^{SM ( l )} {\overline{B}}_{mn}^{( N )} ( {θ}_{s} , {ϕ}_{s} ) ] \cdot \hat{θ} , \qquad ( 30 )$$

$${f}_{H ξ} ( {θ}_{s} , {ϕ}_{s} ) = {\sum }_{l} {\sum }_{n , m} \frac{exp ( - ik ( {x}_{l} sin {θ}_{s} cos {ϕ}_{s} + {y}_{l} sin {θ}_{s} sin {ϕ}_{s} + {z}_{l} cos {θ}_{s} ) )}{k} \times [ {{i}^{- n - 1} ( - 1 )}^{m} {a}_{mn}^{SM ( l )} {\overline{C}}_{mn}^{( N )} ( {θ}_{s} , {ϕ}_{s} ) + {{i}^{- n} ( - 1 )}^{m} {a}_{mn}^{SM ( l )} {\overline{B}}_{mn}^{( N )} ( {θ}_{s} , {ϕ}_{s} ) ] \cdot \hat{ϕ}$$

where ξ is ‘V’ for incident wave of vertical polarization and ‘H’ for horizontal polarization.

TABLE 1

| | | |
|---|---|---|
| | FHM- | FHM- |
| Parameter | VCW | VSW |

| | |
|---|---|
| w | 0.29 λ |
| l | 0.14 λ |

| | | |
|---|---|---|
| h | 0.92 λ | 0.98 λ |
| h_{gap} | 0.05 λ | 0.11 λ |

| | |
|---|---|
| pₓ | 0.60 λ |
| p_{y} | 0.60 λ |

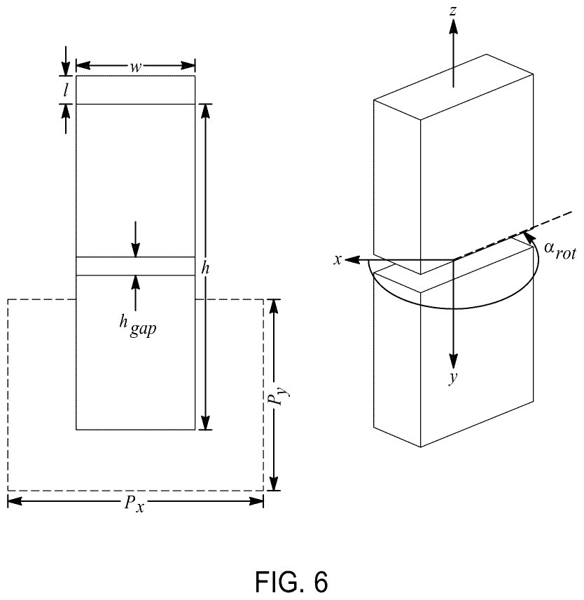

For the validations of the FHMSTM methods, compare the results of the fast hybrid multiple scattering method with commercial software. In metasurfaces, dielectric pins have been widely applied to manipulate electromagnetic waves. The double-layered dielectric pins are designed where the height is greater than both the width and length. The two dielectric pins arranged vertically can be contained by the enclosing cylinder for FHMSTM-VCW; whereas, a single pin is contained in the enclosing sphere for FHMSTM-VSW as shown in FIG. 3. In FIG. 6, the geometric parameters w, l, h, and hgap represent the dielectric pin's width, length, height, and gap length, respectively. The unit cell lengths, pₓ and p_{y}, are defined along x-axis and y-axis. The values of these parameters are shown in Table 1 above. Assuming a transparent substrate, consider the substrate material to be the air. The two dielectric pins are placed one on the top and the other on the bottom of the substrate, forming the gap between them. The relative permittivity of the dielectric pins is 8.9.

For validation, the FDFD inhouse solver is utilized, the T-matrix extraction algorithm is implemented, and its elements are generated. The total numbers of kz modes and azimuthal modes used are Nₘ=63 and Nₙ=3, respectively. Four unit cells of the dielectric pins are designed for comparison with full-wave simulation solvers. In each unit cell, a pair of dielectric pins are rotated by specific angles αᵣₒₜ=45°, 135°, 225°, and 315°. The wave vector follows the notation pointing out from the origin: where θ_{inc} and φ_{inc} are the angles of the incident wave. The angles used in the validation are θinc=150° and φinc=0°. Incident electric fields are y-polarized. The tolerance is set to 10⁻³ for multiple scattering iteration and 0.03 for the iterative method.

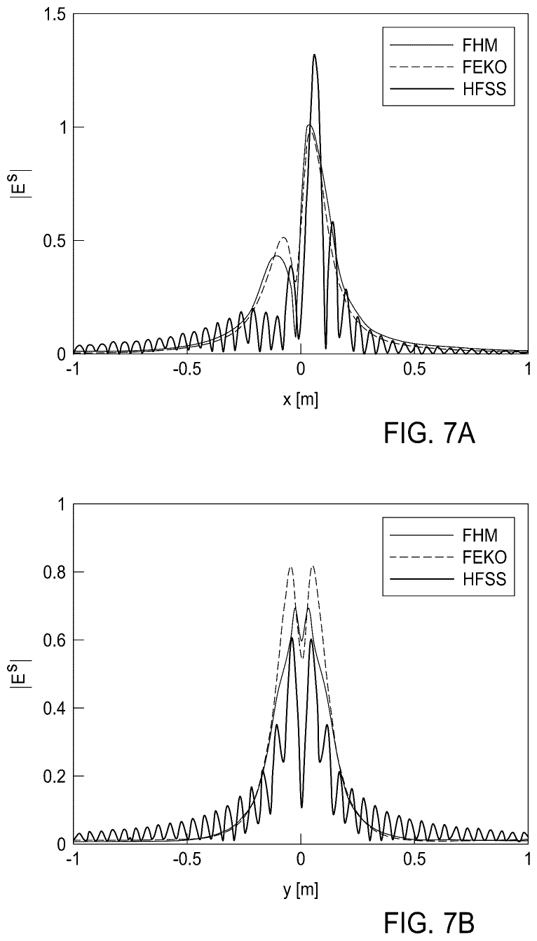

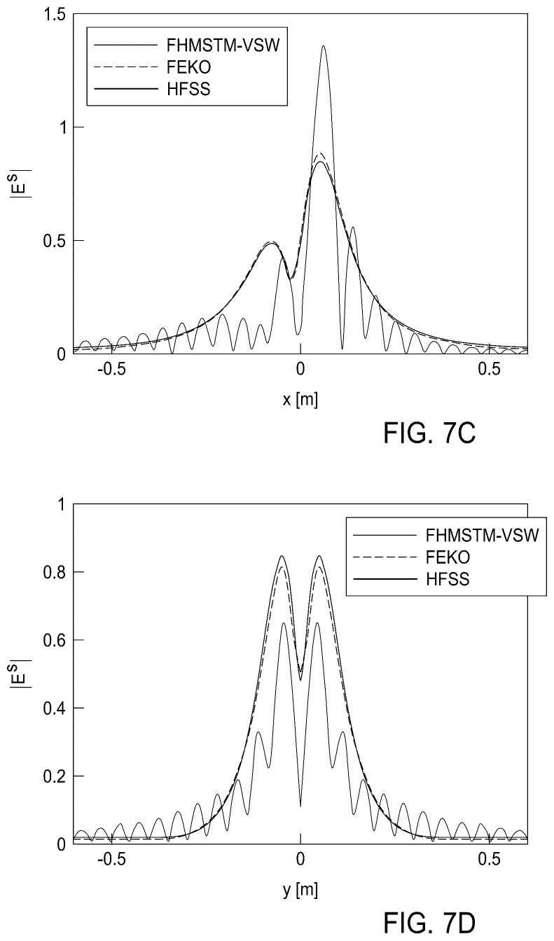

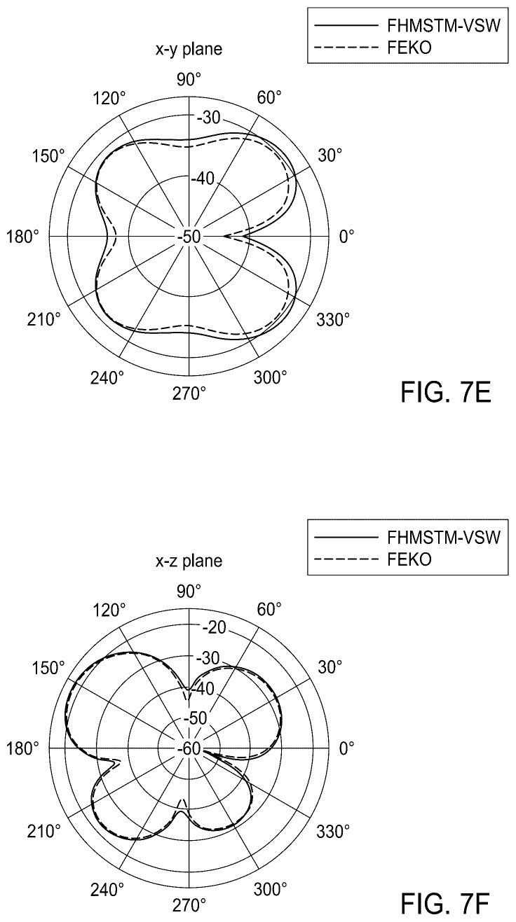

The full-wave solver FEKO and HFSS are used to compare the scattered fields of the FHMSTM. For the FEKO setup, one can choose the standard mesh to ensure correct discretization of the gap and activate the MLFMM default option for enhanced efficiency of CPU time and memory. The field points are positioned along the x-axis and y-axis at z=−λ, respectively. FIGS. 7B and 7C show the comparisons of the scattered fields obtained using FHMSTM VCWs and VSWs, respectively, against those simulated by commercial software FEKO and HFSS. The results of the FHMSTM are in good agreement with FEKO. The far-field solutions of VSWs are verified using FEKO as shown in FIG. 7D. The x-y plane corresponds to field points at θ=90° and 0°≤φ≤360°. The x-z plane represents 0≤θ≤360° and φ=0°. Note that the polar angle greater than 180° are conventionally mapped to 0≤θ≤180° and φ=180°.

Apply the FHMSTM-VCW and VSW to the optical metasurface lens as shown in FIG. 8. The metasurface is designed to focus the linear polarized waves onto the focal plane. The phase shift formula follows the equation below,

$${α}_{rot} ( {x}_{q} , {y}_{q} ) = \frac{π}{λ} ( f - \sqrt{{x}_{q}^{2} + {y}_{q}^{2} + {f}^{2}} ) \qquad ( 31 )$$

where f and λ are the focal length and the wave length, respectively. The scatterer in the q unit cell is rotated by the azimuthal angle αᵣₒₜ(x_{q}, y_{q}) for qϵ{1, 2, . . . , N}. Each unit cell manipulates the phase, which generates the focal point. The focal length is set to 7.7λ. The unit cell positions are xq and yq. These unit cell positions generate a unique set of αᵣₒₜ, the number of elements less than NxNy.

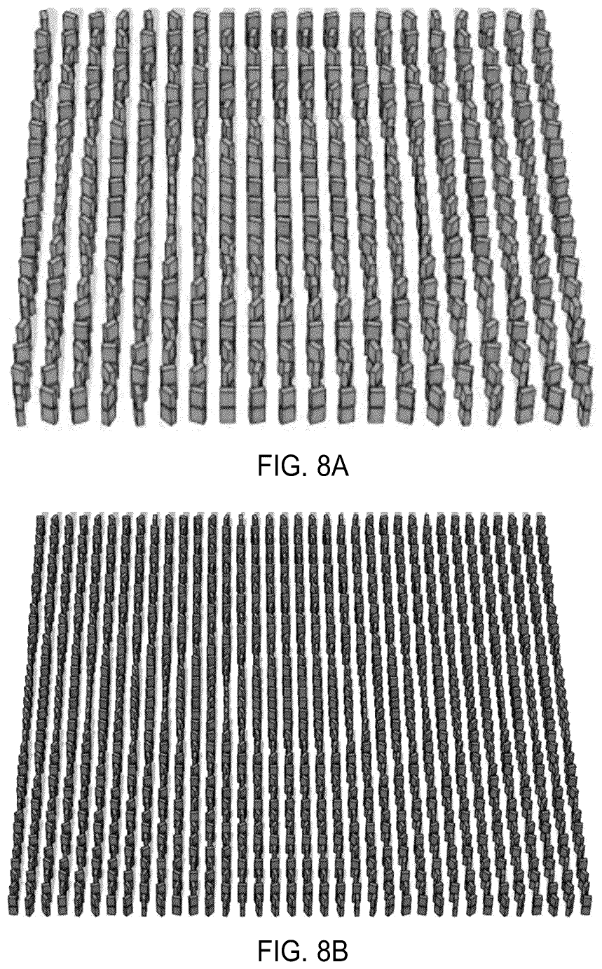

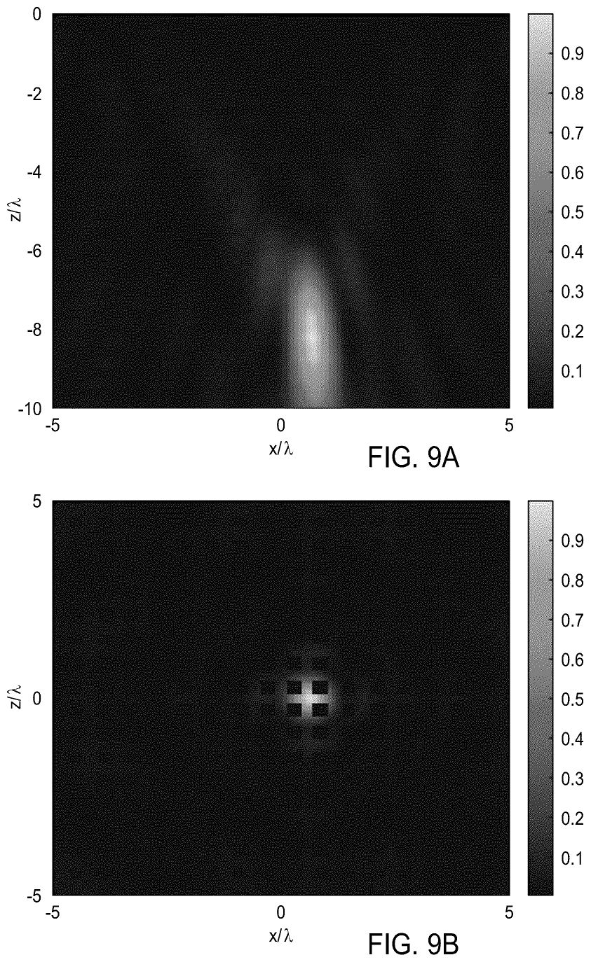

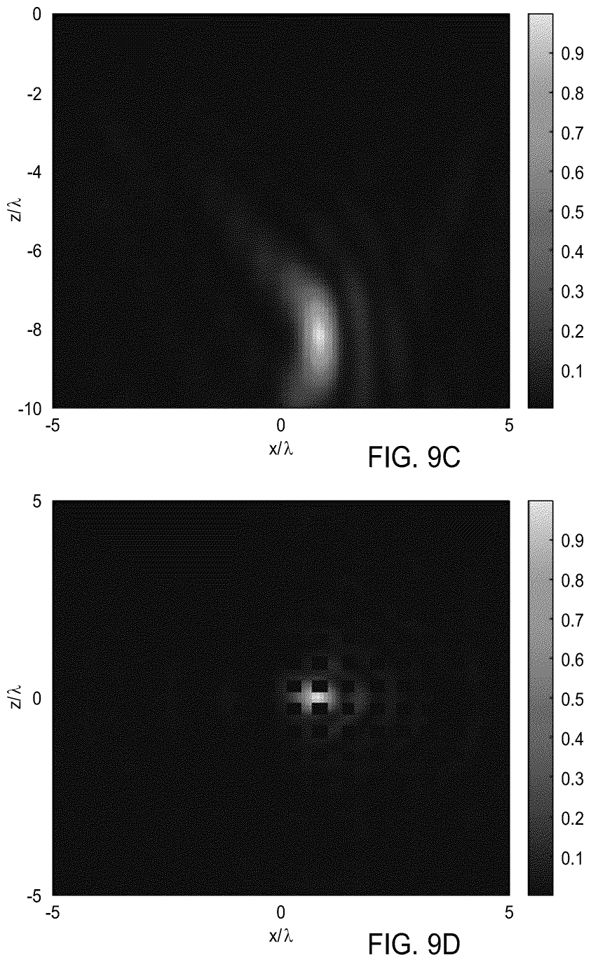

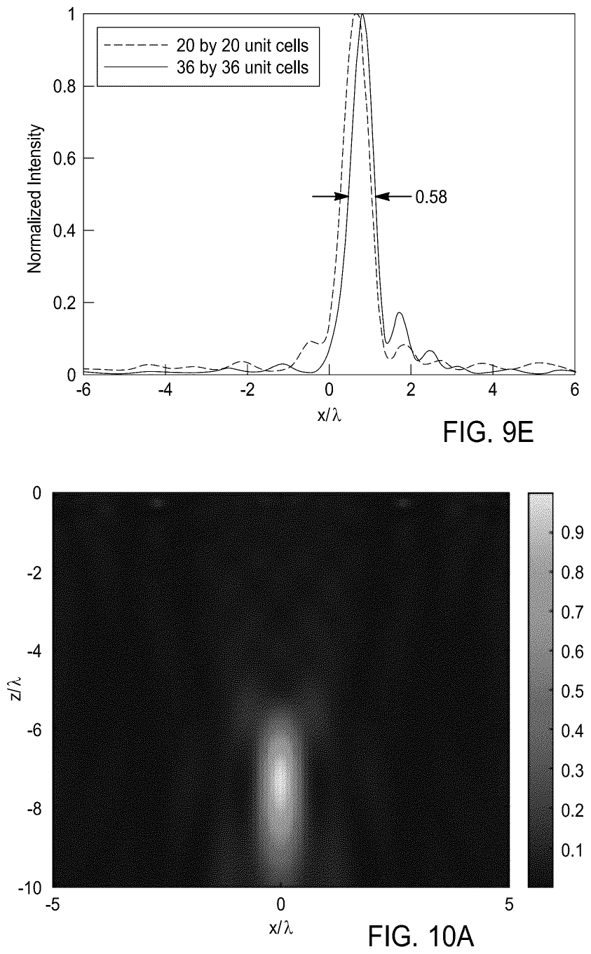

In FHMSTM-VCW simulation, the incident wave is y-polarized with oblique incident angle θ_{inc}=176° and φ_{inc}=0°. T-matrices are generated using azimuth rotation angles from the non-rotated T-matrix and subsequently stored in the library. Unit cell configurations of 20×20 and 36×36 are utilized to investigate the focus effects with respect to varying the number of unit cells. The iterative method of GMRES is used due to divergence of the multiple scattering iterative method. The intensities of the focal planes are shown in FIGS. 9A and 9B. As expected in the design parameters, one observes the focal length at z=−7.7λ. As the number of unit cells increases from 20 by 20 to 36 by 36, the full-width at half-maximum (FWHM) decreases from 0.77λ to 0.58λ, as shown in FIG. 9C.

The intensities of the focal planes are shown in FIGS. 9A and 9B. As expected in the design, one observes the focal length at z=−7.7λ. As the number of unit cells increases from 20 by 20 to 36 by 36, the full-width at half-maximum (FWHM) decreases from 0.77λ, to 0.58λ, as shown in FIG. 9C.

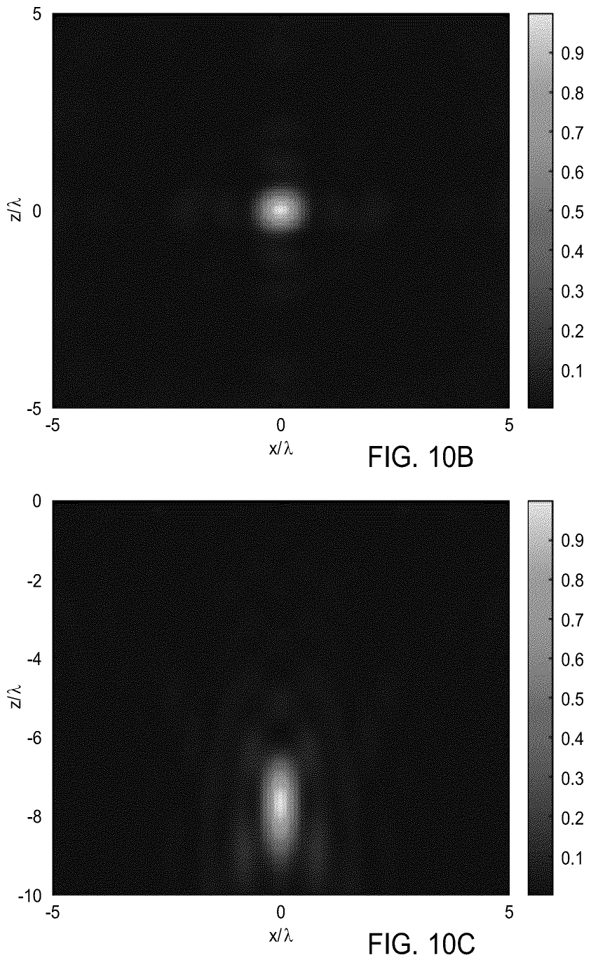

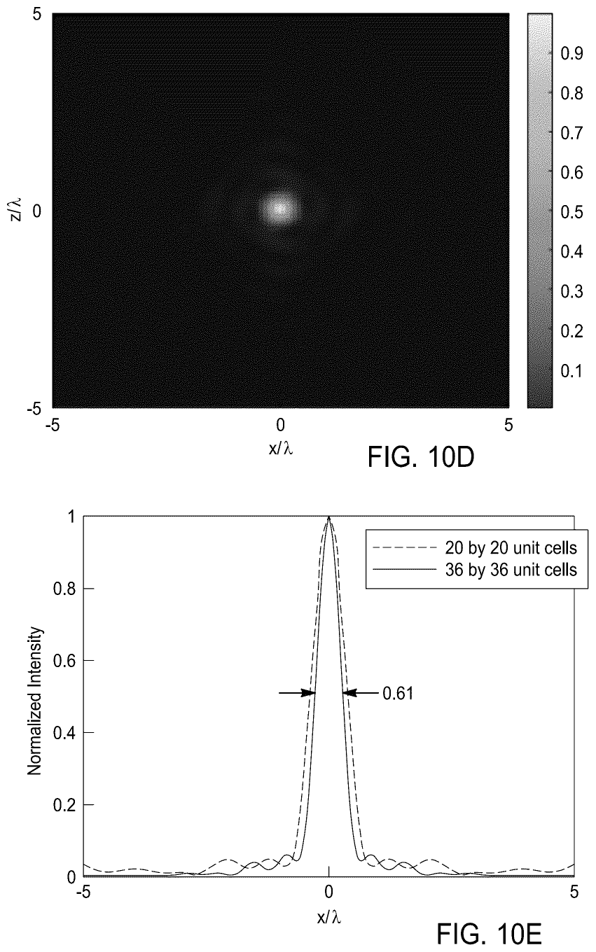

FHMSTM-VSW is also applied to the previous lens configuration using the unit cell of which the scattering characteristics are represented by the VSW. Two unit cells are vertically (z-direction) stacked to form two dielectric pins. The incident angles are normal incidence: θ_{inc}=180° and φ_{inc}=0°. The incident wave is linearly polarized in the y direction. Through the FHMSTM-VSW simulations, the intensities on the plane are obtained as shown in FIGS. 10A and 10B. The focal point is formed along z axis due to the normal incident wave. The normalized intensities show that the focal point is also formed at the center of the lens as shown in FIG. 10C. As the number of unit cells increase, the FWHM is clearly shown (FIGS. 10D and 10E) to reduce from 0.76λ to 0.61λ. 36×36-unit cell configuration results in flat intensities outside the focal area, with intensities to nearly zero.

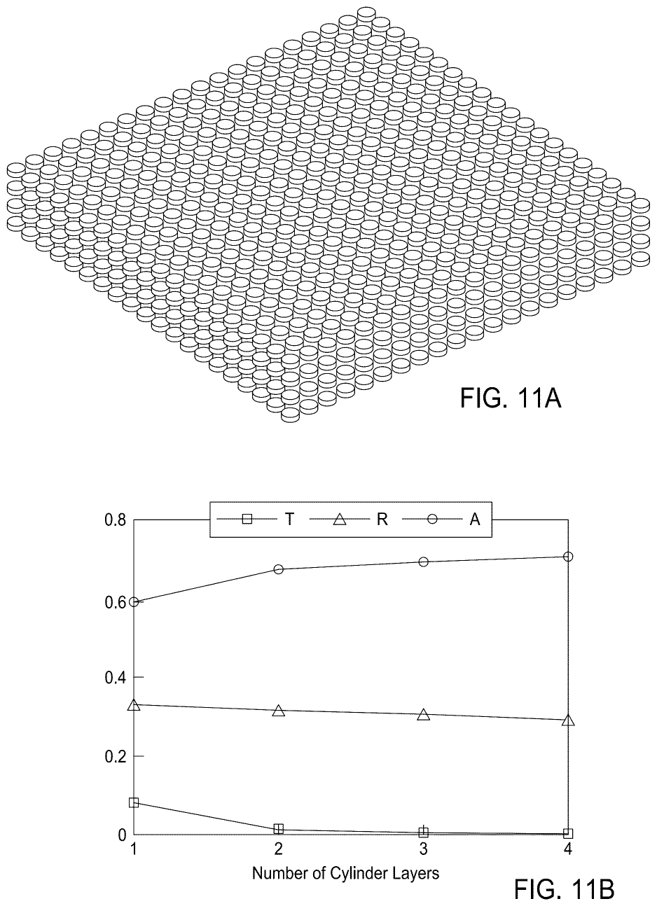

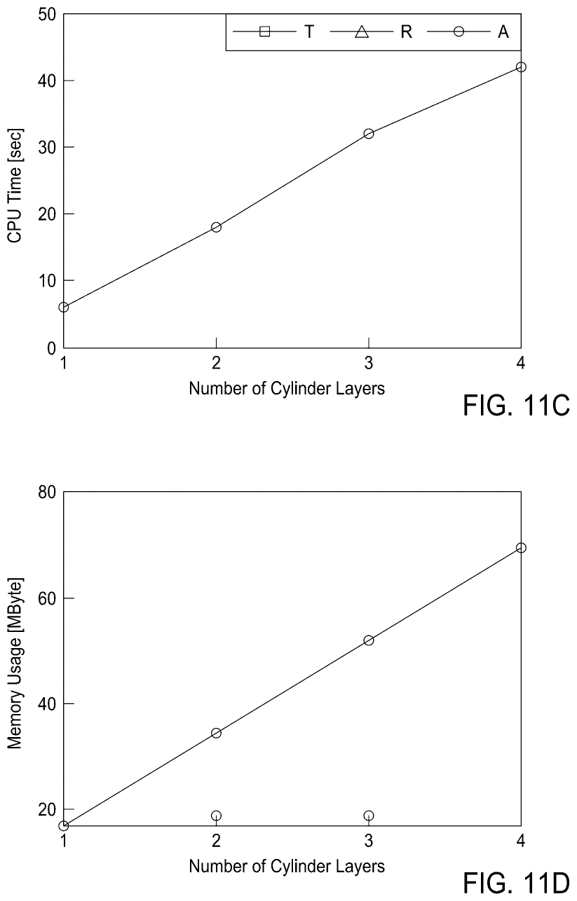

Next, apply the FHMSTM-VSW to metasurface optical absorber. Utilizing silicon materials and resonance of a cylinder structure, the dielectric metasurfaces (FIG. 11A) absorb electromagnetic waves. The absorber design parameters are shown in Table 2 below. In the FHMSTM analysis, one can use the same normal incident wave as in the previous subsection. The relative permittivity of the silicon material is 12.25 with a loss tangent of 0.07. The absorbance is obtained by A(λ)=1−T(λ)−R(λ), where transmittance T(λ) and reflectance R(λ) are extracted from the FHMSTM solver. To find the effects of the number of cylinder layers on absorbance, simulations were conducted with structures ranging from one to four cylinder layers. An absorbance of 0.6 is observed for a single cylinder layer. As the number of cylinder layers increases, the reflectance linearly decreases while the transmittance drops quickly as shown in FIG. 11B. From three to four cylinder layers, the absorbance reaches saturation. The computation of the FHMSTM-VSW is highly efficient for unit cells arranged along z-direction. FIGS. 11C and 11D show that the CPU time and memory usage increase with the number of cylinder layers n, which follows O(n). Details of the CPU time and memory and comparisons with commercial software are discussed in the next section.

TABLE 2

| Parameter | Value |
|---|---|
| h | 0.2λ |
| d | 0.43λ |
| pₓ | 0.61λ |
| p_{y} | 0.61λ |
| p_{z} | 0.5λ |

The Foldy-Lax equation describes electromagnetic interactions outside the unit cells. Outside the unit cell, one can express the fields using a finite number of VCW or VSW functions (two orthogonal basis functions). The computation of the Foldy-Lax equation is further enhanced with the FFT algorithm during a matrix-vector multiplication operation. Thus, in FHMSTM with VCWs, the computational complexity and memory follow

$$O ( {N}_{q} {N}_{n}^{2} {N}_{m}^{2} + {N}_{m} {N}_{q} {N}_{n} log {N}_{q} {N}_{n} ) and O ( {N}_{n}^{2} {N}_{m}^{2} + {N}_{m} {N}_{q} {N}_{n} ) ,$$

respectively. In FHMSTM with VSWs, the computational complexity and memory achieve

$$O ( {{N}_{max}^{2} ( {N}_{max} + 2 )}^{2} {N}_{q} log {N}_{q} ) and O ( {{N}_{max}^{2} ( {N}_{max} + 2 )}^{2} + {N}_{q} {{N}_{max}^{2} ( {N}_{max} + 2 )}^{2} ) ,$$

respectively.

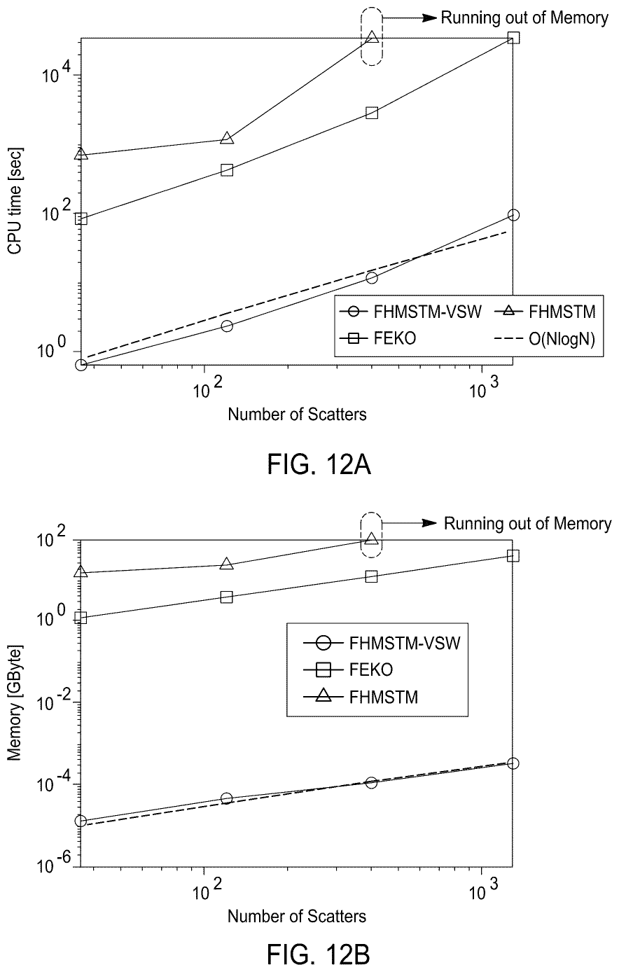

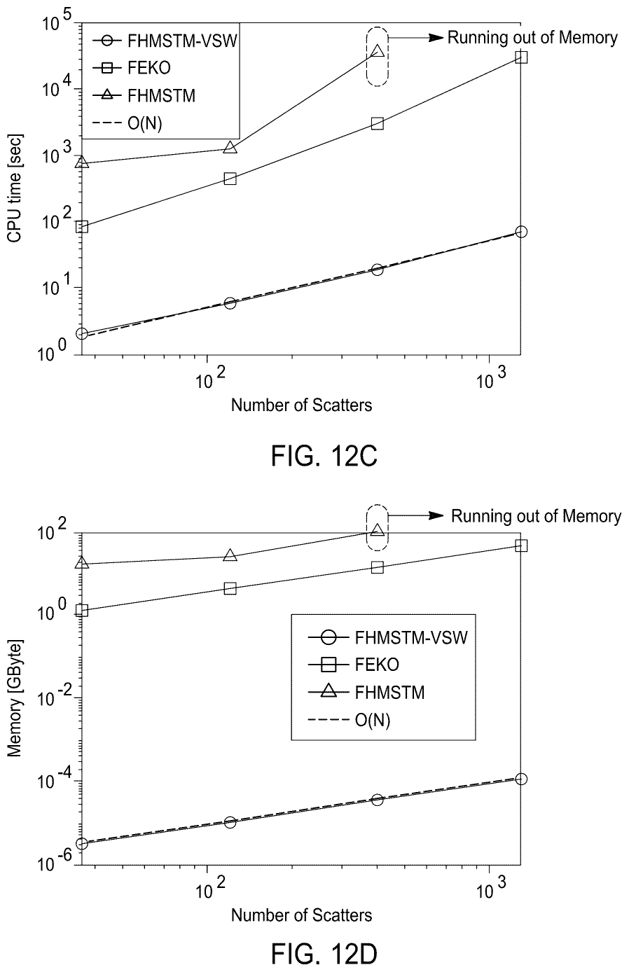

Simulations were performed on a desktop computer with an i9-12900k processor and 128-GB RAM to estimate the computational efficiency. High performance computing is not required in the FHMSTM simulation. For fair comparisons, the FHMSTM, FEKO, and HFSS were executed on the same computer, with all three solvers deactivating the parallel processing. The CPU time and memory requirement are summarized in Table 3 below, and the computational complexity is shown in FIGS. 12A-12D. The FHMSTM maintains lower CPU time and memory than those of FEKO and HFSS. For the simulation of 400 unit cells, the FHMSTM-VCW is 243 times faster than FEKO and 2,934 times faster than HFSS. When simulating 1,296 unit cells, memory limitations become a critical bottleneck: HFSS cannot solve the problem due to “out of memory”, while FEKO requires 46 GB. Although FEKO is still available for 1,296 unit cells, hours of CPU time renders it unsuitable for optimization or fine tuning to further improve performance. The FHMSTM-VSW shows comparable performance with the FHMSTM-VCW. The advantage of using FHMSTM-VSWs is to maintain lower CPU time and memory than the FHMSTM-VCW when unit cells exceed 400. For the case of 1296 unit cells, CPU time of the FHMSTM-VSW shows 442 times faster than that of FEKO. These results indicate that commercial solvers are inefficient for large-scale metasurface problems with many unit cells. On the other hand, the FHMSTM efficiently solves multiple scattering problems using the Foldy-Lax equation, reducing CPU time and memory requirements.

TABLE 3

| N unit cell | | 36 | 121 | 400 | 1296 |
|---|---|---|---|---|---|
| CPU | FHMSTM- | 0.63 | 2.5 | 12 | 96 |
| time | VCW | | | | |
| (sec) | FHMSTM- | 2 | 6 | 19 | 70 |
| | VSW | | | | |
| | FEKO | 82 | 434 | 2916 | 30929 |
| | HFSS | 742 | 1237 | 35216 | N.A. |
| Mem- | FHMSTM- | 0.015 | 0.052 | 0.129 | 0.376 |
| ory | VCW | | | | |
| (GB) | FHMSTM- | 0.0033 | 0.0111 | 0.0365 | 0.116 |
| | VSW | | | | |
| | FEKO | 1.3 | 4.4 | 14.5 | 46 |
| | HFSS | 16.5 | 26.1 | 104 | N.A. |

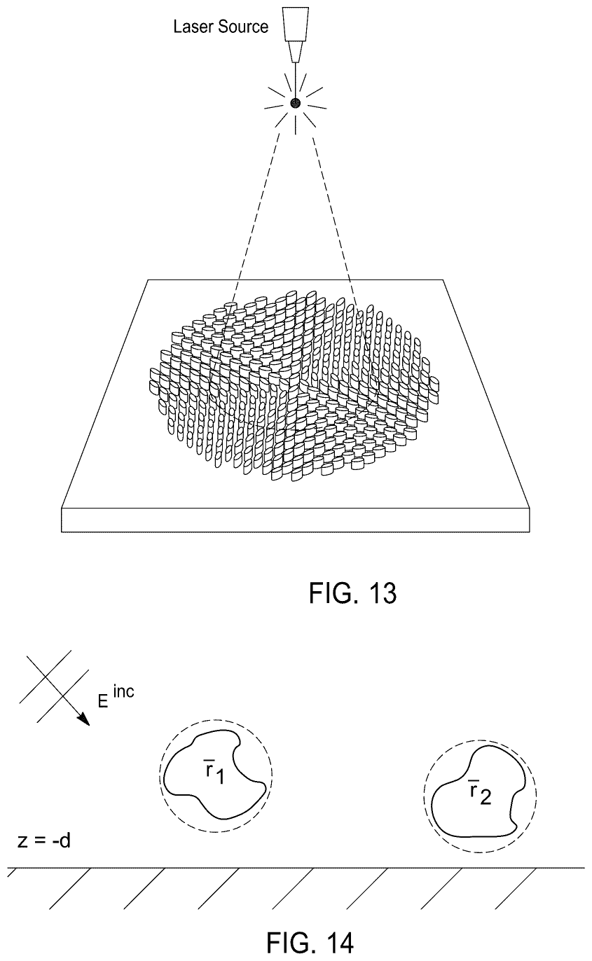

In metasurface, often the scatterers are placed above a dielectric substrate. Thus, it is important to include the dielectric substrate in full-wave simulations. In another aspect of this disclosure, a variant of the proposed fast hybrid method is developed for a metasurface with a dielectric substrate. To include the dielectric substrate, the substrate is treated as a single scatterer and the T matrix is derived using Vector Plane Waves (VPW). With reference to FIG. 13, the geometrical configuration of a laser beam incident on the metasurface is shown with unit cells placed above the dielectric substrate. The extent of laser beam is confined within the domain of the unit cells of the metasurface. Thus, in the full wave simulations, the dielectric substrate is treated as infinite in extent. In the T matrix of VPW, the evanescent waves of the dielectric substrate are included by using complex angles. T matrix of Vector Spherical waves (VSW) is used for the scatterers. Foldy Lax multiple scattering equations are formulated in terms of Vector spherical waves (VSW) and Vector Plane waves (VPW). Transformations between VPW and VSW are applied. Numerical solutions of the Foldy Lax equations are accelerated by using FFT.

Consider N scatterers above a surface. Let E^{inc} be the incident wave, Tₚ, p=1, 2 . . . N be the T matrix of the scatterers, Tₛᵤᵣ is the T matrix of the surface. Then the multiple scattering equations of Foldy Lax govern the final exciting field,

$${E}_{q}^{ex} ,$$

q=1, 2, . . . N of the scatterers and

$${E}_{sur}^{ex} ,$$

the final exciting field of the surface. The Foldy Lax equations, in symbolic form, are

$${E}_{q}^{ex} = {E}^{inc} + {\sum }_{p = 1 , p \neq q}^{N} {G}_{qp} {T}_{p} {E}_{p}^{ex} + {G}_{q , sur} {T}_{sur} {E}_{sur}^{ex} \qquad ( 32 )$$

$${E}_{sur}^{ex} = {E}^{inc} + {\sum }_{p = 1}^{N} {G}_{sur , p} {T}_{p} {E}_{p}^{ex} \qquad ( 33 )$$

where G_{qp} is the propagator from scatterer p to scatterer q, G_{q, sur} is the propagator from the surface to the q th scatterer, and G_{sur,p} is the propagator from the pth scatterer to the surface.

Observations of Fold-Lax multiple scattering equations are as follows. The final exciting fields are the unknowns. The final exciting field of a scatterer is due to the incident wave plus the scattered fields from other scatterers to that scatterer. The advantage of the Foldy-Lax equations is that they only require scattering from a scatterer to all other scatterers. The dielectric substrate is a scatterer with T matrix Tₛᵤᵣ. The Foldy Lax equations do not require the field solutions everywhere. The use of T-matrix is to calculate scattering to other scatterers. The T-matrix only requires a subset of information of the “single scatterer” solution. There is no spatial discretization in the Foldy Lax equations. Since N is large, a fast summation of scattering from a large number of other scatterers is needed. After the final exciting field of scatterers are computed, one can calculate the fields “everywhere” by using the “single scatterer solution” of each scatterer For scatterers that are close to each other, just as the nearest neighbors, one can decompose into near scatterers and non-near scatterers. Near field scattering corresponds to a sparse matrix.

Equation 32 is Foldy Lax equations in terms of exciting fields. One can also use Foldy Lax equation in terms of scattered field

$${E}_{q}^{s} = {T}_{q} {E}^{inc} + {T}_{q} {\sum }_{p = 1 , p \neq q}^{N} {G}_{qp} {E}_{p}^{s} + {T}_{q} {G}_{q , sur} {E}_{sur}^{s}$$

$${E}_{sur}^{s} = {T}_{sur} {E}^{inc} + {T}_{sur} {\sum }_{p = 1}^{N} {G}_{sur , p} {E}_{p}^{s}$$

The scattered fields above are that of scattered waves to other scatterers.

Consider an incident wave upon the surface. The incident exciting field Ē^{E} of surface is, in VPW,

$${\overline{E}}^{E} = {\int }_{- ∞}^{∞} {dk}_{x} {\int }_{- ∞}^{∞} {dk}_{y} exp ( i \overline{K} \cdot \overline{r} ) ( {a}^{E ( e )} ( {k}_{x} , {k}_{y} ) ê ( {k}_{x} , {k}_{y} , - {k}_{z} ) + {a}^{E ( h )} ( {k}_{x} , {k}_{y} ) \hat{h} ( {k}_{x} , {k}_{y} , - {k}_{z} ) )$$

where (e) is TE polarization and (h) is TM polarization, a^{E(e)}(kₓ,k_{y}) and a^{E(h)}(kₓ, k_{y}) are respectively the exciting field coefficients for TE and TM respectively. There are 4 T matrix components

$${T}^{( ee )} ( {k}_{x} , {k}_{y} , {k}_{x}^{′} , {k}_{y}^{′} ) , {T}^{( eh )} ( {k}_{x} , {k}_{y} , {k}_{x}^{′} , {k}_{y}^{′} ) ,$$

$${T}^{( he )} ( {k}_{x} , {k}_{y} , {k}_{x}^{′} , {k}_{y}^{′} ) , {T}^{( hh )} ( {k}_{x} , {k}_{y} , {k}_{x}^{′} , {k}_{y}^{′} ) ,$$

where (kₓ, k_{y}) and

$$( {k}_{x}^{′} , {k}_{y}^{′} )$$

are wave vector components of the scattered wave and incident field respectively. For plane waves with incident angle (θᵢ, φᵢ) and scattered angles (θₛ, φₛ), the relations to wave vector components are

$${k}_{x} = k sin {θ}_{s} cos {ϕ}_{s} , {k}_{y} = k sin {θ}_{s} sin {ϕ}_{s} ,$$

$${k}_{x}^{′} = k sin {θ}_{i} cos {ϕ}_{i} , {k}_{y}^{′} = k sin {θ}_{i} sin {ϕ}_{i} .$$

In terms of T matrix coefficients

$${a}^{s ( e )} ( {k}_{x} , {k}_{y} ) = {\int }_{- ∞}^{∞} {\int }_{- ∞}^{∞} {dk}_{x}^{′} {dk}_{y}^{′} [ {T}^{( ee )} ( {k}_{x} , {k}_{y} , {k}_{x}^{′} , {k}_{y}^{′} ) {a}^{E ( e )} ( {k}_{x}^{′} , {k}_{y}^{′} ) + {T}^{( eh )} ( {k}_{x} , {k}_{y} , {k}_{x}^{′} , {k}_{y}^{′} ) {a}^{E ( h )} ( {k}_{x}^{′} , {k}_{y}^{′} ) ]$$

$${a}^{s ( h )} ( {k}_{x} , {k}_{y} ) = {\int }_{- ∞}^{∞} {\int }_{- ∞}^{∞} {dk}_{x}^{′} {dk}_{y}^{′} [ {T}^{( he )} ( {k}_{x} , {k}_{y} , {k}_{x}^{′} , {k}_{y}^{′} ) {a}^{E ( e )} ( {k}_{x}^{′} , {k}_{y}^{′} ) + {T}^{( hh )} ( {k}_{x} , {k}_{y} , {k}_{x}^{′} , {k}_{y}^{′} ) {a}^{E ( h )} ( {k}_{x}^{′} , {k}_{y}^{′} ) ]$$

The representation is a general expression of surface, and has been applied to rough surface. In general, the T matrix coefficients of the surface can be computed by CEM such as FEM, FD, MoM, MLFMM or SMCG so that the T matrix coefficients are exact without approximations.

For the case of a planar surface with a layered medium

$${\overline{E}}^{s} = {\int }_{- ∞}^{∞} {dk}_{x} {\int }_{- ∞}^{∞} {dk}_{y} exp ( i \overline{k} \cdot \overline{r} ) ( {R}^{TE} ( {k}_{x} , {k}_{y} ) {a}^{E ( e )} ( {k}_{x} , {k}_{y} ) ê ( {k}_{x} , {k}_{y} , {k}_{z} ) + {R}^{TM} ( {k}_{x} , {k}_{y} ) {a}^{E ( h )} ( {k}_{x} , {k}_{y} ) \hat{h} ( {k}_{x} , {k}_{y} , {k}_{z} ) )$$

where R^{TE}(kₓ,k_{y}) and R^{TM}(kₓ,k_{y}) are TE and TM reflection coefficients of layered medium. For discrete scatterer, the T matrix are in VSW in this disclosure.

For VSW, the exciting field is

$${\overline{E}}^{E} = {\sum }_{m , n} ( {a}_{mn}^{E ( M )} Rg {\overline{M}}_{mn} ( k \overline{r} ) + {a}_{mn}^{E ( N )} Rg {\overline{N}}_{mn} ( k \overline{r} ) )$$

The scattered field is

$${\overline{E}}^{S} = {\sum }_{m , n} ( {a}_{m , n}^{s ( M )} {\overline{M}}_{mn} ( k \overline{r} ) + {a}_{m , n}^{s ( M )} {\overline{N}}_{mn} ( k \overline{r} ) )$$

The T matrix in VSW are then defined by

$${a}_{m , n}^{s ( M )} = {\sum }_{m , {n}^{′}} ( {T}_{{mnm}^{′} {n}^{′}}^{( MM )} {a}_{{m}^{′} {n}^{′}}^{E ( M )} + {T}_{{mnm}^{′} {n}^{′}}^{( MN )} {a}_{{m}^{′} {n}^{′}}^{E ( N )} )$$

$${a}_{m , n}^{s ( N )} = {\sum }_{m , {n}^{′}} ( {T}_{{mnm}^{′} {n}^{′}}^{( NH )} {a}_{{m}^{′} {n}^{′}}^{E ( M )} + {T}_{{mnm}^{′} {n}^{′}}^{( NN )} {a}_{{m}^{′} {n}^{′}}^{E ( N )} )$$

where n=1, 2, . . . and m=0, ±1, ±2, . . . . In notations, one can combine the two indices into 1, (m, n)→l.

Next, the transformation of T matrix from VSW to VPW is derived. The expressions of the electromagnetic fields in VPW for the case of electric dipoles and magnetic dipoles which are the expressions for n=1 can be found in the book “Electromagnetic Wave Theory 2000”. The transformation between outgoing waves of VSW is derived in terms of VPW for general n. The expressions are derived from using the dyadic Green's functions in VPW and VSW.

The dyadic Green's function for VPW is

$${{G}^{=}}_{0} ( \overline{r} , {\overline{r}}^{′} ) = \frac{i}{8 {π}^{2}} {\int }_{- ∞}^{∞} {dk}_{x} {\int }_{- ∞}^{∞} {dk}_{y} \frac{1}{{k}_{z}} ( \hat{e} ( {k}_{x} , {k}_{y} , - {k}_{z} ) \hat{e} ( {k}_{x} , {k}_{y} , - {k}_{z} ) + \hat{h} ( {k}_{x} , {k}_{y} , - {k}_{z} ) \hat{h} ( {k}_{x} , {k}_{y} , - {k}_{z} ) exp ( i \overline{K} \cdot \overline{r} ) exp ( - i \overline{K} \cdot {\overline{r}}^{′} )$$

$$z < {z}^{′}$$

where

$${k}_{z} = \sqrt{{k}^{2} - {k}_{x}^{2} - {k}_{y}^{2}} .$$

The propagation waves are for

$$\sqrt{{k}_{x}^{2} + {k}_{y}^{2}} \leq k .$$

The evanescent waves are for

$$\sqrt{{k}_{x}^{2} + {k}_{y}^{2}} > k .$$

The ê(kₓ,k_{y},k_{z}) and ĥ(kₓ,k_{y},k_{z}) are respectively TE waves and TM waves. For upward going plane waves, k̅=kₓ\hat{x}+k_{y}ÿ+k_{z}\hat{z} and for downward going waves K̅=kₓ\hat{x}+k_{y}ŷ−k_{z}\hat{z}.

Dyadic Green's function in terms of VSW is

$${{G}^{=}}_{0} ( \overline{r} , {\overline{r}}^{′} ) = ik {\sum }_{n , m} {( - 1 )}^{m} {\overline{M}}_{mn} ( k \overline{r} ) Rg {\overline{M}}_{- mn} ( k {\overline{r}}^{′} ) + ik {\sum }_{n , m} {( - 1 )}^{m} {\overline{N}}_{mn} ( k \overline{r} ) Rg {\overline{N}}_{- mn} ( k {\overline{r}}^{′} )$$

$$for$$

$$r > {r}^{′}$$

where Rg stands for regular so that RgM̅ₘₙ(kr̅) and RgN̅ₘₙ(kr̅) and the outgoing waves are M̅ₘₙ(kr̅) and N̅ₘₙ(kr̅). Outgoing waves have spherical Hankel functions

$${h}_{n}^{( 1 )} ( kr )$$

while Rg has spherical Bessel functions jₙ(kr). Next, relate the dyadic Green's functions of VSW to VPW, by letting r̅′ to be on an infinitesimal spherical surface of radius a, a→0. Thus r̅′=a sin θ′cos φ′\hat{x}+a sin θ′ sin φ′ŷ+a cos θ′\hat{z}. Integrate over the spherical spherical surface of dS′=a² sin θ′dθ′dφ′. The orthogonality of vector spherical harmonics of B̅ₘₙ and C̅ₘₙ are made use.

Then

$${\overline{N}}_{mn} ( k \overline{r} ) = - \frac{i}{k} {γ}_{mn} {lim}_{a \to 0} \frac{1}{\frac{{( {kaj}_{n} ( ka ) )}^{′}}{ka}} {\int }_{0}^{π} {d θ}^{′} {sin θ}^{′} {\int }_{0}^{2 π} {d ϕ}^{′} {\overline{\overline{G}}}_{0} ( \overline{r} , {\overline{r}}^{′} ) \cdot {\overline{B}}_{mn} ( {θ}^{′} , {ϕ}^{′} )$$

substitute the VPW of G̅₀(r̅,r̅′) in the above. Make use of

$$Rg {\overline{N}}_{mn} ( ka \hat{k} ) = {γ}_{mn} \{ \frac{n ( n + 1 ) {j}_{n} ( ka )}{ka} {\overline{P}}_{mn} ( {θ}_{k} , {ϕ}_{k} ) + \frac{{( {kaj}_{n} ( ka ) )}^{′}}{ka} {\overline{B}}_{mn} ( {θ}_{k} , {ϕ}_{k} ) \} = \frac{{( - i )}^{n - 1}}{4 π} {γ}_{mn} {\int }_{0}^{π} {d θ}^{′} {sin θ}^{′} {\int }_{0}^{2 π} {d ϕ}^{′}$$

exp(ika(sin θₖ cos φₖ sin θ′ cos φ′+sin θₖ sin φₖ sin θ′ sin φ′+cos θₖ cos θ′))B̅ₘₙ(θ′, φ′) where \hat{k}=sin θₖ cos φₖ\hat{x}+sin θₖ sin φₖŷ+cos θₖ\hat{z}. Then obtain

$$z < 0$$

$${\overline{N}}_{mn} ( k \overline{r} ) = \frac{{( i )}^{n - 1}}{2 π k} {{γ}_{mn} ( - 1 )}^{m} {\int }_{- ∞}^{∞} {dk}_{x} {\int }_{- ∞}^{∞} {dk}_{y} exp ( i \overline{k} \cdot \overline{r} ) \frac{1}{{k}_{z}} [ ( \frac{im}{sin ( {θ}_{k} )} {P}_{n}^{m} ( cos ( {θ}_{k} ) ) ) \hat{e} ( {k}_{x} , {k}_{y} , - {k}_{z} ) - \frac{d {P}_{n}^{m} ( {cos θ}_{k} )}{d ( {θ}_{k} )} \hat{h} ( {k}_{x} , {k}_{y} , - {k}_{z} ) ] exp ( {im ϕ}_{k} )$$

To complete the transformations to VPW, substitute for the analytical expressions of

$${P}_{n}^{m} ( cos ( {θ}_{k} ) ) ,$$

$$\frac{d {P}_{n}^{m} ( {cos θ}_{k} )}{d ( {θ}_{k} )}$$

by

$${cos θ}_{k} = \frac{{k}_{z}}{k} ,$$

$${sin θ}_{k} = \frac{{k}_{ρ}}{k} .$$

### Using M̅ₘₙ(kr̅)=(∇×N̅mn(kr̅))/k:

$$z < 0$$

$${\overline{M}}_{mn} ( k \overline{r} ) = \frac{{( i )}^{n}}{2 π k} {{γ}_{mn} ( - 1 )}^{m + 1} {\int }_{- ∞}^{∞} {dk}_{x} {\int }_{- ∞}^{∞} {dk}_{y} exp ( i \overline{k} \cdot \overline{r} ) \frac{1}{{k}_{z}} [ ( \frac{im}{sin ( {θ}_{k} )} {P}_{n}^{m} ( cos ( {θ}_{k} ) ) ) \hat{h} ( {k}_{x} , {k}_{y} , - {k}_{z} ) + \frac{d {P}_{n}^{m} ( cos ( {θ}_{k} ) )}{d ( {θ}_{k} )} \hat{e} ( {k}_{x} , {k}_{y} , - {k}_{z} ) ] exp ( {im ϕ}_{k} )$$

Expressions are for z<0 which are useful because the scattered wave from the scatterer propagates downward to the reflective surface. The cos θₖ and sin θₖ above are complex for evanescent waves with

$$cos {θ}_{k} = \frac{{k}_{z}}{k} .$$

To illustrate, first consider the case of two discrete scatterers and one surface scatterer. Below the approach will be extended to a large number of discrete scatterers.

In this scattering problem, an incident plane wave, a planar surface at z=−d, and the two discrete scatterers are centered at r̅₁ and r̅₂ as shown in FIG. 14, where r̅ⱼ=xⱼ\hat{x}+yⱼŷ+zⱼ\hat{z}, j=1,2. The T matrices of the two scatterers, T⁽¹⁾ and T⁽²⁾ are in VSW.

In MST, the unknowns to be solved are the “final” scattered fields from the planar surface and the “final” scattered fields from the two scatterers. The final scattered fields are from the final exciting fields and the final scattered fields are the scattered fields to other scatterers or to infinity. The final scattered field from the surface, Ē^{R}, is expressed in VPW:

$${\overline{E}}^{R} = {\int }_{- ∞}^{∞} {dk}_{x} {\int }_{- ∞}^{∞} {dk}_{y} exp ( {ik}_{x} x + {ik}_{y} y + {ik}_{z} z ) ( {a}^{R ( e )} ( {k}_{x} , {k}_{y} , {k}_{z} ) \hat{e} ( {k}_{x} , {k}_{y} , {k}_{z} ) + {a}^{R ( h )} ( {k}_{x} , {k}_{y} , {k}_{z} ) \hat{h} ( {k}_{x} , {k}_{y} , {k}_{z} ) )$$

The final scattered field of the two scatterers are Ē^{S(1)} and Ē^{S(2)} respectively. A combined index is used, (m, n)→l

$${\overline{E}}^{S ( j )} = {\sum }_{ℓ} ( {a}_{ℓ}^{s ( j ) ( M )} {\overline{M}}_{mn} ( k ( \overline{r} - {\overline{r}}_{j} ) ) + {a}_{ℓ}^{s ( j ) ( N )} {\overline{N}}_{ℓ} ( k ( \overline{r} - {\overline{r}}_{j} ) ) ) , j = 1 , 2$$

where M̅ₘₙ(k(r̅−r̅ⱼ)) and N̅ₘₙ(k((r̅−r̅ⱼ), j=1,2 are outgoing vector spherical waves from scatterer centered at fj.

These two scattered waves are impinging upon the smooth surface. To obtain the scattered field from the surface, the results above are used to express M̅ₘₙ(k(r̅−r̅ⱼ)), N̅ₘₙ(k(r̅−r̅ⱼ)), in terms of downward going plane waves (VPW).

$${\sum }_{j} {\overline{E}}^{S ( j )} = {\sum }_{j = 1 , 2} {\sum }_{ℓ} {a}_{ℓ}^{s ( j ) ( M )} \frac{{( i )}^{n}}{2 π k} {γ}_{mn} {( - 1 )}^{m + 1} {\int }_{- ∞}^{∞} {dk}_{x} {\int }_{- ∞}^{∞} {dk}_{y} exp ( i \overline{K} \cdot ( \overline{r} - {\overline{r}}_{j} ) )$$

$$\frac{1}{{k}_{z}} [ ( \frac{im}{sin ( {θ}_{k} )} {P}_{n}^{m} ( cos ( {θ}_{k} ) ) ) \hat{h} ( {k}_{x} , {k}_{y} , - {k}_{z} ) + \frac{{dP}_{n}^{m} ( cos ( {θ}_{k} ) )}{d ( {θ}_{k} )} \hat{e} ( {k}_{x} , {k}_{y} , - {k}_{z} ) ] exp ( {im ϕ}_{k} ) + {\sum }_{j = 1 , 2} {\sum }_{ℓ} {a}_{ℓ}^{s ( j ) ( N )} \frac{{( i )}^{n - 1}}{2 π k} {γ}_{mn} {( - 1 )}^{m} {\int }_{- ∞}^{∞} {dk}_{x} {\int }_{- ∞}^{∞} {dk}_{y} exp ( i \overline{K} \cdot ( \overline{r} - {\overline{r}}_{j} ) )$$

$$\frac{1}{{k}_{z}} [ ( \frac{im}{sin ( {θ}_{k} )} {P}_{n}^{m} ( cos ( {θ}_{k} ) ) ) \hat{e} ( {k}_{x} , {k}_{y} , - {k}_{z} ) - \frac{{dP}_{n}^{m} ( cos ( {θ}_{k} ) )}{d ( {θ}_{k} )} \hat{h} ( {k}_{x} , {k}_{y} , - {k}_{z} ) ] exp ( {im ϕ}_{k} )$$

At the planar surface z=−d, the phase of exp (iK̅·(r̅−r̅ⱼ)) is ikₓ(x−xⱼ)+ik_{y}(y−yⱼ)+ik_{z}(d+zⱼ). It will be reflected to become upward going waves with reflection coefficients of TE and TM. The reflected waves have phase exp(ikₓ(x−xⱼ)+ik_{y}(y−yⱼ)+ik_{z}(d+zⱼ)) exp(ik_{z}(z+d)).

Then the reflected waves which are the reflection of scattered waves of scatterers 1 and 2

$${\overline{E}}^{R} = {\sum }_{j = 1 , 2} {\sum }_{ℓ} {a}_{ℓ}^{s ( j ) ( M )} \frac{{( i )}^{n}}{2 π k} {γ}_{mn} {( - 1 )}^{m + 1} {\int }_{- ∞}^{∞} {dk}_{x} {\int }_{- ∞}^{∞} {dk}_{y} exp ( {ik}_{x} ( x - {x}_{j} ) + {ik}_{y} ( y - {y}_{j} ) + {ik}_{z} ( d + {z}_{j} ) ) exp ( {ik}_{z} ( z + d ) )$$

$$\frac{1}{{k}_{z}} [ ( \frac{im}{sin ( {θ}_{k} )} {P}_{n}^{m} ( cos ( {θ}_{k} ) ) ) {R}^{TM} ( {k}_{x} , {k}_{y} ) \hat{h} ( {k}_{x} , {k}_{y} , {k}_{z} ) + \frac{{dP}_{n}^{m} ( cos ( {θ}_{k} ) )}{d ( {θ}_{k} )} {R}^{TE} ( {k}_{x} , {k}_{y} ) \hat{e} ( {k}_{x} , {k}_{y} , {k}_{z} ) ] exp ( {im ϕ}_{k} ) + {\sum }_{j = 1 , 2} {\sum }_{ℓ} {a}_{ℓ}^{s ( j ) ( N )} \frac{{( i )}^{n - 1}}{2 π k} {γ}_{mn} {( - 1 )}^{m} {\int }_{- ∞}^{∞} {dk}_{x} {\int }_{- ∞}^{∞} {dk}_{y} exp ( {ik}_{x} ( x - {x}_{j} ) + {ik}_{y} ( y - {y}_{j} ) + {ik}_{z} ( d + {z}_{j} ) ) exp ( {ik}_{z} ( z + d ) )$$

$$\frac{1}{{k}_{z}} [ ( \frac{im}{sin ( {θ}_{k} )} {P}_{n}^{m} ( cos ( {θ}_{k} ) ) ) {R}^{TE} ( {k}_{x} , {k}_{y} ) \hat{e} ( {k}_{x} , {k}_{y} , {k}_{z} ) - \frac{{dP}_{n}^{m} ( cos ( {θ}_{k} ) )}{d ( {θ}_{k} )} {R}^{TE} ( {k}_{x} , {k}_{y} ) \hat{h} ( {k}_{x} , {k}_{y} , {k}_{z} ) ] exp ( {im ϕ}_{k} )$$

In the above, the downward polarization vector ê(kₓ,k_{y},−k_{z}) and ĥ(kₓ,k_{y},−k_{z}), on reflection upward have been changed to upward ê(kₓ,k_{y},k_{z}) and ĥ(kₓ,k_{y},k_{z}) with associated Fresnel reflection coefficients R^{TE}(kₓ,k_{y},k_{z}) and R^{TM}(kₓ,k_{y},k_{z}), respectively.

The integration transformation is

$${\int }_{- ∞}^{∞} {dk}_{x} {\int }_{- ∞}^{∞} {dk}_{y} = {\int }_{0}^{∞} {dk}_{ρ} {k}_{ρ} {\int }_{0}^{2 π} {d ϕ}_{k} .$$

Setting k_{ρ}=k sin θₖ, then dk_{ρ}k_{ρ}=dθₖk_{z}k_{ρ}. Then k_{z} factor will cancel the k_{z} in the denominator to eliminate divide check. To include evanescent path, integrate ∫ dθₖ over the Sommerfeld integration path. For propagating waves,

$${\int }_{0}^{k} \frac{{dk}_{ρ}}{{k}_{z}} = {\int }_{0}^{\frac{π}{2}} {d θ}_{k} .$$

For evanescent waves,

$${θ}_{k} = \frac{π}{2} - {i α}_{k} , {\int }_{k}^{∞} \frac{{dk}_{ρ}}{{k}_{z}} = - i {\int }_{{α}_{k} = 0}^{{α}_{k} = ∞} {d α}_{k} .$$

If one lets the maximum of k_{ρ} be k_{ρ max}, then, cos h

$${α}_{k , max} = \frac{{k}_{ρ max}}{k}$$

The above Ē^{R} is the diffuse part of the reflected wave from the surface. a^{R(e)}(k̅) and a^{R(h)}(k̅) are the sum of diffuse and specular reflection. Let a^{RD(e)}(k̅) and a^{R(h)}(k̅) denote diffuse. From the above, they are

$${a}^{RD ( e )} ( \overline{k} ) = {\sum }_{j = 1 , 2} {\sum }_{ℓ} exp ( - i \overline{K} \cdot {\overline{r}}_{j} ) exp ( {ik}_{z} 2 d ) {R}^{TE} ( {k}_{x} , {k}_{y} ) ( {F}_{ℓ}^{( e ) ( M )} ( \overline{k} ) {a}_{ℓ}^{s ( j ) ( M )} + {F}_{ℓ}^{( e ) ( N )} ( \overline{k} ) {a}_{ℓ}^{s ( j ) ( N )} )$$

$${a}^{RD ( h )} ( \overline{k} ) = {\sum }_{j = 1 , 2} {\sum }_{ℓ} exp ( - i \overline{K} \cdot {\overline{r}}_{j} ) exp ( {ik}_{z} 2 d ) {R}^{TM} ( {k}_{x} , {k}_{y} ) ( {F}_{ℓ}^{( h ) ( M )} ( \overline{k} ) {a}_{ℓ}^{s ( j ) ( M )} + {F}_{ℓ}^{( h ) ( N )} ( \overline{k} ) {a}_{ℓ}^{s ( j ) ( N )} )$$

where

$${F}_{ℓ}^{( e ) ( M )} ( \overline{k} ) = \frac{{( i )}^{n}}{2 π k} {γ}_{mn} {( - 1 )}^{m} {k}_{ρ} exp ( {im ϕ}_{k} ) ( - \frac{{dP}_{n}^{m} ( cos ( {θ}_{k} ) )}{d ( {θ}_{k} )} )$$

$${F}_{ℓ}^{( e ) ( N )} ( \overline{k} ) = \frac{{( i )}^{n}}{2 π k} {γ}_{mn} {( - 1 )}^{m} {k}_{ρ} exp ( {im ϕ}_{k} ) ( \frac{m}{sin ( {θ}_{k} )} {P}_{n}^{m} ( cos ( {θ}_{k} ) ) ) .$$

$${F}_{ℓ}^{( h ) ( M )} ( \overline{k} ) = - {iF}_{ℓ}^{( e ) ( N )} ( \overline{k} )$$

$${F}_{ℓ}^{( h ) ( N )} ( \overline{k} ) = - {iF}_{ℓ}^{( e ) ( M )} ( \overline{k} )$$

Next consider specular reflection of incident plane waves. The incident plane wave Ē_{inc} is downward

$${\overline{E}}_{inc} = ( {E}_{i}^{TM} \hat{h} ( {k}_{ix} , {k}_{iy} , - {k}_{iz} ) + {E}_{i}^{TE} \hat{e} ( {k}_{ix} , {k}_{iy} , - {k}_{iz} ) ) exp ( i {\overline{K}}_{i} \cdot \overline{r} )$$

where kᵢₓ=k sin θᵢ cos φᵢ, k_{iy}=k sin θᵢ sin φᵢ and k_{iz}=k cos θᵢ. The incident plane wave is reflected at z=−d. The reflection Ē_{ref} is specular

$${\overline{E}}_{ref} = ( {E}_{i}^{TM} {R}^{TM} ( {k}_{ix} , {k}_{iy} , {k}_{iz} ) \hat{h} ( {k}_{ix} , {k}_{iy} , {k}_{iz} ) + {E}_{i}^{TE} {R}^{TE} ( {k}_{ix} , {k}_{iy} , {k}_{iz} ) \hat{e} ( {k}_{ix} , {k}_{iy} , {k}_{iz} ) ) exp ( {ik}_{ix} x + {ik}_{iy} y + {ik}_{iz} ( z + 2 d ) )$$

Adding that to the diffuse reflections, then

$${a}^{R ( e )} ( \overline{k} ) = {a}^{RD ( e )} ( \overline{k} ) + {E}_{i}^{TE} {R}^{TE} ( {k}_{ix} , {k}_{iy} , {k}_{iz} ) exp ( {ik}_{iz} 2 d ) δ ( {θ}_{k} - {θ}_{i} ) δ ( {ϕ}_{k} - {ϕ}_{i} )$$

$${a}^{R ( h )} ( \overline{k} ) = {a}^{RD ( h )} ( \overline{k} ) + {E}_{i}^{TE} {R}^{TM} ( {k}_{ix} , {k}_{iy} , {k}_{iz} ) exp ( {ik}_{iz} 2 d ) δ ( {θ}_{k} - {θ}_{i} ) δ ( {ϕ}_{k} - {ϕ}_{i} )$$

Consider the total exciting field of scatterer 1: There are 3 contributions: from the surface reflection of the dielectric substrate, from scatterer 2, and from the incident wave. The reflected wave from the surface reflection needs to be transformed to VSW on scatterer 1. This then becomes an exciting field for scatterer 1.

One needs to transform to vector spherical waves. For the combined index, use the notations, (m, n)→ [symbol] , [symbol] =1, 2, 3, . . . . For example (−1,1)→1; (0,1)→2, (1,1)→3, etc. Also use the convenient notation for negative values of [symbol] : (−m,n)→− [symbol] .

### Since

$$\hat{e} ( \overline{k} ) exp ( i \overline{k} \cdot ( \overline{r} - {\overline{r}}_{j} ) ) = {\sum }_{ℓ} {( - 1 )}^{m} \frac{2 n + 1}{n ( n + 1 )} {i}^{n} \hat{e} ( \overline{k} ) \cdot [ \frac{{\overline{C}}_{- ℓ} ( {θ}_{k} , {ϕ}_{k} )}{{γ}_{ℓ}} Rg {\overline{M}}_{ℓ} ( k ( \overline{r} - {\overline{r}}_{j} ) ) - \frac{i {\overline{B}}_{- ℓ} ( {θ}_{k} , {ϕ}_{k} )}{{γ}_{ℓ}} Rg {\overline{N}}_{ℓ} ( k \overline{r} - {\overline{r}}_{j} ) ]$$

$$\hat{h} ( \overline{k} ) exp ( i \overline{k} \cdot ( ( \overline{r} - {\overline{r}}_{j} ) ) ) = {\sum }_{ℓ} {( - 1 )}^{m} \frac{2 n + 1}{n ( n + 1 )} {i}^{n} \hat{h} ( \overline{k} ) \cdot [ \frac{{\overline{C}}_{- ℓ} ( {θ}_{k} , {ϕ}_{k} )}{{γ}_{ℓ}} Rg {\overline{M}}_{ℓ} ( k ( \overline{r} - {\overline{r}}_{j} ) ) - \frac{i {\overline{B}}_{- ℓ} ( {θ}_{k} , {ϕ}_{k} )}{{γ}_{ℓ}} Rg {\overline{N}}_{ℓ} ( k ( \overline{r} - {\overline{r}}_{j} ) ) ]$$

### Then

$${\overline{E}}^{R} = \int {d θ}_{k} \int {d ϕ}_{k} exp ( i \overline{k} \cdot {\overline{r}}_{j} ) ( {a}^{R ( e )} ( \overline{k} ) \hat{e} ( \overline{k} ) + {a}^{R ( h )} ( \overline{k} ) \hat{h} ( \overline{k} ) )$$

$${\sum }_{{ℓ}^{′}} {( - 1 )}^{{m}^{′}} \frac{2 {n}^{′} + 1}{{n}^{′} ( {n}^{′} + 1 )} {i}^{{n}^{′}} \cdot [ \frac{{\overline{C}}_{- ℓ}^{′} ( {θ}_{k} , {ϕ}_{k} )}{{γ}_{ℓ}^{′}} Rg {\overline{M}}_{ℓ}^{′} ( k ( \overline{r} - {\overline{r}}_{j} ) ) + \frac{i {\overline{B}}_{- ℓ}^{′} ( {θ}_{k} , {ϕ}_{k} )}{{γ}_{ℓ}^{′}} Rg {\overline{N}}_{ℓ}^{′} ( k ( \overline{r} - {\overline{r}}_{j} ) ) ]$$

Let the exciting field from surface to scatter j is

$${\overline{E}}^{ex ( j )} = {\sum }_{{ℓ}^{′}} ( {a}_{{ℓ}^{′}}^{E ( j ) ( M )} Rg {\overline{M}}_{{ℓ}^{′}} ( k ( \overline{r} - {\overline{r}}_{j} ) ) + {a}_{{ℓ}^{′}}^{E ( j ) ( N )} Rg {\overline{N}}_{{ℓ}^{′}} ( k ( \overline{r} - {\overline{r}}_{j} ) ) )$$

Denote the contribution from surface to be

$${a}_{{ℓ}^{′}}^{E ( j ) ( M ) R} and {a}_{{ℓ}^{′}}^{E ( j ) ( N ) R} .$$

Using ê(k̅)=−\hat{φ}(k̅),ĥ(k̅)=−\hat{θ}(k̅), then exciting field from surface to particle j

$${a}_{{ℓ}^{′}}^{E ( j ) ( M ) R} = \int d {θ}_{k} \int d {ϕ}_{k} exp ( i \overline{k} \cdot {\overline{r}}_{j} ) ( {a}^{R ( e )} ( \overline{k} ) {D}_{{ℓ}^{′}}^{( M ) ( e )} ( \overline{k} ) + {a}^{R ( h )} ( \overline{k} ) {D}_{{ℓ}^{′}}^{( M ) ( h )} ( \overline{k} ) )$$

$${a}_{{ℓ}^{′}}^{E ( j ) ( N ) R} = \int d {θ}_{k} \int d {ϕ}_{k} exp ( i \overline{k} \cdot {\overline{r}}_{j} ) ( {a}^{R ( e )} ( \overline{k} ) {D}_{{ℓ}^{′}}^{( N ) ( e )} ( \overline{k} ) + {a}^{R ( h )} ( \overline{k} ) {D}_{{ℓ}^{′}}^{( N ) ( h )} ( \overline{k} ) )$$

where the coupling coefficients of VPW to VSW are

$${D}_{{ℓ}^{′}}^{( M ) ( e )} ( \overline{k} ) = {( - 1 )}^{{m}^{′}} \frac{2 {n}^{′} + 1}{{n}^{′} ( {n}^{′} + 1 ) {γ}_{{ℓ}^{′}}} {i}^{{i}^{′}} \frac{{dP}_{{n}^{′}}^{- {m}^{′}} ( cos {θ}_{k} )}{d {θ}_{k}} exp ( - {im}^{′} {ϕ}_{k} )$$

$${D}_{{ℓ}^{′}}^{( N ) ( e )} ( \overline{k} ) = {( - 1 )}^{{m}^{′}} \frac{2 {n}^{′} + 1}{{n}^{′} ( {n}^{′} + 1 ) {γ}_{{ℓ}^{′}}} {i}^{{n}^{′}} \frac{{m}^{′}}{sin {θ}_{k}} {P}_{{n}^{′}}^{- {m}^{′}} ( cos {θ}_{k} ) exp ( - {im}^{′} {ϕ}_{k} )$$

$${D}_{{ℓ}^{′}}^{( N ) ( h )} ( \overline{k} ) = {iD}_{{ℓ}^{′}}^{( M ) ( e )} ( \overline{k} )$$

$${D}_{{ℓ}^{′}}^{( M ) ( h )} ( \overline{k} ) = {iD}_{{ℓ}^{′}}^{( N ) ( e )} ( \overline{k} )$$

The total exciting field of particle j comes from surface reflection, from other particles, and from incident waves. The exciting field from surface reflections was derived in the previous section.

Denote scattered fields from other particles that contribute to the exciting fields by

$${a}_{{ℓ}^{′}}^{E ( 1 ) ( M ) S} and {a}_{{ℓ}^{′}}^{E ( 1 ) ( N ) S} .$$

Using the translational addition theorem, then

$${a}_{{ℓ}^{′}}^{E ( 1 ) ( M ) S} = {\sum }_{ℓ} {a}_{ℓ}^{s ( 2 ) ( M )} {A}_{{ℓ}^{′} ℓ} ( k ( {\overline{r}}_{1} - {\overline{r}}_{2} ) ) + {\sum }_{ℓ} {a}_{ℓ}^{s ( 2 ) ( N )} {B}_{{ℓ}^{′} ℓ} ( k ( {\overline{r}}_{1} - {\overline{r}}_{2} ) )$$

$${a}_{{ℓ}^{′}}^{E ( 1 ) ( N ) S} = {\sum }_{ℓ} {a}_{ℓ}^{s ( 2 ) ( M )} {B}_{{ℓ}^{′} ℓ} ( k ( {\overline{r}}_{1} - {\overline{r}}_{2} ) ) + {\sum }_{ℓ} {a}_{ℓ}^{s ( 2 ) ( N )} {A}_{{ℓ}^{′} ℓ} ( k ( {\overline{r}}_{1} - {\overline{r}}_{2} ) )$$

where [symbol] (k(r̅₁−r̅₂)) and [symbol] (k(r̅₁−r̅₂)). For the exciting field from incident waves which are downward going,

$${\overline{E}}_{inc} = ( {E}_{i}^{TE} exp ( i {\overline{K}}_{i} \cdot {\overline{r}}_{1} ) \hat{e} ( {k}_{ix} , {k}_{iy} , - {k}_{iz} ) ) \cdot {\sum }_{{ℓ}^{′}} {( - 1 )}^{{m}^{′}} \frac{2 {n}^{′} + 1}{{n}^{′} ( {n}^{′} + 1 )} {i}^{{n}^{′}} [ \frac{{\overline{C}}_{- {ℓ}^{′}} ( π - {θ}_{k} , {ϕ}_{k} )}{{γ}_{{ℓ}^{′}}} Rg {\overline{M}}_{{ℓ}^{′}} ( k ( \overline{r} - {\overline{r}}_{1} ) ) - \frac{i {\overline{B}}_{- {ℓ}^{′}} ( π - {θ}_{k} , {ϕ}_{k} )}{{γ}_{{ℓ}^{′}}} Rg {\overline{N}}_{{ℓ}^{′}} ( k ( \overline{r} - {\overline{r}}_{1} ) ) ] + ( {E}_{i}^{TM} exp ( i {\overline{K}}_{i} \cdot {\overline{r}}_{1} ) \hat{h} ( {k}_{ix} , {k}_{iy} , - {k}_{iz} ) ) \cdot {\sum }_{{ℓ}^{′}} {( - 1 )}^{{m}^{′}} \frac{2 {n}^{′} + 1}{{n}^{′} ( {n}^{′} + 1 )} {i}^{{n}^{′}} [ \frac{{\overline{C}}_{- {ℓ}^{′}} ( π - {θ}_{k} , {ϕ}_{k} )}{{γ}_{{ℓ}^{′}}} Rg {\overline{M}}_{{ℓ}^{′}} ( k ( \overline{r} - {\overline{r}}_{1} ) ) - \frac{i {\overline{B}}_{- {ℓ}^{′}} ( π - {θ}_{k} , {ϕ}_{k} )}{{γ}_{{ℓ}^{′}}} Rg {\overline{N}}_{{ℓ}^{′}} ( k ( \overline{r} - {\overline{r}}_{1} ) ) ]$$

Extend the definitions of

$${D}_{{ℓ}^{′}}^{( M ) ( e )} ( \overline{K} )$$

for a single downward direction K̅ᵢ

$${D}_{{ℓ}^{′}}^{( M ) ( e )} ( \overline{K} ) = {( - 1 )}^{{m}^{′}} \frac{2 {n}^{′} + 1}{{n}^{′} ( {n}^{′} + 1 )} {i}^{{n}^{′}} \frac{1}{{γ}_{{ℓ}^{′}}} \hat{e} ( \overline{K} ) \cdot {\overline{C}}_{- {ℓ}^{′}} ( \hat{K} )$$

$${D}_{{ℓ}^{′}}^{( M ) ( h )} ( \overline{K} ) = {( - 1 )}^{{m}^{′}} \frac{2 {n}^{′} + 1}{{n}^{′} ( {n}^{′} + 1 )} {i}^{{n}^{′}} \frac{1}{{γ}_{{ℓ}^{′}}} \hat{h} ( \overline{K} ) \cdot {\overline{C}}_{- {ℓ}^{′}} ( \hat{K} ) ;$$

$${D}_{{ℓ}^{′}}^{( N ) ( e )} ( \overline{K} ) = {( - 1 )}^{{m}^{′}} \frac{2 {n}^{′} + 1}{{n}^{′} ( {n}^{′} + 1 )} {i}^{{n}^{′}} ( \hat{e} ( \overline{K} ) ) \cdot ( \frac{- i {\overline{B}}_{- {ℓ}^{′}} ( \hat{K} )}{{γ}_{{ℓ}^{′}}} )$$

$${D}_{{ℓ}^{′}}^{( N ) ( h )} ( \overline{K} ) = {( - 1 )}^{{m}^{′}} \frac{2 {n}^{′} + 1}{{n}^{′} ( {n}^{′} + 1 )} {i}^{{n}^{′}} ( \hat{h} ( \overline{K} ) ) \cdot ( \frac{- i {\overline{B}}_{- {ℓ}^{′}} ( \hat{K} )}{{γ}_{{ℓ}^{′}}} )$$

Then the contributions from incident plane wave are

$${a}_{{ℓ}^{′}}^{E ( 1 ) ( M ) , inc} = {E}_{i}^{TE} exp ( i {\overline{K}}_{i} \cdot {\overline{r}}_{1} ) {D}_{{ℓ}^{′}}^{( M ) ( e )} ( {\overline{K}}_{i} ) + {E}_{i}^{TM} exp ( i {\overline{K}}_{i} \cdot {\overline{r}}_{1} ) {D}_{{ℓ}^{′}}^{( M ) ( h )} ( {\overline{K}}_{i} )$$

$${a}_{{ℓ}^{′}}^{E ( 1 ) ( N ) , inc} = {E}_{i}^{TE} exp ( i {\overline{K}}_{i} \cdot {\overline{r}}_{1} ) {D}_{{ℓ}^{′}}^{( N ) ( e )} ( {\overline{K}}_{i} ) + {E}_{i}^{TM} exp ( i {\overline{K}}_{i} \cdot {\overline{r}}_{1} ) {D}_{{ℓ}^{′}}^{( N ) ( h )} ( {\overline{K}}_{i} )$$

Then adding the three contributions to get total exciting field of scatterer 1, and substituting the T matrices of VSW, one has, on further decomposing into specular and diffuse for the surface reflections a^{R(e)}(k̅) and a^{R(h)}(k̅)

$${a}_{ℓ}^{s ( 1 ) ( M )} = {\sum }_{{ℓ}^{′}} {\sum }_{{ℓ}^{″}} {T}_{{ℓℓ}^{′}}^{( 1 ) ( MM )} ( {A}_{{ℓ}^{′} {ℓ}^{″}} ( k ( {\overline{r}}_{1} - {\overline{r}}_{2} ) ) {a}_{{ℓ}^{″}}^{s ( 2 ) ( M )} + {B}_{{ℓ}^{′} {ℓ}^{″}} ( k ( {\overline{r}}_{1} - {\overline{r}}_{2} ) ) {a}_{{ℓ}^{′}}^{s ( 2 ) ( N )} ) + {\sum }_{{ℓ}^{′}} {\sum }_{{ℓ}^{′}} {T}_{{ℓℓ}^{′}}^{( 1 ) ( MN )} ( {a}_{{ℓ}^{″}}^{s ( 2 ) ( M )} {B}_{{ℓ}^{′} {ℓ}^{″}} ( k ( {\overline{r}}_{1} - {\overline{r}}_{2} ) ) + {a}_{{ℓ}^{′}}^{s ( 2 ) ( N )} {A}_{{ℓ}^{′} ℓ} {ℓ}^{″} ( k ( {\overline{r}}_{1} - {\overline{r}}_{2} ) ) ) + {\sum }_{{ℓ}^{′}} {T}_{{ℓℓ}^{′}}^{( 1 ) ( MM )} \int d {θ}_{k} \int d {ϕ}_{k} exp ( i \overline{k} \cdot {\overline{r}}_{1} ) {a}^{RD ( e )} ( \overline{k} ) {D}_{{ℓ}^{′}}^{( M ) ( e )} ( \overline{k} ) + {\sum }_{{ℓ}^{′}} {T}_{{ℓℓ}^{′}}^{( 1 ) ( MM )} \int d {θ}_{k} \int d {ϕ}_{k} exp ( i \overline{k} \cdot {\overline{r}}_{1} ) {a}^{RD ( h )} ( \overline{k} ) {D}_{{ℓ}^{′}}^{( M ) ( h )} ( \overline{k} ) + {\sum }_{{ℓ}^{′}} {T}_{{ℓℓ}^{′}}^{( 1 ) ( MN )} \int d {θ}_{k} \int d {ϕ}_{k} exp ( i \overline{k} \cdot {\overline{r}}_{1} ) {a}^{RD ( e )} ( \overline{k} ) {D}_{{ℓ}^{′}}^{( N ) ( e )} ( \overline{k} ) + {\sum }_{{ℓ}^{′}} {T}_{{ℓℓ}^{′}}^{( 1 ) ( MN )} \int d {θ}_{k} \int d {ϕ}_{k} exp ( i \overline{k} \cdot {\overline{r}}_{1} ) {a}^{RD ( h )} ( \overline{k} ) {D}_{{ℓ}^{′}}^{( N ) ( h )} ( \overline{k} ) + {\sum }_{{ℓ}^{′}} {T}_{{ℓℓ}^{′}}^{( 1 ) ( MM )} exp ( i {\overline{k}}_{i} \cdot {\overline{r}}_{1} ) {E}_{i}^{TE} {R}^{TE} ( {k}_{ix} , {k}_{iy} , {k}_{iz} ) exp ( {ik}_{iz} 2 d ) {D}_{{ℓ}^{′}}^{( M ) ( e )} ( {\overline{k}}_{i} ) + {\sum }_{{ℓ}^{′}} {T}_{{ℓℓ}^{′}}^{( 1 ) ( MM )} exp ( i {\overline{k}}_{i} \cdot {\overline{r}}_{1} ) {E}_{i}^{TM} {R}^{TM} ( {k}_{ix} , {k}_{iy} , {k}_{iz} ) exp ( {ik}_{iz} 2 d ) {D}_{{ℓ}^{′}}^{( M ) ( h )} ( {\overline{k}}_{i} ) + {\sum }_{{ℓ}^{′}} {T}_{{ℓℓ}^{′}}^{( 1 ) ( MN )} exp ( i {\overline{k}}_{i} \cdot {\overline{r}}_{1} ) {E}_{i}^{TE} {R}^{TE} ( {k}_{ix} , {k}_{iy} , {k}_{iz} ) exp ( {ik}_{iz} 2 d ) {D}_{{ℓ}^{′}}^{( N ) ( e )} ( {\overline{k}}_{i} ) + {\sum }_{{ℓ}^{′}} {T}_{{ℓℓ}^{′}}^{( 1 ) ( MN )} exp ( i {\overline{k}}_{i} \cdot {\overline{r}}_{1} ) {E}_{i}^{TM} {R}^{TM} ( {k}_{ix} , {k}_{iy} , {k}_{iz} ) exp ( {ik}_{iz} 2 d ) {D}_{{ℓ}^{′}}^{( N ) ( h )} ( {\overline{k}}_{i} ) + {\sum }_{{ℓ}^{′}} {T}_{{ℓℓ}^{′}}^{( 1 ) ( MM )} ( {E}_{i}^{TE} exp ( i {\overline{K}}_{i} \cdot {\overline{r}}_{1} ) {D}_{{ℓ}^{′}}^{( M ) ( e )} ( {\overline{K}}_{i} ) + {E}_{i}^{TM} exp ( i {\overline{K}}_{i} \cdot {\overline{r}}_{1} ) {D}_{{ℓ}^{′}}^{( M ) ( h )} ( {\overline{K}}_{i} ) ) + {\sum }_{{ℓ}^{′}} {T}_{{ℓℓ}^{′}}^{( 1 ) ( MN )} ( {E}_{i}^{TE} exp ( i {\overline{K}}_{i} \cdot {\overline{r}}_{1} ) {D}_{{ℓ}^{′}}^{( N ) ( e )} ( {\overline{K}}_{i} ) + {E}_{i}^{TM} exp ( i {\overline{K}}_{i} \cdot {\overline{r}}_{1} ) {D}_{{ℓ}^{′}}^{( N ) ( h )} ( {\overline{K}}_{i} ) )$$

$${a}_{ℓ}^{s ( 1 ) ( N )} = {\sum }_{{ℓ}^{′}} {T}_{{ℓℓ}^{′}}^{( 1 ) ( NM )} {\sum }_{{ℓ}^{′}} ( {A}_{{ℓ}^{′} {ℓ}^{′}} ( k ( {\overline{r}}_{1} - {\overline{r}}_{2} ) ) {a}_{{ℓ}^{′}}^{s ( 2 ) ( M )} + {B}_{{ℓ}^{′} {ℓ}^{′}} ( k ( {\overline{r}}_{1} - {\overline{r}}_{2} ) ) {a}_{{ℓ}^{′}}^{s ( 2 ) ( N )} ) + {\sum }_{{ℓ}^{′}} {T}_{{ℓℓ}^{′}}^{( 1 ) ( NN )} {\sum }_{{ℓ}^{″}} ( {a}_{{ℓ}^{′}}^{s ( 2 ) ( M )} {B}_{{ℓ}^{′} {ℓ}^{′}} ( k ( {\overline{r}}_{1} - {\overline{r}}_{2} ) ) + {a}_{{ℓ}^{″}}^{s ( 2 ) ( N )} {A}_{{ℓ}^{′} {ℓ}^{″}} ( k ( {\overline{r}}_{1} - {\overline{r}}_{2} ) ) ) + {\sum }_{{ℓ}^{′}} {T}_{{ℓℓ}^{′}}^{( 1 ) ( NM )} \int d {θ}_{k} \int d {ϕ}_{k} exp ( i \overline{k} \cdot {\overline{r}}_{1} ) {a}^{RD ( e )} ( \overline{k} ) {D}_{{ℓ}^{′}}^{( M ) ( e )} ( \overline{k} ) + {\sum }_{{ℓ}^{′}} {T}_{{ℓℓ}^{′}}^{( 1 ) ( NM )} \int d {θ}_{k} \int d {ϕ}_{k} exp ( i \overline{k} \cdot {\overline{r}}_{1} ) {a}^{RD ( h )} ( \overline{k} ) {D}_{{ℓ}^{′}}^{( M ) ( h )} ( \overline{k} ) + {\sum }_{{ℓ}^{′}} {T}_{{ℓℓ}^{′}}^{( 1 ) ( NN )} \int d {θ}_{k} \int d {ϕ}_{k} exp ( i \overline{k} \cdot {\overline{r}}_{1} ) {a}^{RD ( e )} ( \overline{k} ) {D}_{{ℓ}^{′}}^{( N ) ( e )} ( \overline{k} ) + {\sum }_{{ℓ}^{′}} {T}_{{ℓℓ}^{′}}^{( 1 ) ( NN )} \int d {θ}_{k} \int d {ϕ}_{k} exp ( i \overline{k} \cdot {\overline{r}}_{1} ) {a}^{RD ( h )} ( \overline{k} ) {D}_{{ℓ}^{′}}^{( N ) ( h )} ( \overline{k} ) + {\sum }_{{ℓ}^{′}} {T}_{{ℓℓ}^{′}}^{( 1 ) ( NM )} exp ( i {\overline{k}}_{i} \cdot {\overline{r}}_{1} ) {E}_{i}^{TE} {R}^{TE} ( {k}_{ix} , {k}_{iy} , {k}_{iz} ) exp ( {ik}_{iz} 2 d ) {D}_{{ℓ}^{′}}^{( M ) ( e )} ( {\overline{k}}_{i} ) + {\sum }_{{ℓ}^{′}} {T}_{{ℓℓ}^{′}}^{( 1 ) ( NM )} exp ( i {\overline{k}}_{i} \cdot {\overline{r}}_{1} ) {E}_{i}^{TM} {R}^{TM} ( {k}_{ix} , {k}_{iy} , {k}_{iz} ) exp ( {ik}_{iz} 2 d ) {D}_{{ℓ}^{′}}^{( M ) ( h )} ( {\overline{k}}_{i} ) + {\sum }_{{ℓ}^{′}} {T}_{{ℓℓ}^{′}}^{( 1 ) ( NN )} exp ( i {\overline{k}}_{i} \cdot {\overline{r}}_{1} ) {E}_{i}^{TE} {R}^{TE} ( {k}_{ix} , {k}_{iy} , {k}_{iz} ) exp ( {ik}_{iz} 2 d ) {D}_{{ℓ}^{′}}^{( N ) ( e )} ( {\overline{k}}_{i} ) + {\sum }_{{ℓ}^{′}} {T}_{{ℓℓ}^{′}}^{( 1 ) ( NN )} exp ( i {\overline{k}}_{i} \cdot {\overline{r}}_{1} ) {E}_{i}^{TM} {R}^{TM} ( {k}_{ix} , {k}_{iy} , {k}_{iz} ) exp ( {ik}_{iz} 2 d ) {D}_{{ℓ}^{′}}^{( N ) ( h )} ( {\overline{k}}_{i} ) + {\sum }_{{ℓ}^{′}} {T}_{{ℓℓ}^{′}}^{( 1 ) ( NM )} ( {E}_{i}^{TE} exp ( i {\overline{K}}_{i} \cdot {\overline{r}}_{1} ) {D}_{{ℓ}^{′}}^{( M ) ( e )} ( {\overline{K}}_{i} ) + {E}_{i}^{TM} exp ( i {\overline{K}}_{i} \cdot {\overline{r}}_{1} ) {D}_{{ℓ}^{′}}^{( M ) ( h )} ( {\overline{K}}_{i} ) ) + {\sum }_{{ℓ}^{′}} {T}_{{ℓℓ}^{′}}^{( 1 ) ( NN )} ( {E}_{i}^{TE} exp ( i {\overline{K}}_{i} \cdot {\overline{r}}_{1} ) {D}_{{ℓ}^{′}}^{( N ) ( e )} ( {\overline{K}}_{i} ) + {E}_{i}^{TM} exp ( i {\overline{K}}_{i} \cdot {\overline{r}}_{1} ) {D}_{{ℓ}^{′}}^{( N ) ( h )} ( {\overline{K}}_{i} ) )$$

The terms are explained as follows. The first two terms are scattering from the particle 2 followed by scattering of particle 1. The second four terms are reflections from the planar surface of the dielectric substrate followed by scattering from particle 1. The third four terms are reflections of incident plane waves from the planar surface of the dielectric substrate followed by scattering from particle 1. The last two terms are scattering of incident plane waves by particle 1. Note that the direct delta functions have been integrated out in the above expressions. The advantage of the above expression is that there is no specular Dirac delta function.

The expressions above can be condensed by using matrix notations. For VSW, with (n,m)→ [symbol] , the number of terms is Lₘₐₓ=(Nₘₐₓ+2)Nₘₐₓ, where Nₘₐₓ=maximum of n. The dimensions of T̅^{(1)(MM)}, T̅^{(1)(MN)}, T̅^{(1)(NM)}, T̅^{(1)(NN)} are Lₘₐₓ×Lₘₐₓ, dimensions of A̅(k(r̅₁−r̅₂)), B̅(k(r̅₁−r̅₂)) are Lₘₐₓ×Lₘₐₓ, and ā^{S(j)(M)}, ā^{S(j)(N)} are Lₘₐₓ×1.

Further let

$${\overline{\overline{T}}}^{( 1 )} = [ \begin{matrix}{\overline{\overline{T}}}^{( 1 ) ( MM )} & {\overline{\overline{T}}}^{( 1 ) ( MN )} \\ {\overline{\overline{T}}}^{( 1 ) ( NM )} & {\overline{\overline{T}}}^{( 1 ) ( NN )}\end{matrix} ]$$

$${\overline{a}}^{S ( 1 ) S} = [ \begin{matrix}{\overline{a}}^{sM ( 1 ) S} \\ {\overline{a}}^{sN ( 1 ) S}\end{matrix} ]$$

$$\overline{\overline{σ}} ( k ( {\overline{r}}_{1} - {\overline{r}}_{2} ) ) = [ \begin{matrix}\overline{\overline{A}} ( k ( {\overline{r}}_{1} - {\overline{r}}_{2} ) ) & \overline{\overline{B}} ( k ( {\overline{r}}_{1} - {\overline{r}}_{2} ) ) \\ \overline{\overline{B}} ( k ( {\overline{r}}_{1} - {\overline{r}}_{2} ) ) & \overline{\overline{A}} ( k ( {\overline{r}}_{1} - {\overline{r}}_{2} ) )\end{matrix} ]$$

Then the scattered wave from scatterer 2 to particle 1 becomes

$${\overline{a}}^{S ( 1 ) S} = {\overline{\overline{T}}}^{( 1 )} \overline{\overline{σ}} ( k ( {\overline{r}}_{1} - {\overline{r}}_{2} ) ) {\overline{a}}^{S ( 2 )}$$

where

$${\overline{a}}^{S ( 2 )} = {\overline{a}}^{S ( 2 ) S} + {\overline{a}}^{S ( 2 ) R} + {\overline{a}}^{S ( 2 ) , inc}$$

Note that the right hand side ā^{S(2)}, is the total

Next, discretize the VPW. For angular directions {θₖ_{_{θ}}:k_{θ}=1 . . . , N_{θ}_{ₖ}};

$$\{ {ϕ}_{{k}_{ϕ}} : {k}_{ϕ} = 1 , ... , {N}_{{ϕ}_{k}} \} , \int d {θ}_{k} \int d {ϕ}_{k} = {\sum }_{{k}_{θ} = 1}^{{N}_{{θ}_{k}}} {\sum }_{{k}_{ϕ} = 1}^{{N}_{{ϕ}_{k}}} {Δθ}_{k} {Δϕ}_{k} ,$$

where ΔθₖΔφₖ is symbolic and generally means quadrature with weighting coefficients wₖ_{_{θ}} and wₖ_{_{σ}}. Evanescent waves are also included. Let

$${K}_{max} = {N}_{{θ}_{k}} {N}_{{ϕ}_{k}} .$$

N_{θ}_{ₖ} is the number of k_{θ} and N_{φ}_{ₖ} is the number of φₖ denotes the number of directions in (θ₀,φₖ). Then

$${\overline{a}}^{R D ( e )} ( \overline{k} ) , {\overline{a}}^{R D ( h )} ( \overline{k} ) = dimension {K}_{max} \times 1$$

$${\overline{a}}_{k}^{R D ( e )} , k = 1 , 2 … {K}_{max} = {a}^{R D ( e )} ( \overline{k} ) Δ {θ}_{k} Δ {ϕ}_{k} . etc$$

$${\overline{\overline{D}}}^{( M ) ( e )} , {\overline{\overline{D}}}^{( N ) ( e )} , {\overline{\overline{D}}}^{( M ) ( h )} , {\overline{\overline{D}}}^{( N ) ( h )} = dimension {L}_{max} \times {K}_{max}$$

$${\overline{\overline{D}}}^{( N ) ( e )} = {D}_{{ℓ}^{′}}^{( N ) ( e )} ( \overline{k} ) , etc$$

$${\overline{\overline{k}}}_{{\overline{r}}_{1}} = exp ( i \overline{k} \cdot {\overline{r}}_{1} ) = {K}_{max} \times {K}_{max} diagonal matrix$$

with element exp(ik̅·r̅₁), where k̅=k sin θₖ cos φₖ\hat{x}+k sin θₖ sin φₖ\hat{x}+k cos θₖ\hat{z}. We have absorbed weighting factors ΔθₖΔφₖ in the definition of the column vector ā^{RD(e)}(k̅)ā^{RD(h)}(k̅). Further let

$$\overline{\overline{D}} = [ \begin{matrix}{\overline{\overline{D}}}^{( M e )} & {\overline{\overline{D}}}^{( M h )} \\ {\overline{\overline{D}}}^{( Ne )} & {\overline{\overline{D}}}^{( Nh )}\end{matrix} ]$$

$${\overline{\overline{k}}}_{{\overline{r}}_{1}} = [ \begin{matrix}{\overline{\overline{k}}}_{{\overline{r}}_{1}} & 0 \\ 0 & {\overline{\overline{k}}}_{{\overline{r}}_{1}}\end{matrix} ] = 2 {K}_{max} \times 2 {K}_{max}$$

$${\overline{a}}^{R D} = \begin{matrix}[ {\overline{a}}^{R D ( e )} ] \\ [ {\overline{a}}^{R D ( h )} ]\end{matrix} = 2 {K}_{max} \times 1$$

Then one has T̅⁽¹⁾D̅k̅_{r̅}_{₁}ā^{RD} for the contribution of diffuse reflected waves to the scattered waves of scatterer 1

The third set of terms are reflections of plane incident waves which does not have summation over k as the plane incident wave only has one direction. Use V to stand for column vector

$${\overline{D}}^{V ( M e )} ( {\overline{k}}_{i} ) = {D}_{{ℓ}^{′}}^{V ( M ) ( e )} ( {\overline{k}}_{i} ) = {L}_{max} \times 1$$

### Let

$$[ \begin{matrix}{\overline{D}}^{V ( M e )} ( {\overline{k}}_{i} ) & {\overline{D}}^{V ( M h )} ( {\overline{k}}_{i} ) \\ {\overline{D}}^{V ( N e )} ( {\overline{k}}_{i} ) & {\overline{D}}^{V ( N h )} ( {\overline{k}}_{i} )\end{matrix} ] = {\overline{\overline{D}}}^{V} ( {\overline{k}}_{i} ) = 2 {L}_{max} \times 2$$

$$[ \begin{matrix}{\overline{D}}^{V ( M e )} ( {\overline{K}}_{i} ) & {\overline{D}}^{V ( M h )} ( {\overline{K}}_{i} ) \\ {\overline{D}}^{V ( N e )} ( {\overline{K}}_{i} ) & {\overline{D}}^{V ( N h )} ( {\overline{K}}_{i} )\end{matrix} ] = {\overline{\overline{D}}}^{V} ( {\overline{K}}_{i} ) = 2 {L}_{max} \times 2$$

$$[ \begin{matrix}{E}_{i}^{T E} \\ {E}_{i}^{T M}\end{matrix} ] = {\overline{E}}_{i} = 2 \times 1$$

$$[ \begin{matrix}{R}^{TE} ( {\overline{k}}_{i} ) {E}_{i}^{T E} \\ {R}^{TM} ( {\overline{k}}_{i} ) {E}_{i}^{T M}\end{matrix} ] = {\overline{E}}_{i}^{R} = 2 \times 1$$

Then summing contributions to the scattered wave of scatterer 1

$${\overline{a}}^{S ( 1 )} = {\overline{\overline{T}}}^{( 1 )} \overline{σ} ( k ( {\overline{r}}_{1} - {\overline{r}}_{2} ) ) {\overline{a}}^{S ( 2 )} + {\overline{\overline{T}}}^{( 1 )} \overline{\overline{D}} {\overline{\overline{k}}}_{{\overline{r}}_{1}} {\overline{a}}^{R D} + {\overline{\overline{T}}}^{( 1 )} {\overline{\overline{D}}}^{V} ( {\overline{k}}_{i} ) {\overline{E}}_{i}^{R} exp ( i {\overline{k}}_{i} \cdot {\overline{r}}_{1} ) exp ( i {k}_{i z} 2 d ) + {\overline{\overline{T}}}^{( 1 )} {\overline{\overline{D}}}^{V} ( {\overline{K}}_{i} ) exp ( i {\overline{K}}_{i} \cdot {\overline{r}}_{1} ) {\overline{E}}_{i}$$

Next discretize ā^{RD} equation from above and use F̅^{(e)(M)} dimension Kₘₐₓ×Lₘₐₓ, and

$${( {\overline{\overline{F}}}^{( e ) ( M )} )}_{k ℓ} = Δ {θ}_{k} Δ {ϕ}_{k} {F}_{{ℓ}^{″}}^{( e ) ( M )} ( \overline{k} )$$

absorbing the weighting factors ΔθₖΔφₖ. The matrix form of reflection coefficients R̅^{TE}, R̅^{TM}=Kₘₐₓ×Kₘₐₓ

$${\overline{\overline{k}}}_{2 d} = exp ( i {k}_{z} 2 d ) = {K}_{max} \times {K}_{max}$$

### Let

$$[ \begin{matrix}{\overline{\overline{F}}}^{( e ) ( M )} & {\overline{\overline{F}}}^{( e ) ( N )} \\ {\overline{\overline{F}}}^{( h ) ( M )} & {\overline{\overline{F}}}^{( h ) ( N )}\end{matrix} ] \to \overline{\overline{F}} = 2 {K}_{max} \times 2 {L}_{max}$$

Define diagonal matrix

$$\overline{\overline{R}} = [ \begin{matrix}{\overline{\overline{R}}}_{0}^{T E} & 0 \\ 0 & {\overline{\overline{R}}}_{0}^{TM}\end{matrix} ] = 2 {K}_{max} \times 2 {K}_{max}$$

$$[ \begin{matrix}{\overline{\overline{k}}}_{2 d} & 0 \\ 0 & {\overline{\overline{k}}}_{2 d}\end{matrix} ] = {\overline{\overline{k}}}_{2 d} = 2 {K}_{max} \times 2 {K}_{max}$$

using (−) to denote minus sign and define

$${\overline{\overline{K}}}_{{\overline{r}}_{j}}^{( - )} = exp ( - i \overline{K} \cdot \overline{{r}_{j}} ) has {K}_{max} by {K}_{max} values$$

$$[ \begin{matrix}{\overline{\overline{K}}}_{{\overline{r}}_{j}}^{( - )} & 0 \\ 0 & {\overline{\overline{K}}}_{{\overline{r}}_{j}}^{( - )}\end{matrix} ] \to {\overline{\overline{K}}}_{{\overline{r}}_{j}} = 2 {K}_{max} \times 2 {K}_{max}$$

Then the diffuse reflection equation is

$${\overline{a}}^{RD} = {\overline{\overline{k}}}_{2 d} \overline{\overline{R}} {\sum }_{j = 1 , 2} {\overline{\overline{K}}}_{{\overline{r}}_{j}}^{( - )} \overline{\overline{F}} {\overline{a}}^{S ( j )}$$

The right hand side ā^{S(j)} is the total scattered wave of scatterer j. Substituting ā^{RD} into ā^{S(1)} equation, one has

$${\overline{a}}^{S ( 1 )} = {\overline{\overline{T}}}^{( 1 )} \overline{\overline{σ}} ( k ( {\overline{r}}_{1} - {\overline{r}}_{2} ) ) {\overline{a}}^{S ( 2 )} + {\overline{\overline{T}}}^{( 1 )} \overline{\overline{D}} {\overline{\overline{k}}}_{{\overline{r}}_{1}} ( {\overline{\overline{k}}}_{2 d} \overline{\overline{R}} {\overline{\overline{K}}}_{{\overline{r}}_{1}}^{( - )} \overline{\overline{F}} {\overline{a}}^{S ( 1 )} + {\overline{\overline{k}}}_{2 d} \overline{\overline{R}} {\overline{\overline{K}}}_{{\overline{r}}_{2}}^{( - )} \overline{\overline{F}} {\overline{a}}^{S ( 2 )} ) + {\overline{\overline{T}}}^{( 1 )} {\overline{\overline{D}}}^{V} ( {\overline{k}}_{i} ) {\overline{E}}_{i}^{R} exp ( i {\overline{k}}_{i} \cdot {\overline{r}}_{1} ) exp ( i {k}_{i z} 2 d ) + {\overline{\overline{T}}}^{( 1 )} {\overline{\overline{D}}}^{V} ( {\overline{K}}_{i} ) exp ( i {\overline{K}}_{i} \cdot {\overline{r}}_{1} ) {\overline{E}}_{i}$$

### Bringing

$${\overline{\overline{T}}}^{( 1 )} \overline{\overline{D}} {\overline{\overline{k}}}_{{\overline{r}}_{1}} {\overline{\overline{k}}}_{2 d} \overline{\overline{R}} {\overline{\overline{K}}}_{{\overline{r}}_{1}}^{( - )} \overline{\overline{F}} {\overline{a}}^{S ( 1 )}$$

to the left hand side, define T matrix, T̅^{R(q)} in the presence of the reflective surface by

$${\overline{\overline{T}}}^{R ( q )} = {( \overline{\overline{I}} - {\overline{\overline{T}}}^{( q )} \overline{\overline{D}} {\overline{\overline{k}}}_{{\overline{r}}_{q}} {\overline{\overline{k}}}_{2 d} \overline{\overline{R}} {\overline{\overline{K}}}_{{\overline{r}}_{q}}^{( - )} \overline{\overline{F}} )}^{- 1} {\overline{\overline{T}}}^{( q )}$$

For N scatterers, the MST-FL become

$${\overline{a}}^{S ( q )} = {\overline{\overline{T}}}^{R ( q )} {\sum }_{p \neq q}^{N} \overline{\overline{σ}} ( k ( {\overline{r}}_{q} - {\overline{r}}_{p} ) ) {\overline{a}}^{S ( p )} + {\overline{\overline{T}}}^{R ( q )} \overline{\overline{D}} {\sum }_{p \neq q}^{N} {\overline{\overline{k}}}_{{\overline{r}}_{q}} {\overline{\overline{k}}}_{2 d} \overline{\overline{R}} {\overline{\overline{K}}}_{{\overline{r}}_{q}}^{( - )} \overline{\overline{F}} {\overline{a}}^{S ( p )} + {\overline{\overline{T}}}^{R ( q )} {\overline{\overline{D}}}^{V} ( {\overline{k}}_{i} ) {\overline{E}}_{i}^{R} exp ( i {\overline{k}}_{i} \cdot {\overline{r}}_{q} ) exp ( {ik}_{iz} 2 d ) + {\overline{\overline{T}}}^{R ( q )} {\overline{\overline{D}}}^{V} ( {\overline{K}}_{i} ) exp ( i {\overline{K}}_{i} \cdot {\overline{r}}_{q} ) {\overline{E}}_{i}$$

$$q = 1 , 2 … N$$

In the next section, an analytical integration over ∫dφₖ is performed,

First perform

$${\int }_{0}^{2 π} d {ϕ}_{k}$$

for the scatterer q. Then perform

$${\int }_{0}^{2 π} d {ϕ}_{k}$$

for scattering from p to q in the Foldy-Lax equation. Note that in the expression of T̅^{R}

$${\overline{\overline{k}}}_{{\overline{r}}_{q}} {\overline{\overline{k}}}_{2 d} \overline{\overline{R}} {\overline{\overline{K}}}_{{\overline{r}}_{q}}^{( - )} = exp ( i \overline{k} \cdot {\overline{r}}_{q} ) exp ( {ik}_{z} 2 d ) ( {R}^{TE} ( {k}_{z} ) or {R}^{TM} ( {k}_{z} ) ) exp ( - i \overline{K} \cdot {\overline{r}}_{q} ) = exp ( 2 {ik}_{z} ( d + {z}_{q} ) ) ( {R}^{TE} ( {k}_{z} ) or {R}^{TM} ( {k}_{z} ) )$$

### Thus

$${\overline{\overline{k}}}_{{\overline{r}}_{q}} {\overline{\overline{k}}}_{2 d} {\overline{\overline{R}}}_{\overline{K}}^{{\overline{K}}_{{\overline{r}}_{q}}} ( - )$$

is independent of φₖ. Using the expressions for vector spherical harmonics, write

$${F}_{mn}^{( e ) ( M )} ( \overline{k} ) = Δ {θ}_{k} Δ {ϕ}_{k} {f}_{mn}^{( e ) ( M )} ( {θ}_{k} ) exp ( im {ϕ}_{k} )$$

$${F}_{mn}^{( e ) ( N )} ( \overline{k} ) = Δ {θ}_{k} Δ {ϕ}_{k} {f}_{mn}^{( e ) ( N )} ( {θ}_{k} ) exp ( im {ϕ}_{k} )$$

where

$${f}_{mn}^{( e ) ( M )} ( \overline{k} ) = - \frac{{( i )}^{n}}{2 π k} {( - 1 )}^{m} {k}_{ρ} exp ( im {ϕ}_{k} ) {γ}_{mn} ( \frac{{dP}_{n}^{m} ( cos ( {θ}_{k} ) )}{d ( {θ}_{k} )} )$$

$${f}_{mn}^{( e ) ( N )} ( \overline{k} ) = \frac{{( i )}^{n}}{2 π k} {( - 1 )}^{m} {k}_{ρ} exp ( im {ϕ}_{k} ) {γ}_{mn} \frac{m}{sin ( {θ}_{k} )} {P}_{n}^{m} ( cos ( {θ}_{k} ) )$$

The reason for separating out

$${f}_{mn}^{( e ) ( M )} ( \overline{k} ) and {f}_{mn}^{( e ) ( N )} ( \overline{k} )$$

from

$${F}_{mn}^{( e ) ( M )} ( \overline{k} ) and {F}_{mn}^{( e ) ( N )} ( \overline{k} )$$

respectively is that the exp(imφₖ) can Ne integrated analytically over dφₖ. Similarly, for

$${D}_{{m}^{′} {n}^{′}}^{( M ) ( e )} ( \overline{k} ) and {D}_{{m}^{′} {n}^{′}}^{( N ) ( e )} ( \overline{k} ) ,$$

one has

$${D}_{{m}^{′} {n}^{′}}^{( M ) ( e )} ( \overline{k} ) = {d}_{{m}^{′} {n}^{′}}^{( M ) ( e )} ( {θ}_{k} ) exp ( - {im}^{′} {ϕ}_{k} )$$

$${D}_{{m}^{′} {n}^{′}}^{( N ) ( e )} ( \overline{k} ) = {d}_{{m}^{′} {n}^{′}}^{( N ) ( e )} ( {θ}_{k} ) exp ( - {im}^{′} {ϕ}_{k} )$$

$${D}_{{m}^{′} {n}^{′}}^{( M ) ( e )} ( {θ}_{k} ) = {( - 1 )}^{{m}^{′}} 4 π {i}^{{n}^{′}} {γ}_{( - {m}^{′} ) {n}^{′}} \frac{{dP}_{{n}^{′}}^{- {m}^{′}} ( cos {θ}_{k} )}{d {θ}_{k}}$$

$${D}_{{m}^{′} {n}^{′}}^{( N ) ( e )} ( {θ}_{k} ) = {( - 1 )}^{{m}^{′}} 4 π {i}^{{n}^{′}} {γ}_{( - {m}^{′} ) {n}^{′}} \frac{{m}^{′}}{sin {θ}_{k}} {P}_{{n}^{′}}^{- {m}^{′}} ( cos {θ}_{k} )$$

### Then

$$\overline{\overline{D}} {\overline{\overline{k}}}_{{\overline{r}}_{q}} {\overline{k}}_{2 d} \overline{\overline{R}} {\overline{\overline{K}}}_{{\overline{r}}_{q}}^{( - )} \overline{\overline{F}}$$

has the terms

$${\sum }_{k = 1}^{{K}_{max}} {D}_{{ℓ}^{′} k} exp ( 2 {ik}_{z} ( d + {z}_{q} ) ) ( {R}^{TE} ( {k}_{z} ) or {R}^{TM} ( {k}_{z} ) ) {F}_{kℓ} = 2 π {\sum }_{k = 1}^{{N}_{{θ}_{k}}} {D}_{{ℓ}^{′}} ( {θ}_{k} ) exp ( 2 {ik}_{z} ( d + {z}_{q} ) ) ( {R}^{TE} ( {k}_{z} ) or {R}^{TM} ( {k}_{z} ) ) {w}_{{θ}_{k}} {f}_{ℓ} ( {θ}_{k} ) {δ}_{{m}^{′} m} = 2 {L}_{max} \times 2 {L}_{max}$$

N_{θ}_{ₖ} is the number of directions in θₖ only as dφₖ has been integrated analytically

$${\overline{\overline{d}} ( θ )}_{k} = [ \begin{matrix}{\overline{\overline{d}}}^{( Me )} & {\overline{\overline{d}}}^{( Mh )} \\ {\overline{\overline{d}}}^{( Ne )} & {\overline{\overline{d}}}^{( Nh )}\end{matrix} ] = 2 {L}_{max} \times 2 {N}_{{θ}_{k}}$$

$${\overline{\overline{f}} ( θ )}_{k} = {Δθ}_{k} [ \begin{matrix}{\overline{\overline{f}}}^{( e ) ( M )} & {\overline{\overline{f}}}^{( e ) ( N )} \\ {\overline{\overline{f}}}^{( h ) ( M )} & {\overline{\overline{f}}}^{( h ) ( N )}\end{matrix} ] \to \overline{\overline{f}} = 2 {N}_{{θ}_{k}} \times 2 {L}_{max}$$

where Δ←ₖ or w_{θ}_{ₖ} refers to quadrature weights.

Next for the Foldy Lax equations for scattering from scatter p to q.

$${\overline{\overline{k}}}_{{\overline{r}}_{q}} {\overline{\overline{k}}}_{2 d} \overline{\overline{R}} {\overline{\overline{K}}}_{{\overline{r}}_{p}}^{( - )} = exp ( {ik}_{x} ( {x}_{q} - {x}_{p} ) + {ik}_{y} ( {y}_{q} - {y}_{p} ) ) exp ( {ik}_{z} ( 2 d + {z}_{p} + {z}_{q} ) ) ( {R}^{TE} ( {k}_{z} ) or {R}^{TM} ( {k}_{z} ) )$$

For metasurfaces, the scatterers are often of the same height, thus let

$${z}_{p} = {z}_{q}$$

### Then

$${D}^{=} {{k}^{=}}_{{\overline{r}}_{q}} {{k}^{=}}_{2 d} {R}^{=} {{K}^{=}}_{{\overline{r}}_{p}}^{( - )} {F}^{=}$$

has the terms

$${\sum }_{k} {D}_{{ℓ}^{′} k} exp ( {ik}_{x} ( {x}_{q} - {x}_{p} ) + {ik}_{y} ( {y}_{q} - {y}_{p} ) ) exp ( {ik}_{z} ( 2 d + {z}_{p} + {z}_{q} ) ) ( {R}^{TE} ( {k}_{z} ) or {R}^{TM} ( {k}_{z} ) ) {F}_{k ℓ} = \int d {θ}_{k} {d}_{{ℓ}^{′}} ( {θ}_{k} ) exp ( {ik}_{z} ( 2 d + {z}_{p} + {z}_{q} ) ) ( {R}^{TE} ( {k}_{z} ) or {R}^{TM} ( {k}_{z} ) ) {f}_{ℓ} ( {θ}_{k} ) {a}_{ℓ}^{S ( p )} {\int }_{0}^{2 π} d {ϕ}_{k} exp ( {ik}_{x} ( {x}_{q} - {x}_{p} ) + {ik}_{y} ( {y}_{q} - {y}_{p} ) ) exp ( - {im}^{′} {ϕ}_{k} ) exp ( im {ϕ}_{k} )$$

Next carry out the integration over

$${\int }_{0}^{2 π} d {ϕ}_{k}$$

analytically. Let

$$\begin{matrix}{x}_{q} - {x}_{p} & = {ρ}_{qp} cos {ϕ}_{qp} \\ {y}_{q} - {y}_{p} & = {ρ}_{qp} sin {ϕ}_{qp} \\ {k}_{x} & = {k}_{ρ} cos {ϕ}_{k} \\ {k}_{y} & = {k}_{ρ} sin {ϕ}_{k}\end{matrix}$$

$$I = {\int }_{0}^{2 π} d {ϕ}_{k} exp ( - i {m}^{′} {ϕ}_{k} ) exp ( im {ϕ}_{k} ) exp ( {ik}_{x} ( {x}_{q} - {x}_{p} ) + {ik}_{y} ( {y}_{q} - {y}_{p} ) ) = 2 π {i}^{( m - {m}^{′} )} exp ( i ( m - {m}^{′} ) {ϕ}_{qp} ) {J}_{m - {m}^{′}} ( {k}_{ρ} {ρ}_{qp} )$$

### Then

$${\sum }_{p \neq q}^{N} {\sum }_{k = 1}^{{K}_{max}} {D}_{{ℓ}^{′} k} exp ( {ik}_{x} ( {x}_{q} - {x}_{p} ) + {ik}_{y} ( {y}_{q} - {y}_{p} ) ) exp ( {ik}_{z} ( 2 d + {z}_{p} + {z}_{q} ) ) ( {R}^{TE} ( {k}_{z} ) or {R}^{TM} ( {k}_{z} ) ) {F}_{k ℓ} {a}_{ℓ}^{S ( p )} = {\sum }_{k = 1}^{{N}_{{θ}_{k}}} {w}_{{θ}_{k}} {d}_{{ℓ}^{′}} ( {θ}_{k} ) exp ( {ik}_{z} ( 2 d + {z}_{p} + {z}_{q} ) ) ( {R}^{TE} ( {k}_{z} ) or {R}^{TM} ( {k}_{z} ) ) {f}_{ℓ} ( {θ}_{k} ) 2 π {i}^{( m - {m}^{′} )} [ {\sum }_{p \neq q}^{N} exp ( i ( m - {m}^{′} ) {ϕ}_{qp} ) {J}_{m - {m}^{′}} ( {k}_{ρ} {ρ}_{qp} ) ] {a}_{ℓ}^{S ( p )}$$

where q, p are the scatterers, [symbol] =(n,m), and [symbol] =(n′, m′). For small to moderate size scatterers

$${\sum }_{p \neq q}^{N} exp ( i ( m - {m}^{′} ) {ϕ}_{qp} ) {J}_{m - {m}^{′}} ( {k}_{ρ} {ρ}_{qp} )$$

can be performed by 2D FFT. For large scatterers where Nₘₐₓ is large,

$${\sum }_{{m}^{′}} {\sum }_{p \neq q}^{N} exp ( i ( m - {m}^{′} ) {ϕ}_{qp} ) {J}_{m - {m}^{′}} ( {k}_{ρ} {ρ}_{qp} )$$

is carried out using triple FFT.

After the Foldy Lax equations are solved, one obtains the final scattered field coefficients,

$${a}_{ℓ}^{S ( q ) ( M )} and {a}_{ℓ}^{S ( q ) ( N )} .$$

Using the far field approximation of VSW, one has for the scattered direction of (θ, φ)

$${\overline{M}}_{ℓ} ( k ( \overline{r} - {\overline{r}}_{q} ) ) \to {γ}_{ℓ} [ \frac{{e}^{ikr}}{kr} exp ( - i \overline{k} \cdot {\overline{r}}_{1} ) {i}^{- n - I} {\overline{C}}_{ℓ} ( θ , ϕ ) ]$$

$${\overline{N}}_{ℓ} ( k ( \overline{r} - {\overline{r}}_{q} ) ) \to {γ}_{ℓ} [ \frac{{e}^{ikr}}{kr} exp ( - i \overline{k} \cdot {\overline{r}}_{1} ) {i}^{- n} {\overline{B}}_{ℓ} ( θ , ϕ ) ]$$

Then the final scattered field summing scattered field from all scatterers is

$${\overline{E}}^{S , scatt} = \frac{{e}^{ikr}}{kr} {\sum }_{q = 1}^{N} {\sum }_{ℓ} {γ}_{ℓ} exp ( - i \overline{k} \cdot {\overline{r}}_{1} ) ( {a}_{ℓ}^{S ( q ) ( M )} {i}^{- n - 1} {\overline{C}}_{ℓ} ( θ , ϕ ) + {a}_{ℓ}^{S ( q ) ( N )} {i}^{- n} {\overline{B}}_{ℓ} ( θ , ϕ ) )$$

Using ā^{S(q)}, calculate the diffuse reflected field ā^{RD}. Using the method of stationary phase, evaluate far field diffuse reflected field

$${\overline{E}}^{RD} = \int d {θ}_{k} \int d {ϕ}_{k} {a}^{RD ( e )} ( {k}_{x} , {k}_{y} , {k}_{z} ) exp ( i \overline{k} \cdot \overline{r} ) \hat{e} ( {k}_{x} , {k}_{y} , {k}_{z} ) + \int d {θ}_{k} \int d {ϕ}_{k} {a}^{RD ( h )} ( {k}_{x} , {k}_{y} , {k}_{z} ) exp ( i \overline{k} \cdot \overline{r} ) \hat{h} ( {k}_{x} , {k}_{y} , {k}_{z} )$$

Stationary phase point is at

$${k}_{x} = k sin θ cos ϕ = {k}_{x}^{s} , {k}_{y} = k sin θ sin ϕ = {k}_{y}^{s} , {k}_{z} = k cos θ = {k}_{z}^{s} and {k}_{ρ} = k sin θ = {k}_{ρ}^{s} .$$

### Make use of

$$\int d {θ}_{k} \int d {ϕ}_{k} exp ( i \overline{k} \cdot \overline{r} ) = - i 2 π \frac{exp ( ikr )}{k sin θ r}$$

Substituting in the diffuse

$${a}^{RD ( e )} ( {k}_{x}^{s} , {k}_{y}^{s} ) and {a}^{RD ( h )} ( {k}_{x}^{s} , {k}_{y}^{s} )$$

in terms of the scattered field coefficients, one has

$${\overline{E}}^{RD} = - i 2 π \frac{exp ( ikr )}{r} {\sum }_{q = 1}^{N} {\sum }_{ℓ} \frac{1}{{k}_{p}^{s}} exp ( - i {\overline{K}}^{s} \cdot {\overline{r}}_{q} ) exp ( {ik}_{z}^{s} 2 d ) {R}^{TE} ( {k}_{z}^{s} ) \hat{e} ( {k}_{x}^{s} , {k}_{y}^{s} , {k}_{z}^{s} )$$

$$( {F}_{ℓ}^{( e ) ( M )} ( {\overline{k}}^{s} ) {a}_{ℓ}^{s ( q ) ( M )} + {F}_{ℓ}^{( e ) ( N )} ( {\overline{k}}^{s} ) {a}_{ℓ}^{s ( q ) ( N )} ) - i 2 π \frac{exp ( ikr )}{r} {\sum }_{q = 1}^{N} {\sum }_{ℓ} \frac{1}{{k}_{p}^{s}} exp ( - i {\overline{K}}^{s} \cdot {\overline{r}}_{q} ) exp ( {ik}_{z}^{s} 2 d ) {R}^{TM} ( {k}_{z}^{s} ) \hat{h} ( {k}_{x}^{s} , {k}_{y}^{s} , {k}_{z}^{s} )$$

$$( {F}_{ℓ}^{( h ) ( M )} ( {\overline{k}}^{s} ) {a}_{ℓ}^{s ( q ) ( M )} + {F}_{ℓ}^{( h ) ( N )} ( {\overline{k}}^{s} ) {a}_{ℓ}^{s ( q ) ( N )} )$$

To complete, the reflection of a flat surface is

$${\overline{E}}_{ref} = ( {E}_{i}^{TM} {R}^{TM} ( {k}_{ix} , {k}_{iy} , {k}_{iz} ) \hat{h} ( {k}_{ix} , {k}_{iy} , {k}_{iz} ) + {E}_{i}^{TE} {R}^{TE} ( {k}_{ix} , {k}_{iy} , {k}_{iz} ) \hat{e} ( {k}_{ix} , {k}_{iy} , {k}_{iz} ) ) exp ( {ik}_{ix} x + {ik}_{iy} y + {ik}_{iz} ( z + 2 d ) )$$

The final far field scattered field is

$${\overline{E}}^{s} = {\overline{E}}^{S , scatt} + {\overline{E}}^{RD} + {\overline{E}}_{ref}$$

The accuracies of FHMSTM are validated below. All results are compared with FEKO, which is a commercial software based on Method of Moment of surface integral equation. The wavelength is set as 1. The incident angle is 40°. First consider the case of spheres. The relative permittivity of the spheres is 8.3, and the relative permittivity of the dielectric substrate is set at 6. One can use the FEKO 2021/2022 version for comparisons with FHMSTM. For the infinite ground plane (planar surface) problem, FEKO provides two methods: exact Sommerfeld integration method and the reflection coefficient approximation. The exact Sommerfeld integration method is further divided into two options (i) fine mesh option provided by FEKO and (ii) extra-fine mesh (manually specify). In the reflection coefficient approximation method, the reflection coefficient approximation takes advantage of the multilevel fast multipole method (MLFMM). This method is fast because of MLFMM. However, as shown in the following, the results of this reflection coefficient method with MLFMM is not accurate and often does not converge. Therefore, unless specified, all comparisons between FEKO and FHMSTM are based on the exact Sommerfeld integration method with fine mesh. In the illustration of far field scattered field, the reflection of the incident wave by the infinite dielectric substrate is excluded in all the FHMSTM simulations. The evanescent waves of VPW of the planar surface reflection are included.

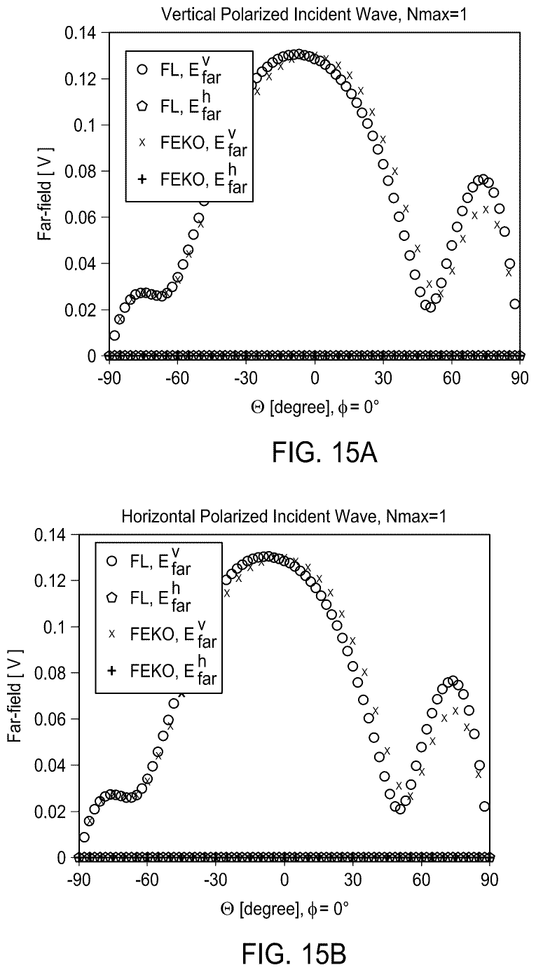

Consider a single spherical scatter placed above the planar surface. The radius of the spherical scatterer is 0.15λ. The distance above the surface is 0. Set Nₘₐₓ=1. Consider vertical and horizontal incident polarized plane waves in FIGS. 15A and 15B, respectively. The far-fields are shown at the φ=0° plane. The results are in good agreement with FEKO.

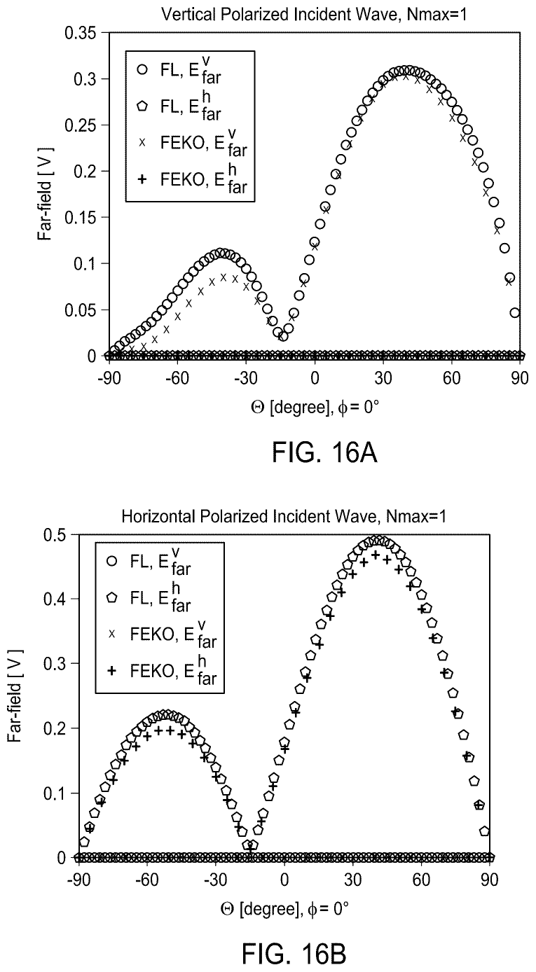

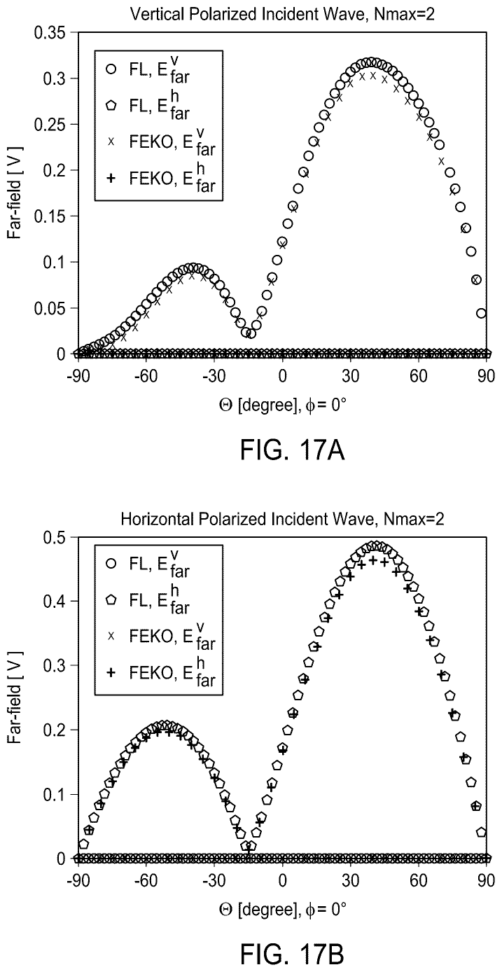

Next, consider two spheres above the dielectric substrate. The radius of the two spheres are both equal to 0.15λ. They are placed at distance d=0 above the dielectric substrate. The horizontal separation between the two spheres is 0.5λ (center to center). In FIGS. 16A and 16B, the case of vertical polarization incidence and horizontal incidence, respectively, is shown using Nₘₐₓ=1. The agreement with FEKO is good. In FIGS. 17A and 17B, the accuracies of FHMSTM are improved by using Nₘₐₓ=2. The agreement with FEKO has improved showing near field interaction require a larger Nₘₐₓ.

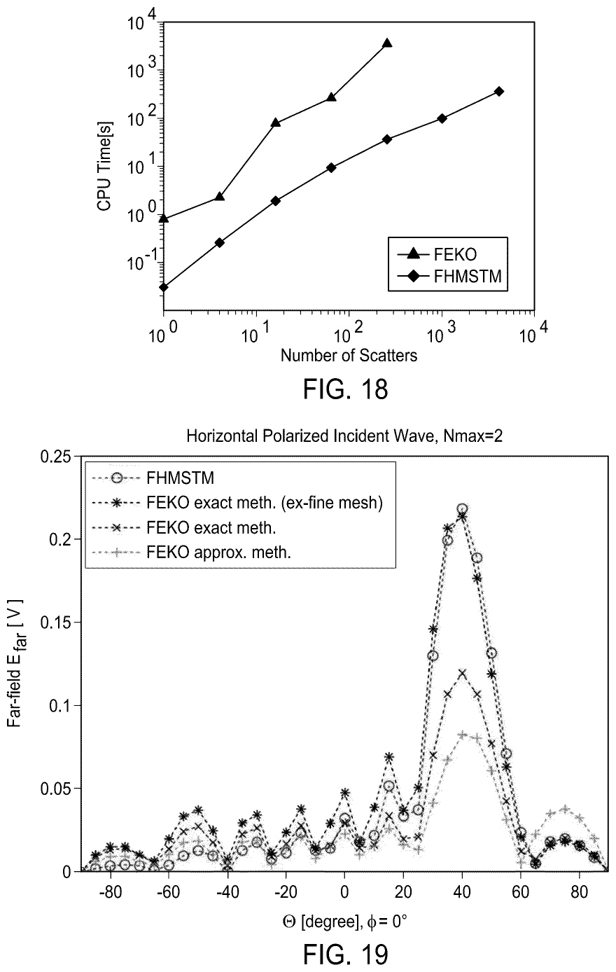

Another example is given to serve as proof of large-scale computation ability. Compare the results of large numbers of scatterers with FEKO. Here cubic scatterers with a dimension of 0.12λ×0.12λ×0.12λ are used. The grid distance is 0.24λ and the lowest scatterer touches the flat plane. A Nₘₐₓ=2 is used. All calculations are carried out on an 8-core common computer with 32 GB memory. Since FEKO does not allow a surface to touch to the dielectric plane, a small offset of 0.001λ is given. Here FEKO adopts fine mesh. The results of 1024 scatterers with horizontal wave incidence is shown in FIG. 19. FIG. 18 compares the CPU times between FEKO and FHMSTM. For 256 scatterers, it requires FEKO CPU of 3683 s compared with 35 s using FHMSTM. It shows the proposed fast hybrid multiple scattering method with FFT technique works well with thousands of scatterers. The FHMSTM is 104 times faster than FEKO for 256 scatterers. FIG. 18 indicates that it is difficult to use FEKO to solve the case of thousands of scatterers without extensive high performance computing resources. On the other hand, solving the case of thousands of scatterers on a substrate can be done with FHMSTM All of the tests are carried out on an 8-core common computer with 32 GB memory.

Table 4 provides a comparison of memory requirement. The memory consumption of the proposed fast hybrid multiple scattering method is almost linear when the number of scatterers is large, and is less than 100 MB for 4096 scatterers, which is significantly less than FEKO. It indicates the proposed fast hybrid multiple scattering method is very suitable for computing a very large system of thousands of scatterers.

TABLE 4
Memory consumption of FEKO (fine mesh) and FHMSTM.

| | Scatterers number | | | | | | | | | | | | | |
|---|---|---|---|---|---|---|---|---|---|---|---|---|---|---|
| | 1 | | 4 | | 16 | | 64 | | 256 | | 1024 | | 4096 | |
| FEKO, fine mesh | 27.0 | MB | 27.3 | MB | 46.8 | MB | 662.0 | MB | 10.2 | GB | 159.6 | GB† | 2,506 | GB† |
| FHMSTM | 16 | KB | 16 | KB | 16 | KB | 1.0 | MB | 4.0 | MB | 16.0 | MB | 64.1 | MB |

†Anticipate results.

FIG. 19 is a comparison of 256 cubic scatterers above a plane. The FEKO results of fine mesh and reflection coefficient approximation are inaccurate, especially for the reflection coefficient approximation method with MLFMM acceleration. The three results of FEKO: exact method with extra fine mesh, exact method with fine mesh and approximate reflection coefficient with fine mesh, are all different. Assuming that FEKO extra fine mesh are accurate, the FHMSTM results are validated as the results show good agreement with FEKO of the extra fine mesh option.

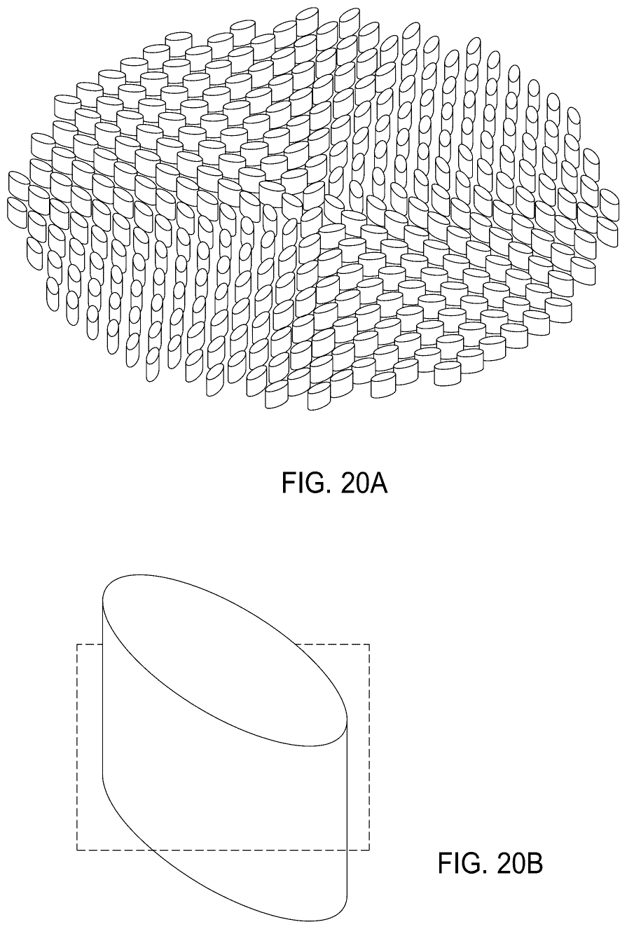

The proposed FHMST is applied to metasurfaces with dielectric substrate to demonstrate the computation efficiency of FHMSTM. OAM metasurfaces are used to manipulate light to produce vortex beams with orbital angular momentum (OAM). The metasurface in FIG. 20a has been used to to generate reflected Orbital angular momentum (OAM) waves from an LCP/RCP incident wave.

The radius of this metasurface (FIG. 20a) is set as 20.642 and the number of scatterers is 5024. If the working wavelength is set as 1550 nm, the radius of etching area will be 32 μm. The scatterers lie on a dielectric substrate (FIG. 20a). FIG. 20b shows the structure of a single unit cell of silicon elliptical nanopillar, which performs as a resonator. The different scatterers are obtained by rotating Euler angle α according to a helical phase term. So, scatterers in each axis are different from the point of view of the incident wave. The ground plane is made of fused silica substrate. For this simulation case, the topological charge l is chosen as −2 and the incident wave is RCP with a incident angle of 0°.

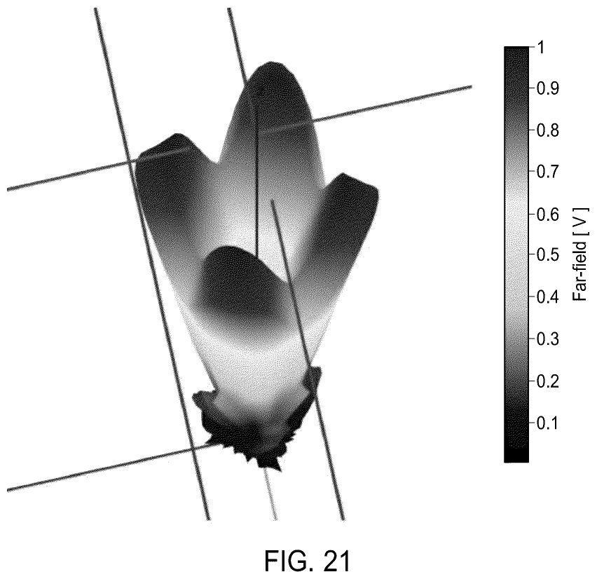

Using the proposed FHMSTM, perform full wave simulations and obtain the far field scattering pattern. The results are shown in FIG. 21 that shows the OAM cone-like far field. The calculation time of FHMSTM is 1023.2 seconds and the memory requirement is 100.2031 MB.

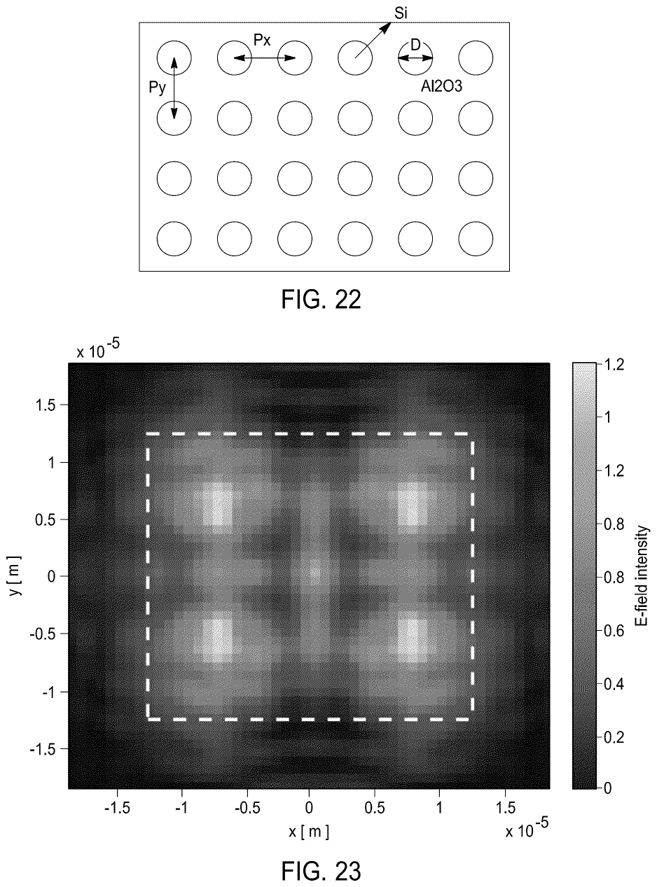

For a wavelength-selective metamirror, the metasurface (Metamirror) shown in FIG. 22 is designed to operate at target of λ₁=1064 nm, consisting of cylindrical Si unit cells on a Al 2 O 3 substrate. The Px and Py are chosen as 416 nm. The height and diameter of cylinders are 211 and 297 nm, separately. In this case, one can simulate 3600(60×60) unit cells. The area of this metasurface is 623 μm². The reflection efficiency is calculated through

$${η}_{r} = \frac{{P}_{ref}}{{P}_{in}}$$

where P_{ref} is reflected energy toward z-direction calculated within a surface with a same area of the metasurface and 20λ above it, and the Pᵢₙ is the energy of the plane wave incident on the metasurface with a incident angle of 0°.

FIG. 23 shows the near field. The proposed FHMSTM consumes 2510.47 seconds to finish the test case and the efficiency is 82.41%. In addition to computational efficiency, another advantage here is the edge effect being shown clearly.

A metasurface can generate numerous diffractive and transmissive patterns that can tailor the optical waves, microwaves and terahertz waves for applications in optical, microwave, terahertz communications, quantum computers etc. However, the design of optical, microwave and terahertz metasurfaces face immense challenges as the traditional predictive full wave simulations tools of finite difference, finite element method and the method of moment are extremely time consuming. Because of the prohibitive cost of traditional tools, recent research work tends to use artificial intelligence (AI) to assist the design. But Al suffers from inaccuracies with large errors and lack of predictive training data. The fast hybrid method described above is several hundred to one thousand times faster than the traditional method of prediction tools. Given a desired diffractive or transmissive pattern or phase pattern, the fast hybrid method can be used to generate a large number of patterns initially based on varied arrangement of scatterers in the metasurfaces in several tens of minutes of CPU. Iterative designs are next performed by optimizing parameters using rotation of the unit cell scatterers or different unit cells to obtain the desired T matrices and also adjusting the spacings and relative arrangement of scatterers. The optimization goal is to obtain the desired geometric phase known as Pancharatnam-Berry (PB) phase or diffractive pattern. Several iterations will be used to achieve the optimal design. The design based on fast hybrid method is much faster than using the traditional method of predictive tools and much more accurate than Al.

The techniques described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

Some portions of the above description present the techniques described herein in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the described techniques include process steps and instructions described herein in the form of an algorithm. It should be noted that the described process steps and instructions could be embodied in software, firmware or hardware, and when embodied in software, could be downloaded to reside on and be operated from different platforms used by real time network operating systems.

The present disclosure also relates to an apparatus for performing the operations herein. This apparatus may be specially constructed for the required purposes, or it may comprise a computer selectively activated or reconfigured by a computer program stored on a computer readable medium that can be accessed by the computer. Such a computer program may be stored in a tangible computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various systems may also be used with programs in accordance with the teachings herein, or it may prove convenient to construct more specialized apparatuses to perform the required method steps. The required structure for a variety of these systems will be apparent to those of skill in the art, along with equivalent variations. In addition, the present disclosure is not described with reference to any particular programming language. It is appreciated that a variety of programming languages may be used to implement the teachings of the present disclosure as described herein.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for full-wave simulations of metasurfaces, comprising:
receiving, by a computer processor, a metasurface comprised of a plurality of scattering structures having same shape;
determining, by a compute processor, a baseline T-matrix for a given scattering structure of the metasurface;
generating, by the computer processor, a model for the metasurface by assigning a T-matrix to each scattering structure comprising the metasurface, where each assigned T-matrix is a variant of the baseline T-matrix;
for each scattering structure in the model, formulating a Foldy-Lax equation for a particular scattering structure, thereby forming a set of Foldy-Lax equations, where each Foldy-Lax equation accounts for scattering from each of remaining scattering structures in the model; and
determining a scattered wave for each of the plurality of scattering structures by applying a Fast Fourier transform to the set of Foldy-Lax equations.

2. The method of claim 1 wherein the baseline T-matrix expresses scattered fields outside of a cylinder as vector cylindrical waves or outside a sphere as vector spherical waves, where the cylinder or the sphere represents the given scattering structure.

3. The method of claim 1 wherein the baseline T-matrix is determined using an electromagnetic field solver.

4. The method of claim 1 wherein generating the model for the metasurface includes rotating elements of the baseline T-matrix according to a series of orientations to form a series of T-matrix variants; assigning a T-matrix variant from the series of T-matrix variants to each scattering structure in the model, where orientation of the T-matrix variant aligns with orientation of the scattering structure to which it is assigned; and storing the series of T matrix variants in a library.

5. The method of claim 1 wherein the Foldy-Lax equation is expressed as
$${E}_{q}^{ex} = {E}^{inc} + {{\sum }_{p = 1 , p \neq q}}^{N} {G}_{qp} {T}_{p} {E}_{p}^{ex} ,$$
$$q = 1 , 2 , ... , N$$
where E^{inc} is incident wave, G_{qp} is a propagator from scatterer p to scatter q, Tₚ is T-matrix assigned to scattering structure p,
$${E}_{p}^{ex}$$
is exciting field of scattering structure p and the product
$${G}_{qp} {T}_{p} {E}_{p}^{ex}$$
is scattered wave from scattering structure p to scattering structure q.

6. The method of claim 1 further comprises iteratively determining a scattered wave for each of the plurality of scattering structures by applying a Fast Fourier transform to the set of Foldy-Lax equations until a stop condition is met.

7. The method of claim 1 wherein the metasurface scattering structures reside on a surface of a substrate and further comprises
determining a T-matrix for the surface of the substrate in vector plane waves including evanescent waves; and
formulating a Foldy-Lax equation for the particular scattering structure, where the Foldy-Lax equation accounts for scattering of the surface of the substrate.

8. The method of claim 7 wherein the Foldy-Lax equation is expressed as
$${E}_{q}^{ex} = {E}^{inc} + {{\sum }_{p = 1 , p \neq q}}^{N} {G}_{qp} {T}_{p} {E}_{p}^{ex} + {G}_{q , sur} {T}_{sur} {E}_{sur}^{ex}$$
$${E}_{sur}^{ex} = {E}^{inc} + {{\sum }_{p = 1}}^{N} {G}_{sur , p} {T}_{p} {E}_{p}^{ex}$$
where E^{inc} is incident wave, G_{qp} is a propagator from scattering structure p to scattering structure q, Tₚ is T-matrix assigned to scattering structure p and
$${E}_{p}^{ex}$$
is exciting field of scattering structure p, G_{q,sur} is a propagator from the surface to scattering structure q, Tₛᵤᵣ is T-matrix for the surface,
$${E}_{sur}^{ex} r$$
is exciting field of the surface, G_{sur,p} is propagator from scattering structure p to the surface, and the product
$${G}_{sur , p} {T}_{p} {E}_{p}^{ex}$$
is the scattered wave from scattering structure p to the surface

9. The method of claim 7 further comprises
calculating a transformation between the baseline T-matrix of vector spherical waves of the scattering structures and the T-matrix of vector plane waves including evanescent waves for the surface of the dielectric substrate;
calculating a transformation between the baseline T-matrix and the T-matrix with a dielectric substrate, where the T matrix of a scattering structure is first expanded to vector plane waves and then the Fresnel reflection rule is used to find the reflection of such vector plane waves including evanescent waves from the dielectric substrate;
transforming the reflected vector plane waves back to vector spherical waves; and
calculating the T matrix of scattering structure with a dielectric substrate.

10. A computer-implemented method for full-wave simulations of metasurfaces, comprising:
receiving, by a computer processor, a metasurface comprised of a plurality of scattering structures residing on a surface of a substrate, where the plurality of scattering structures have same shape;
determining a T-matrix for the surface of the substrate in vector plane waves including evanescent waves
determining, by a compute processor, a baseline T-matrix for a given scattering structure of the metasurface;
generating, by the computer processor, a model for the metasurface by assigning a T-matrix to each scattering structure comprising the metasurface, where each assigned T-matrix is a variant of the baseline T-matrix;
for each scattering structure in the model, formulating a Foldy-Lax equation for a particular scattering structure, thereby forming a set of Foldy-Lax equations, where each Foldy-Lax equation accounts for scattering from each of remaining scattering structures in the model and accounts for scattering of the surface of the substrate; and
determining a scattered wave for each of the plurality of scattering structures by applying a Fast Fourier transform to the set of Foldy-Lax equations.

11. The method of claim 10 wherein the baseline T-matrix expresses scattered fields outside of a cylinder as vector cylindrical waves or outside a sphere as vector spherical waves, where the cylinder or the sphere represents the given scattering structure.

12. The method of claim 10 wherein the baseline T-matrix is determined using an electromagnetic field solver.

13. The method of claim 10 wherein generating the model for the metasurface includes rotating elements of the baseline T-matrix according to a series of orientations to form a series of T-matrix variants; assigning a T-matrix variant from the series of T-matrix variants to each scattering structure in the model, where orientation of the T-matrix variant aligns with orientation of the scattering structure to which it is assigned; and storing the series of T matrix variants in a library.

14. The method of claim 10 wherein the Foldy-Lax equation is expressed as
$${E}_{q}^{ex} = {E}^{inc} + {{\sum }_{p = 1 , p \neq q}}^{N} {G}_{qp} {T}_{p} {E}_{p}^{ex} + {G}_{q , sur} {T}_{sur} {E}_{sur}^{ex}$$
$${E}_{sur}^{ex} = {E}^{inc} + {{\sum }_{p = 1}}^{N} {G}_{sur , p} {T}_{p} {E}_{p}^{ex}$$
where E^{inc} is incident wave, G_{qp} is a propagator from scattering structure p to scattering structure q, Tₚ is T-matrix assigned to scattering structure p and
$${E}_{p}^{ex}$$
is exciting field of scattering structure p, G_{q,sur} is a propagator from the surface to scattering structure q, Tₛᵤᵣ is T-matrix for the surface,
$${E}_{sur}^{ex} r$$
is exciting field of the surface, G_{sur,p} is propagator from scattering structure p to the surface, and the product
$${G}_{sur , p} {T}_{p} {E}_{p}^{ex}$$
is the scattered wave from scattering structure p to the surface

15. The method of claim 14 further comprises
calculating a transformation between the baseline T-matrix of vector spherical waves of the scattering structures and the T-matrix of vector plane waves including evanescent waves for the surface of the dielectric substrate;
calculating a transformation between the baseline T-matrix and the T-matrix with a dielectric substrate, where the T matrix of a scattering structure is first expanded to vector plane waves and then the Fresnel reflection rule is used to find the reflection of such vector plane waves including evanescent waves from the dielectric substrate;
transforming the reflected vector plane waves back to vector spherical waves; and
calculating the T matrix of scattering structure with a dielectric substrate.
